(19) United States
(12) Patent Application Publication
(10) Pub. No.: US 2008/0104032 A1
(43) Pub. Date: May 1, 2008

(54) Method and System for Organizing Items

(75) Inventor: Devajyoti Sarkar, Singapore (SG)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: SARKAR PTE LTD., Singapore (SG)

(21) Appl. No.: 11/663,999

(22) PCT Filed: Sep. 27, 2005
(86) PCT No.: PCT/SG05/00320

§ 371 Date: Oct. 9, 2007

Related U.S. Application Data
(63) Continuation-in-part of application No. 10/954,964, filed on Sep. 29, 2004.

(51) Int. Cl. G06F 17/30

(52) U.S. Cl. 707/3; 707/102; 707/E17.014; 707/E17.044

(57) ABSTRACT

An organisation system (5) for organizing items (11), the system (5) comprising: a data structure (10) associating at least one semantic metadata (12) with an item (11) to define a directional relationship between a concept and the item (11); and a user interface (20) to express the at least one semantic metadata (12) in at least one natural language using a description or at least one keyword corresponding to the concept in the at least one natural language; wherein the at least one semantic metadata (12) corresponds to the concept that is a characteristic of the item (11); and the at least one semantic metadata (12) and the item (11) are referenced by unique machine-readable identifiers

### TECHNICAL FIELD

The invention concerns a method and system for organizing items.

### BACKGROUND OF THE INVENTION

Technologies that help organize knowledge are still in their infancy. The most common form of organization that people encounter is the computer file system. Given the large disks of today, it is no longer feasible for someone to recall the precise location of such files every time they need to access it. This problem is far worse in the case of a shared file system within a large organization such as a corporation or a government entity. The design of file systems creates a fragile and brittle mechanism that is no longer practical.

The Internet has pioneered a new paradigm for information storage and communication based on the concept of the hyperlink where web pages may be linked together through a network of hyperlinks. As a system for organization, hyperlinks do not scale well for the size of the Internet. This led to the creation of full-text search engines. However the usefulness of such searches is limited to the relevance of the results. Modern search engines like Google use a variant of this method where the relevance of a page is computed by using their PageRank™ algorithm among other methods. Such methods are not directly applicable in the Intranet scenario. Traditional Information Retrieval problems like precision and recall are encountered. Precision is the ratio of relevant documents to the total number of documents returned as result of a search. Recall is the ratio of relevant documents returned as a result of the search to the total number of relevant documents. In most situations, these ratios rarely exceed 50%. Thus, full-text searching as a method of organization has its limits.

Even on the Internet, search techniques currently used have their limitations. If the information one is looking for is not adequately found within the first few pages of results, then it is not possible to search the millions of hits that typically are returned. There is a desire to dynamically categorize the these hits such that a person can drill down and narrow the list as required and browse the results within that context.

Web directories attempt to organize information on the Internet. A typical problem encountered by such a structure is the creation of categories in such a way that a web site falls clearly within it and not multiple others. Determining the right level of granularity for categories for different and widely varying contexts is difficult, and almost always requires compromises. If categories are not correctly chosen, a site may be in a number of them. If a category is too broad, then there may be too many sites within it for the category to be useful. This type of categorization is not flexible enough to cater to the varying needs of different users as well as change with changing needs. A larger problem is that the categorization is done manually by a staff of people in these directories. Staff make a best effort attempt to understand the uses of a web site but ultimately adhere to a rigid methodology that may not cater to a wide variety of real needs of users on the Internet.

The need for dynamic categorization also is present in forms of communication on the Internet. Traditional methods like forums, Usenet, bulletin boards, chat rooms and others use a rudimentary form of categorization based on the topic of conversation. Perhaps the biggest problem is what may be described as the ‘tragedy of the commons’. The forum attracts people on the basis of its topic. As the group grows larger, the differing interests of the people involved results in messages being posted to the group that is not directly related to the topic. As this ‘out of band’ conversation grows, it results in spamming or even closure of the group. There needs to be a way for special interests to be catered to by drilling down to a specific context while leaving the group's common areas uncluttered. An example of this in Internet scale is Blogs. Again, what is missing is the ability to dynamically categorize each post so that people may retrieve them in a context-sensitive fashion.

Loosely defined categorization is the act of organizing a collection of entities, whether things or concepts, into related groups.

Classification is extensively used in science as means for ordering items according to a specific domain worldview. Most classification schemes in science can seem artificial and arbitrary. These techniques are difficult to adapt to the Internet. Firstly, it requires a clearly understood classification system with broad consensus amongst ordinary users. This is almost impossible because of the requirement to support multiple viewpoints, multiple contexts and multiple uses. Secondly, a person needs to be a specialist, understand each class and diligently apply the organizing principles so that they can classify an item. This method of organization is not practical.

Library science has been devoted to the study of cataloging and classification of documents. There are three types of classification schemes: enumerative, synthetic and analytico-synthetic. The first two systems have major problems. Essentially, they attempt to create an organization of topic hierarchies that all current and future items can be placed. It is impossible to predetermine every single category or even the basic organization structure that is suitable for all purposes. They become outdated easily. Classification structures are by their very definition brittle and unlikely to cater to the needs of the Internet or scale to the size of the Internet.

The third form of classification, originated by S. R. Ranganathan, is called faceted classification. It uses clearly defined, mutually exclusive, and collectively exhaustive aspects, properties, or characteristics (facets), of a class or specific subject. While this may scale to the diversity of content in Internet scale, its major problem is the need for a highly trained specialist to design the facet structure. It is unlikely that faceted classification can be used and readily understood by the general population on the Internet.

Categorization is the process of systematically dividing up the world of experience into a formalized and potentially hierarchical structure of categories, each of which is defined by a unique set of essential features. Each member of the category must exhibit the essential and defining characteristics of the category. However, it is difficult to articulate the defining characteristics of any category, as in real life there is irreducible complexity in such definitions. Such systems typically operate in limited domains where specialists can establish which category something belongs by definition. These characteristics make this form of categorization insufficient for the Internet.

A variant of the above theme is Ontological Classification. Ontological classification only works well within a specialized domain where one has expert catalogers, authoritative sources of judgment, and coordinated and expert users.

Controlled Vocabularies (CV) allows navigation from higher level categories to narrower ones and to find a list of items that correspond to what one is looking for. This method is widely used in Internet websites to organize items. However, a CV is difficult to make. In the attempt to organize items into hierarchies, there is a very thin line between providing useful categories for navigation and putting too many where the entire structure becomes confusing. Each CV is handcrafted to the needs of a particular site, namely the items it contains and the perceived needs of the users of the site. By its very definition, it is managed by a central authority that is responsible for user experience. Trying to replicate a similar mechanism on the Internet in an uncontrolled fashion for the purpose of organizing digital assets is difficult. This technique is not practical for organizing arbitrary information.

Folksonomy is a term used to describe the phenomenon of social tagging as found in sites like Del.icio.us (http://del.icio.us), Flickr (http://www.flickr.com) and Technorati (http://www.technorati.com). Problems with folksonomies include users applying the same tag in different ways (inconsistency) as well as different tags that mean the same thing (the lack of synonym control), both of which give rise to retrieval of non-relevant items. Misspelling, spaces, plural forms, lack of stemming etc. all lead to fragmentation of the content space. Folksonomies suffer from: spamming: people intentionally mis-tag item, mistakes: people make mistakes while tagging, people are lazy: people do not tag accurately or adequately, and that there is more than one way to describe something. All of this makes Folksonomies inaccurate and ultimately unreliable as a method of organizing items.

Clustering is the process of grouping documents based on similarity of words, or the concepts in the documents as interpreted by an analytical engine. Their ability to make relevant groupings is poor. Relying solely on these methods is not a practical option for the Internet.

### SUMMARY OF THE INVENTION

In a first preferred aspect, there is provided a method for organizing items, the method comprising:
associating at least one semantic metadata with an item to define a directional relationship between a concept and the item; and
assigning a unique machine-readable identifier for the at least one semantic metadata and for the item;
wherein the at least one semantic metadata corresponds to the concept that is a characteristic of the item and is expressible in at least one natural language having a description or at least one keyword corresponding to the concept in the at least one natural language; and the at least one semantic metadata and the item are referenced by their unique identifiers.

In a second aspect, there is provided a method for searching items, the method comprising:
inputting a context in the form of a Boolean expression to search for the items, the Boolean expression comprising at least one semantic metadata predicate such that each predicate evaluates whether an item is associated with the semantic metadata;
evaluating machine-readable identifiers of the items; and
retrieving machine-readable identifiers of items having associated semantic metadata causing the Boolean expression evaluate to true;
   wherein items are associated with semantic metadata to define a directional relationship between a concept and the item; unique machine-readable identifiers are assigned for the at least one semantic metadata and for the item; and the concept is a characteristic of the item and is expressible in at least one natural language having a description or at least one keyword corresponding to the concept in the at least one natural language; and the at least one semantic metadata and the item are referenced by their unique identifiers.

In a third aspect, there is provided an organisation system for organizing items, the system comprising:
a data structure associating at least one semantic metadata with an item to define a directional relationship between a concept and the item; and
a user interface to express the at least one semantic metadata in at least one natural language using a description or at least one keyword corresponding to the concept in the at least one natural language;
wherein the at least one semantic metadata corresponds to the concept that is a characteristic of the item; and the at least one semantic metadata and the item are referenced t

In a fourth aspect, there is provided a semantic metadata for enhancing the discoverability of items, wherein the semantic metadata is associated with an item to define a directional relationship between a concept and the item; and a unique machine-readable identifier is assigned for the semantic metadata and for the item; and the at least one semantic metadata corresponds to the concept that is a characteristic of the item and is expressible in at least one natural language having a description or at least one keyword corresponding to the concept in the at least one natural language; and the at least one semantic metadata and the item are referenced by their unique identifiers.

### BRIEF DESCRIPTION OF THE DRAWINGS

An example of the invention will now be described with reference to the accompanying drawings, in which:

FIG. 1 is a schematic diagram of a system in accordance with a preferred embodiment of the present invention;

FIG. 2 is a schematic diagram of an input method in accordance with a preferred embodiment of the present invention;

FIG. 3 is a schematic diagram of inheritance and relationships between concepts in accordance with a preferred embodiment of the present invention;

FIG. 4 is a schematic diagram of TRelated-To and related-To relationships in accordance with a preferred embodiment of the present invention;

FIG. 5 is a schematic diagram of a same-As relationship in accordance with a preferred embodiment of the present invention;

FIG. 6 is a schematic diagram of is-A and related-To relationships in accordance with a preferred embodiment of the present invention;

FIG. 7 is a schematic diagram illustrating a boolean representation of a graph of concepts;

FIG. 8 is a schematic diagram of lexicons within a lexicon store in accordance with a preferred embodiment of the present invention;

FIG. 9 is a schematic diagram of document typing in accordance with a preferred embodiment of the present invention;

FIG. 10 is a schematic diagram of an item store in accordance with a preferred embodiment of the present invention;

FIG. 11 is a schematic diagram illustrating the differences between semi-structures and structured data;

FIG. 12 is a screenshot of a user interface of a directory viewer in accordance with a preferred embodiment of the present invention;

FIG. 13 is an illustration of collapsing the graph structure into the context by a number of hops;

FIG. 14 is a screenshot of a tagging interface;

FIG. 15 is a block diagram of an organisation system in accordance with a preferred embodiment of the present invention;

FIG. 16 is an illustration of expressing concepts to the requirements of a given situation;

FIG. 17 is an illustration of relationships ordered according to their strictness;

FIG. 18 is a process flow diagram of adding or removing an item from the item store;

FIG. 19 is a process flow diagram of editing items in the item store;

FIG. 20 is a process flow diagram of selecting and retrieving items from the item store;

FIG. 21 is an illustration of determining matches from a concept;

FIG. 22 is a process flow diagram of viewing items in the directory viewer; and

FIG. 23 is a process flow diagram of tagging items.

### DETAILED DESCRIPTION OF THE DRAWINGS

The drawings and the following discussion are intended to provide a brief, general description of a suitable computing environment in which the present invention may be implemented. Although not required, the invention will be described in the general context of computer-executable instructions, such as program modules, being executed by a computer such as a personal computer, laptop computer, notebook computer, tablet computer, PDA and the like. Generally, program modules include routines, programs, characters, components, data structures, that perform particular tasks or implement particular abstract data types. As those skilled in the art will appreciate, the invention may be practiced with other computer system configurations, including hand-held devices, multiprocessor systems, microprocessor-based or programmable consumer electronics, network PCs, minicomputers, mainframe computers, and the like. The invention may also be practiced in distributed computing environments where tasks are performed by remote processing devices that are linked through a communications network. In a distributed computing environment, program modules may be located in both local and remote memory storage devices.

In order for a categorization method to be useful, the meaning of the categories must be shared amongst the participants. Information is organized in this invention based on a mechanism that creates an Emergent Vocabulary. This is a vocabulary based on meaning as it emerges in common discourse within a group. Such meanings or concepts have a complex network of associations among them. Structure within meanings is leveraged to provide a form of dynamic categorization that has superior expressive power than traditional hierarchies and ontologies, while remaining simple and natural to the average user. A person is allowed to describe the item in a natural fashion in such a way that the process of describing allows the item to be categorized for efficient retrieval by the group. Such relationships are the in the form of a general cyclic network. Furthermore, each participant may have a slightly different way to organizing the same ideas. Different worldviews of such organization are catered for in a single coherent structure such that different worldviews do not interfere with each other. Simultaneous existence of different structures is supported.

This invention recognizes that the organization of information in a shared system is fundamentally a communicative act. When files are named in a file system or items are tagged in a Folksonomy, the contents of these objects are being communicated to others. This shares many of the properties required for emergence that natural languages have and indeed synergize with natural language to achieve such a goal. As such, the act of describing objects in a shared directory where the object is readily available for examination is a much simpler one than the task that natural languages have to cater to. Natural language must be able to communicate moods, emotions, thought, etc. that are much less likely to have broad consensus than a directory of ‘things’. However, like emergence in other complex systems, emergence of order in such directory systems is critically dependent on the exact mechanism used, the level of information flow within the system and the initial conditions of the system.

Dynamic categorization of unstructured or semi-structured data that is commonly found on the Internet or in computers is provided. It relies on people to categorize the items within a directory while focusing on making it easy for ordinary users to do so and derive high value at relatively low cost. The basic structure is designed around using semantic metadata by leveraging natural language from a categorization perspective. It creates mechanisms that allow efficient information flow among participants such that emergence is reinforced while noise within the system is dampened. It creates a self-organizing directory that orders items according to actual needs of the entire user population as opposed to be being mandated by an arbitrary, central authority. It may be extended to provide a common mechanism that allows for addressing the entire range of data—from unstructured, semi-structured to structured data like databases. Items may be files, web sites, emails or any other digital data or any thing that is identifiable with a unique identifier such as mental abstractions or concepts identified by a URI, physical items with bar codes, items with RFID, people, and entities. It is usable within existing applications, a web directory or even synergize with full-text search engines.

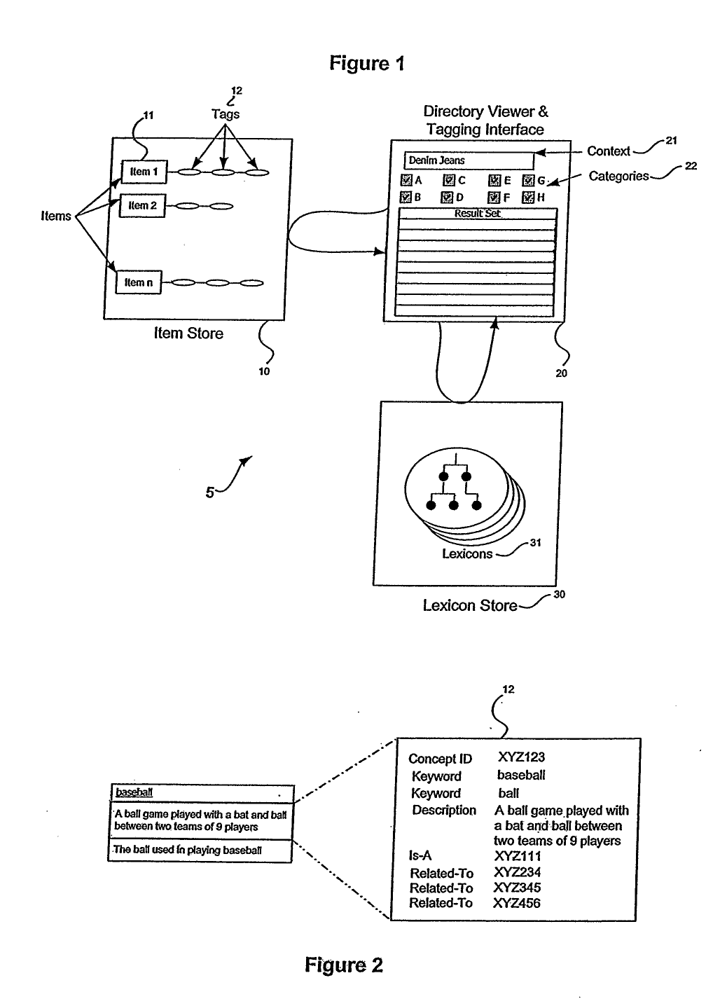

Referring to FIG. 1, an organization system 5 is provided where a directory of items 11 enables association of semantic metadata or semantic tags 12 with each item 11 within the directory. It generally comprises the following components: a Lexicon Store 30, an Item Store 10, an Input Method, a Directory Viewer 20 and a Tagging Interface 25. Each semantic metadata element 12 or tag 12 comes from a specific Lexicon 31. A Lexicon 31 is a data structure that holds tags 12 and their inter-relationships. The Lexicon Store 30 manages all the Lexicons 31 in use within the system 5. For a tag 12 to be used in the Item Store 10, there must be a corresponding Lexicon 31 in the Lexicon Store 30 that holds the tag 12. The Item Store 10 manages all the items 11 with the Directory. The Input Method is disclosed in the previously filed cross-related application, the contents of which are herein incorporated by reference.

The Item Store 10 contains a unique identifier for each item 11 along with its associated tags 12. The Input Method is a mechanism that allows a user to look up and specify tags 12. This is used in the Directory Viewer 20 as well as the Tagging Interface 25. The Directory Viewer 20 is a front-end user interface application that allows a user to query/browse the items 11 within a directory by specifying a context 21 that is made of a Boolean expression of tags 12. This communicates with the Item Store 10 to retrieve matching items 11 and displays them to the user. It also allows the user to successively drill down into more focused contexts 21. The Tagging Interface 25 allows the user to add or modify tags to an item. This may be used in conjunction with the Directory Viewer 20 and allow the user to see items 11 matching a set of tags 12 while tagging and correspondingly allow the user to tag items 11 while viewing an item listing of a context 21.

The semantic tag 12 (or semantic metadata or tag) is a unique machine-readable identifier (such as a URI, a hash code or a sequence of bits) corresponding to a concept or a meaning that is able to be shared or communicated between people. In a natural language, words are created to represent meanings to be conveyed. In order for a word to be effective, it's meaning must be shared by its users. While anyone may create a word, the set of meanings actually used emerges as a form of group consensus based on usage. The semantic tag 12 corresponds to such a meaning.

There is a difference between a concept that is expressible in a natural language at a given point of time and one that is not. Any concept may be expressed in natural language regardless of whether it represents a real, physical item or it is completely a mental abstraction of a single individual. Thomas More's Utopia or Conan Doyle's Sherlock Holmes never existed in the real world yet they are expressible in natural language by words representing them because there is a certain level of shared meaning that is sufficient for communication. On the other hand, concepts like mathematical notions, inventive aspects in patent applications or new business models that are not commonly understood by a large enough section of the intended audience, do not correspond to concepts that are readily expressible. While the mechanism includes the ability to assign semantic metadata 12 to any concept, the real semantics of that metadata 12 will emerge through actual use by the group of users.

Semantic metadata 12 are also different in some ways from what is commonly found in natural language dictionaries. A dictionary meaning of a word may not be the one used within a particular group of people. There either needs to be a separate semantic tag 12 for each such meaning or allow a more generic one to remain underspecified until there is a need to discriminate between the commonly accepted meaning. Another important aspect of semantic metadata 12 different from traditional dictionaries is that the meaning of the metadata 12 may be described by means other than text. For example, in corporate branding, the brand may be built up with a logo or a corporate jingle. Each of these is a valid description. Therefore, the description or keywords of a semantic tag 12 may include an image, a sound clip, a video, Braille, and possibly a scent and a taste if future technologies allow such things to be efficiently communicated.

Each meaning and its corresponding semantic metadata 12 is required to have a separate unique identifier. Natural language words or phrases may be mapped to semantic metadata 12 on the basis of meaning. The word “baseball” could mean the game of baseball or the ball used to play it. Each of those meanings would require a separate semantic metadata 12. However, “The man who invented Relativity” and “Albert Einstein” refer to the same person and therefore represent one semantic metadata.

The terms ‘concept’ and ‘meaning’ are used interchangeably. An extensive survey of definitions used for concepts, etc. in current scientific literature is found in “Classification: Assumptions and Implications for Conceptual Modelling” by Tor Kristian Bjelland. In general most commonly accepted definitions revolve around the method of defining concepts in terms of their intension and extension. The intension is the set of attributes, criteria or rules used to decide whether a particular object is categorized by the concept, and the extension is the set of objects that match against the concept. For natural language meanings to map to this model, one might have an arbitrarily large and irreducibly complex intension with an equivalently large and varied extension. It is generally not possible for the current state of art to make this feasible.

A “I know it when I see it” form of definition is used for concepts. A native speaker of a natural language looks up a dictionary to find out the meaning of an unknown term and understand it on the basis of the explanation of it written there. In a similar fashion, ‘concepts’ or ‘meanings’ correspond to entries in the Lexicon 31 where a person unfamiliar with it understands it by reading the keywords or description associated with it and/or looking at the items 11 tagged by it. Tags 12 include nouns, other parts of speech and phrases (adjective forms such as ‘Market-Driven’ are common buzz-words in normal practice). This definition is extended to encompass anything that can be described and understood as a single unit of meaning like ‘The man who invented Relativity’. Concepts in a Lexicon 31 do not intrinsically contain meaning but are rendered a meaning in the mind of the user by consistent use by a community in a particular context 21.

Referring to FIG. 2, an Input Method is provided for users to specify tags 12. Each tag 12 is defined by its unique identifier and is described by any number of keywords or descriptive strings in natural languages. For concepts that span multiple languages, such keywords are in multiple languages. Each concept may have a descriptive string that gives scope notes or usage guidelines. The input method allows someone to intuitively convert an intended meaning into a specific tag 12 held in the Lexicon 31.

By using the Input Method, what is tagged is a unique concept. Therefore, a disambiguated categorization of items 11 is created by the tagging process itself. A user is able to discover such items 11 by specifying the tag 12 that best matches the user's need and the system finds all the items 11 that are tagged by such a tag 12.

However, even with semantic categories, items 11 that a user is looking for may still not be found. As an example, a user looking for photographs of Asia should be able to find a photograph tagged ‘Bali’, ‘Beach’, ‘Sunrise’. This is because Bali is in Indonesia and Indonesia is in Asia. Further organization is based on the inter-relationships of tags 12 themselves. By defining tags 12 in terms of meaning, such tags 12 are associated with others on the basis of multiple types of relations.

Most people have little difficulty in perceiving a relation between the concept ‘Santa Claus’ and the concept ‘Christmas’. The exact nature of this relation may be different depending on the person and different according to the items 11 being categorized by these concepts, nevertheless there is a relation that is generally valid as opposed to globally true. It is possible to link these two concepts with a relationship that intuitively understood by an average user. So a user looking for items 11 related to ‘Christmas’ may not be surprised to find items 11 related to ‘Santa Claus’. The organization of such concepts must ultimately reflect an individual's or group's worldview while maintaining a shared paradigm for discovering items 11.

The primary purpose of the directory structure is to enhance discoverability during a user's search for items 11. A user that knows the precise category or categories they are interested can find them directly. The effect of placing concept-to-concept relations is to discover more items 11. As long as there is a ranking system that sorts items by their relevance, the simple addition of more items 11 does not pose major a problem. Secondly, there is no general truth in what is relevant to one user is necessarily relevant to another. Each individual may have their own personal view of which concepts are related to which other concepts. Therefore, this system 5 separates the organization of concepts from the Item Store 10 where items 11 are managed. This allows multiple simultaneous organizations on the same data without conflict. Such organizations may change with time without affecting the data stored. Finally, ranking in this mechanism is based on usage. This allows useful relationships to be promoted while less relevant ones fade away. Essentially, the mechanism is forgiving to mistakes.

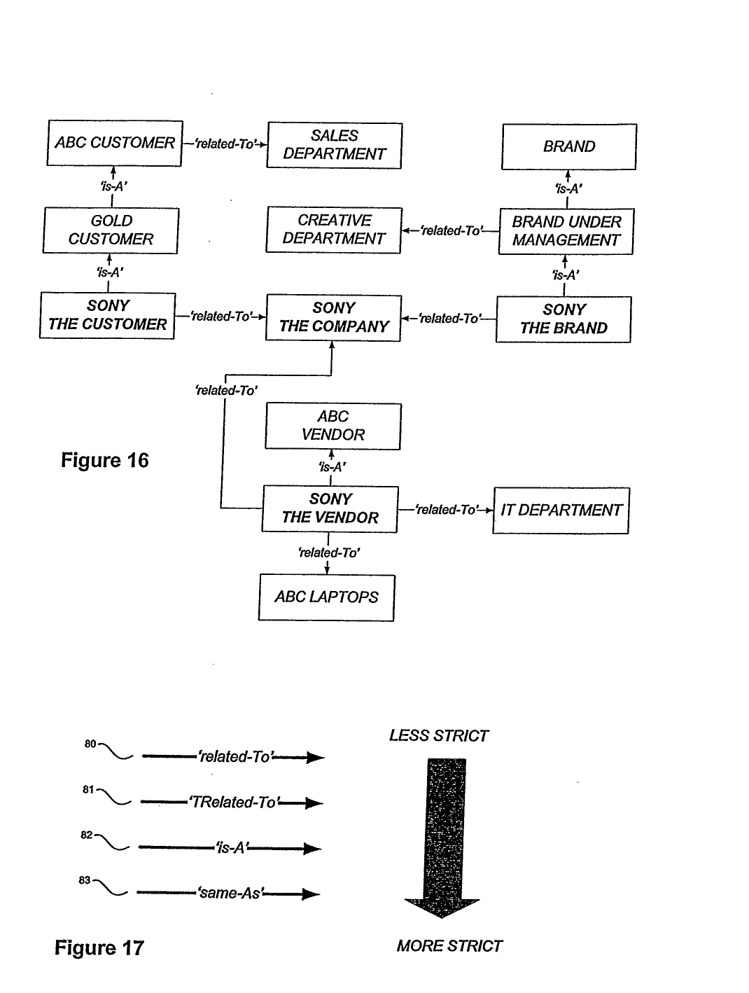

Referring to FIG. 17, four types of relationships are defined: the ‘related-To’ relationship, the ‘is-A’ relationship, the ‘TRelated-To’ relationship and the ‘same-As’ relationship. These are directed named relationships. The basic description of these relationships is as follows:

### Is-A Relationship

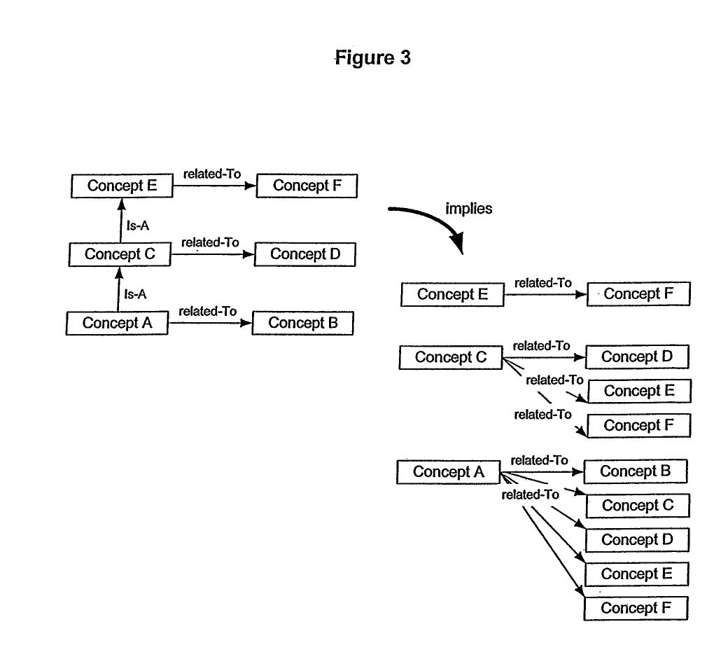

Referring to FIG. 3, there are many words in common use and terms in domain use that are specifically there to represent a hierarchy. There are many concepts in scientific use that exhibit this property. The ‘is-A’ relationship is designed to capture such relationships between concepts. It is similar to traditional type relationships. If ‘Concept A’-is-A→‘Concept B’ then all items 11 categorized by ‘Concept A’ is also categorized by ‘Concept B’. The semantics of the ‘is-A’ relationship is that of a class-subclass relationship where Concept A is a subclass of Concept B. This implies that it can take the place of all its parents/grandparents/etc. with no contradiction to the intent of the tag 12 while allowing for more specificity.

The ‘is-A’ relationship means that all the characteristics of the parent concept are inherited by the subclass concept. All the outgoing ‘related-To’ and/or ‘TRelated-To’ relationships of the parent are inherited by the subclass. This is a transitive relationship, which means that all the ‘related-To’ and/or ‘TRelated-To’ relationships of all the classes above the subclass are inherited by the subclass. The preferred embodiment for the structure of concepts in this relationship is that of a set of trees. This means that the ‘is-A’ relationship defines a classical hierarchical structure. In other embodiments, multiple-inheritance may be supported implying that the graph of concepts with this relationship is a set of Directed Acyclic Graphs.

In FIG. 3, the concepts ‘A’ and ‘C’, inherit all the outgoing ‘related-To’ relationships of their parents going up the ‘is-A’ tree. This means that concept ‘C’ is ‘related-To’ concepts ‘E’, ‘F’ as well as ‘D’, and concept ‘A’ is ‘related-To’ concepts ‘E’, ‘F’, ‘C’, ‘D’ as well as ‘B’. The ‘is-A’ relationship is a stricter form of the ‘related-To’ relationship. This implies that any concepts joined by an ‘is-A’ relationship is also considered to be joined by a ‘related-To’ relationship. Therefore, ‘C’-related-To→‘E’, and ‘A’-related-To→‘C’ and ‘A’-related-To→‘E’. The ‘is-A’ relationship is also convenient shorthand for expressing ‘related-To’ relationships in a succinct and intuitive manner. By placing an ‘is-A’ relationship on an item, the item effectively inherits all the relationships of its parent in a transitive fashion. When a user looks for items that match a concept, they may also be looking for items that match any subclass of the concept. When a user tags an item 11 with a concept, they may be effectively tagging the item 11 with all parent concepts as well.

There are concepts that are difficult to define a parent concept for (like ‘Client-Server’). Concepts may not be explicitly typed through an ‘is-A’ relationship. In this case it is implicitly typed through an ‘is-A’ relationship to a generic concept called ‘Concept’.

### TRelated-To Relationship

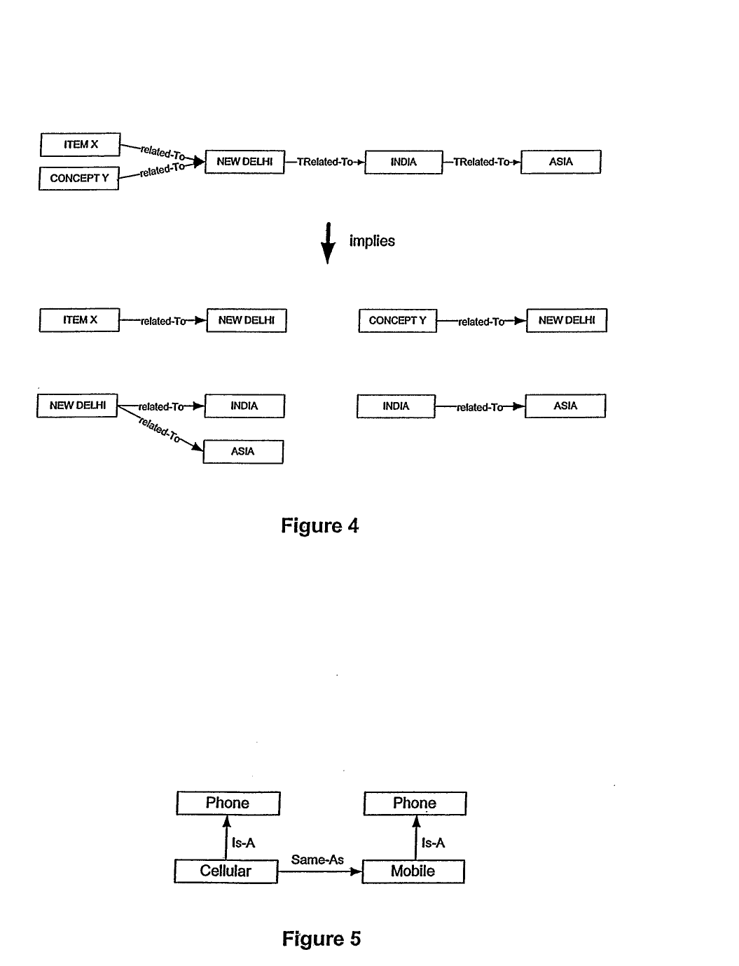

Referring to FIG. 4, the ‘TRelated-To’ is a transitive form of the ‘related-To’ relationship. The concept ‘New Delhi’, ‘India’ and ‘Asia’ are connected by ‘TRelated-To’ relationships. This implies that ‘Item X’ and ‘Concept Y’ are only ‘related-To’ ‘New Delhi’ but ‘New Delhi’ is ‘related-To’ ‘India’ as well as ‘Asia’ and ‘India’ is ‘related-To’ ‘Asia’. The graph formed by concepts that are connected by the ‘TRelated-To’ relationship is a set of Directed Acyclic Graphs (or a DAGs). The ‘TRelated-To’ relationship is a form of the ‘related-To’ relationship so wherever two concepts are joined by the ‘TRelated-To’ relationship they are considered as joined by the ‘related-To’ relationship. The ‘is-A’ relationship is also a stricter form of the ‘TRelated-To’.

### Related-To Relationship

Referring back to FIG. 3, the major method of organization in the Directory is through the use of a ‘related-To’ relationship. This is a named, directed relationship between an item and a concept, or a concept and another concept. This structure or organization pushes the semantics to the source and target concept. Since the ultimate user of this mechanism is a person, the pushing of semantics into the concept is a level of ambiguity that a person may be comfortable with.

The ‘related-To’ relationship however defines semantics that go beyond linking two concepts. Most of the concepts in this mechanism are defined to be used as categories and therefore serve as groupings of items 11. The statement, ‘Concept A’-related-To→‘Concept B’, means that items 11 that are categorized as ‘Concept A’ from a certain perspective are characterized by ‘Concept B’ (“computer” is a characteristic of “computer science” in that computer science is a science that is focused on studying computers). This does not mean that all such items 11 are categorized as ‘Concept B’ (computer science is not a computer). It is so if ‘Concept B’ characterizes all the items 11 from all points of view. In this case, ‘Concept A’ is a subclass of ‘Concept B’. The ‘related-To’ relationship is a directed one. This means that ‘Concept A’ is not said to characterize items 11 categorized as ‘Concept B’.

Although the above is an intuitive explanation of the ‘related-To’ definition, it may be instructive to compare it with more formal definitions of concepts and attributes. A semantic metadata may correspond to an arbitrarily complex intension and an arbitrarily large and varied extension that corresponds to the user's understanding of the term and neither of which is specified in the implementation of the mechanism. In general, any item can have an arbitrarily large number of attributes that may be perceived by a user, but off them the user selects a meaningful subset that serves as the defining attributes for determining whether the item is a member of the concept or not. Depending on the point of view or the intended purpose of the user, this set of defining attributes may change. Also, in the general case, some attributes maybe considered more representative in defining the concept than others. The term “characteristic” embodies all these notions. A concept is said to be a subclass of another concept if it shares all the defining characteristics of the superclass concept and has some other unique characteristics of its own that allow it to distinguish itself from the superclass. In the case of the ‘related-To’ relationship above, a concept is related to another concept if it has a subset of the defining characteristics of the other concept as a subset of the set of defining characteristics of itself. It is considered that the other concept serves as a characteristic of the concept. However, exact specification of such attributes and relationships are neither required nor desirable. The ‘related-To’ relationship may be placed between two concepts that intuitively bear such a relation. Even if it is wrong, the emergent mechanisms based on ranking will promote relevant relationships and demote non-relevant ones.

Significant benefits may be acquired from an underspecified relationship between concepts. In the case of item-to-item relationships, the hyperlink may be considered to be an underspecified relationship. It is a directed relationship that connects one item to another and is associated with a human readable text at its origin. The text of the hyperlink allows the user to understand the implied meaning of the link. The Internet is an example of the usefulness of such a link. In a fashion that has some parallels, it is possible to link items-to-concepts and concepts-to-concepts together with an underspecified directed relationship. Unlike the item case, such a link needs to be augmented with the above semantic definition.

The semantics of the ‘related-To’ relationship is different from relations/properties used in Knowledge Representation. This is because the definition of the relationship is derived from both the concept it points to as well as the concept it points from. That means every ‘related-To’ relationship may be semantically different from every other ‘related-To’ relationship from the perspective of traditional ontologies. The semantics of the ‘related-To’ relationship is left underspecified by design. The mechanism leverages human understanding without having to replicate it. In the above example, ‘New Delhi’-related-To→‘India’ is considered as an amalgamation of many traditional relationships like ‘capital-of’, ‘located-in’, etc. Each has different semantics. The ‘located-in’ relationship is transitive such as ‘India’-located-in→‘Asia’ also means that ‘New Delhi’-located-in→‘Asia’. However, the same is not true for ‘capital-of’. Thus, the ‘related-To’ relationship in general is not transitive. In fact, as one traverses the ‘related-To’ graph, each hop increases the semantic distance between the start and end concepts. This may be understood by considering the notion that as one traverses the ‘related-To’ graph, the concept is less and less characterized by the original concept as at each hop, the set of defining characteristics it shares with the original concept decreases. It is possible for two concepts to have the ‘related-To’ relationship in the form of a cycle, e.g. ‘Baseball (the ball)-related-To→‘Baseball (the game)’ as well as ‘Baseball (the game)’-related-To→‘Baseball (the ball)’. Essentially, the relationship in each direction may be semantically different as per traditional ontologies. The graph formed by the ‘related-To’ relationship in general is a cyclic network. Furthermore, since the definition of the relationship is based on characterizing items, depending on a set of items 11, a ‘related-To’ relationship may make perfect sense but may not hold true in the all cases. In the specific cases concepts like ‘New Delhi’, ‘India’, etc. may have a significant transitive nature due to the relationship-located-in→that may be the prevalent relationship in the items in a directory. Therefore, it may make sense in some situations to use a ‘TRelated-To’ relationship to give the express a transitive relation.

### Same-As Relationship

Referring to FIG. 5, the ‘same-As’ relationship is an equivalence relationship. It is possible that two concepts may have started out as different meanings but over time effectively mean the same thing. The concept ‘Cellular’ and ‘Mobile’ may have started out referring to two slightly different things but as the industry progressed have become synonymous. The ‘same-As’ relationship is used to link these two concepts together. This relationship is reflexive, symmetric as well as transitive. This means that for any concept ‘Concept A’, ‘Concept A’-same-As→‘Concept A’ is true. For any two concepts—‘Concept A’ and ‘Concept B’, ‘Concept A’-same-As→‘Concept B’ implies ‘Concept B’-same-As→‘Concept A’. Also, for any three concepts—‘Concept A’, ‘Concept B’ and ‘Concept C’, it is the case that ‘Concept A’-same-As→‘Concept B’ and ‘Concept B’-same-As→‘Concept C’ implies ‘Concept A’-same-As→‘Concept C’. The ‘same-As’ relationship is a stricter form of the ‘is-A’ relationship. For a ‘same-As’ relationship to be placed between two concepts, they must have an ‘is-A’ relationship to the same parent concept (in the case of single inheritance), the two concepts must have the same children concepts (in this case a merge of the children concepts for each concept must take place) and the resulting tree have the same semantics similar to a tree of ‘is-A’ relationships (all outgoing ‘related-To’ and ‘TRelated-To’ relationships of all parents are inherited by all the children. Items and concepts cannot have a ‘same-As’ relation between them.

The ‘is-A’ and ‘related-To’ relationships work equally well between items in the Item Store 10 and concepts as they do for concepts and concepts. Items may be typed with a ‘is-A’ relationship similar to concepts. For example, if an item -is-A→‘Concept A’, then it has the same characteristics in all respects as any other item of ‘Concept A’. It inherits all such characteristics in the form of outgoing ‘related-To’ and ‘TRelated-To’ relationships of all superclasses of ‘Concept A’ as well as those of ‘Concept A’. This is called typing an item 11 and such typing is equivalent of placing a number of relationships simultaneously (and automatically) against the item. The item 11 may have a ‘related-To’ relationship between it and a concept. This implies that the concept is a characteristic of the item 11. This is referred to as tagging. There is little difference between tagging/typing items 11 and tagging/typing concepts. Thus, the ‘related-To’ and the ‘is-A’ relationship define universally applicable relationships across concepts as well as items 11.

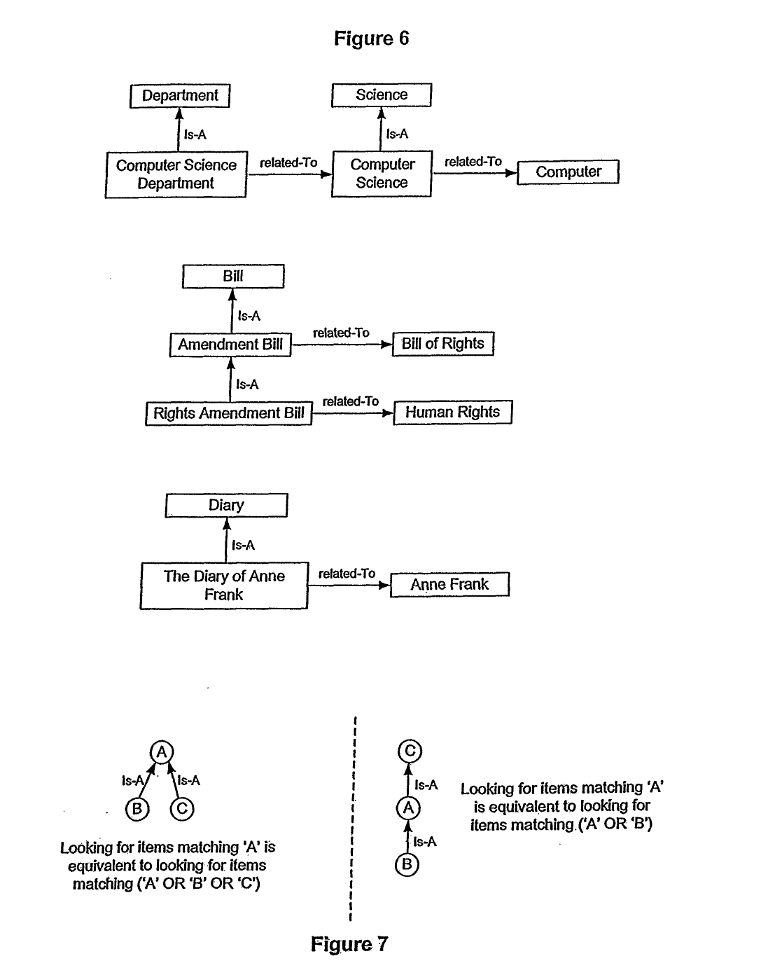

Referring to FIG. 6, an example for organization that resembles ordinary language is illustrated. Most noun phrases, complex nominals and genitives readily align themselves with such an organization. A vast amount of domain oriented or group oriented terminology that comes in such forms may be incorporated. For example, ‘Computer Science Department’ may not make sense in a context but might be perfectly clear in the context of a university. Such a group extends to a common set of concepts to reflect their unique requirements. ‘Rights Ammendment Bill’ is found in a domain specialized in politics. The exact form of ‘is-A’ versus ‘related-To’ for each of these reflects usage. In ‘Computer Science Department’, ‘Department’ ‘related-To’ ‘Computer Science’ may be a more relevant descriptor than ‘Science Department’ ‘related-To’ ‘Computer’. Similar is true for ‘Right Amendment Bill’ although in a different graph of relationships. Thus the organization structure does not limit expressiveness yet is intuitive and creates a set of inter-relationships.

The organization of concepts in the Directory is detached from the storage of items 11. This is due to tagging/typing of items 11 in the Item Store 10 with semantic metadata 12 whose meanings are self-contained. Therefore, it is possible for a user to take their individual graph of concepts and serialize it to a Boolean representation that is then matched against items 11. This Boolean expansion is not limited to expanding on the ‘is-A’ relationship but covers the entire set of defined relationships. The resultant Boolean expression captures the entire organization. It is because of this that the organization structure does not need to be shared.

Referring to FIG. 7, a naïve organization structure for concepts of two users is shown. They are clearly in conflict and cannot be merged into a single graph. The two users may use the same underlying data and yet maintain both schemes. At time of querying the Item Store 10 to find items 11 that correspond to concept ‘A’, each user collapses their organization structures to a Boolean expression of concepts. In the case of User1, since ‘B’ and ‘C’ are considered subclasses of ‘A’ the user is interested in finding items tagged with ‘A’, ‘B’ or ‘C’ or any combination of these tags. User2 on the other hand limits the search to tags ‘A’ or ‘B’ or both. It is not relevant which user's worldview is “correct” as long as the Item Store 10 processes the queries accurately.

This ability addresses diverse and conflicting requirements and creates an organization structure that scales to groups of any size (performance implications aside). The separation of the view from the data allows the creation of views by third parties independent of the owners or creators of the data. This may take the form of commercial products, open source as well as administrator-based solutions that a user leverages to organize items. The user reuses existing solutions and retains the ability to change it for suitability.

Another advantage of using Boolean expression for queries is the fact that such items 11 are discovered even if the concept that it is tagged with is not known to the user or a concept corresponding to the user's need does not exist. At the time of expansion of concepts, if a concept is known to match the Boolean expression, it is included into the query. This aids the user in discovering related concepts, which is useful if the Directory is being used in a group where different members create concepts independently of each other. This is also useful in situations where the user is not exactly sure of what they are looking for but can describe some relevant characteristics. The Boolean expression serves as a virtual concept where a real one may not yet exist. The expression serves as a predicate function based on characteristics of items 11 that are used to determine whether the item 11 belongs to the concept or not. The Boolean expression allows for the search by type 13. This may be done by constraining the expression to -is-A→‘Concept X’, such that the search is limited to items 11 of that type 13 only. This may be extended in the general case into a Boolean expression. Therefore, to search for item -is-A→‘Computer’ OR item -is-A-→‘Printer’ is possible.

The Boolean expression of concepts corresponding to a user query is called a Context 21.

Another advantage of organizing the tags 12 and relationships in the fashion described above is that the result set of items that correspond to a context 21 are already tagged with the drill down categories. Every tag 12 on an item 11 serves as a grouping of items 11 characterized by the concept. Some tags 12 may be associated with a number of such items 11. Therefore, each such concept allows the user successively drill down to narrower contexts until the desired items 11 are found. These drill down categories form dynamically based on the characteristics assigned to actual items 11 in the Directory. At every stage, the same method recursively ensures that the categories available at that stage are based on actual items 11.

### Drill Down Process

The drill-down behavior is considerably different from the drill down behavior commonly found in hierarchies like folders or CVs. This is due to different semantics arising from whether the tag 12 is related to concepts in the context 21 or not. If a tag already exists in the context 21, it can be removed from the set of drill-down tags. If a tag is not related in any fashion to any concept in the context 21, then it may be added to the context 21 with a logical AND during drill-down, and in many ways serves a facet-like role for narrowing the result set. Such a tag 12 is called independent. If the tag 12 is related to (or dependent on) one or more concepts in the context 21, then depending on the nature of the relationship (‘is-A’, ‘related-To’, etc.) drilling down will cause the context 21 to change in different ways. If the tag 12 is a superclass of a concept in the context 21, then it can be removed from the tags 12. If the tag 12 is a subclass of a concept in the context 21, then drill-down is the equivalent to replacing the superclass in the context 21 with the subclass and recomputing the resulting item set. This is so because the drill-down tag represents a stricter condition that the one it replaces. Since the graph of the ‘is-A’ relationship is a set of trees, such a subclass drill-down tag can affect at most only one concept in the context. The same is not true with regards to the ‘related-To’ relationship.

It is assumed that when a ‘Concept A’-related-To→‘Concept B’, then the expression (‘Concept A’ AND ‘Concept B’) is equivalent to (‘Concept A’). This is because all items in ‘Concept A’ are considered to be characterized by ‘Concept B’ and therefore represents a subset of items 11 that can be considered as a logical intersection of ‘Concept A’ and ‘Concept B’. While the above may not be strictly true in a formal sense, it gives reasonable approximation with respect to drill-down behavior. Take the example of ‘Denim Jeans’ where ‘Denim Jeans’-is-A→‘Jeans’ and ‘Denim Jeans’-related-To→‘Denim’. The context (‘Denim’ AND ‘Jeans’) should expand to ((‘Denim’ AND ‘Jeans’) OR (‘Denim Jeans’)). When the user drills down to ‘Denim Jeans’, then the concepts ‘Denim’ and ‘Jeans’ in the context 21 are substituted with ‘Denim Jeans’. This is different from the case of expansion based on the ‘is-A’ relationship alone where the resulting context after drill-down would be ‘Denim’ AND ‘Denim Jeans’).

In the case where there more than two related concepts in the context 21, the above logic may be repeated in a recursive fashion. Take the case of ‘Computer Science Department’ in a previous example. A context like (‘Computer’ AND ‘Science’ AND ‘Department’) would expand to ((‘Computer’) AND (‘Science’ OR ‘Computer Science’) AND (‘Department’ OR ‘Computer Science Department’)). In the expansion of this expression, there occurs a term (‘Computer’ AND ‘Computer Science’ AND ‘Computer Science Department’). Using a similar logic to the case above in a recursive fashion, this term can be reduced to (‘Computer Science Department’). Therefore, the final context after such expansion is ((‘Computer’ AND ‘Science’ AND ‘Department’) OR (‘Computer Science’ AND ‘Department’) OR (‘Computer Science Department’)). This not only brings in all the relevant concepts into the expanded query, it responds to drill down behavior for both ‘Computer Science’ as well as ‘Computer Science Department’. Drilling down to ‘Computer Science’ replaces ‘Computer’ and ‘Science’ in the context. Drilling down to ‘Computer Science Department’ replaces all the concepts in the context. In the general case, if the drill-down behavior of the tag 12 that is related to or dependent on a number of concepts in the context 21, then drill-down is equivalent of replacing all such context concepts with the drill-down tag 12. If the concept is related to all concepts in the context 21, then on drill-down to the tag 12 the entire context is replaced with the tag. A tag 12 is considered to be related to or dependent on a concept in the context 21 if it or its superclasses have at least one outgoing ‘related-To’ or an ‘is-A’ relationship to the concept or its subclasses.

In the examples above, the relationships supported were ‘is-A’ and ‘related-To’. The mechanism may be easily extended to embody the ‘TRelated-To’ and the ‘same-As’ relationship. All that is required is for the ‘TRelated-To’ graph to be collapsed to a set of ‘related-To’ relationships (which can be done with no loss of information), prior to context expansion. The ‘same-As’ relationship similarly can be handled as collapsing to one of the two concepts with the relationship, perform context expansion as above and then recombine the other concept with a logical OR in the final expression.

The above method can completely collapse all the information contained in the relationship graph into a Boolean expression. The expanded query is naturally divided into a number of smaller queries that may be faster for the Item Store 10 to process. The client may provide hints of semantic distance trapped in the relationship graph to an Item Store 10 that will have no such notion. The Boolean expression is presented in a sorted fashion such that the concepts closest to the intension of the query may be processed first. In the example for (‘Computer’ AND ‘Science’ AND ‘Department’) is presented with the sub-query ‘Computer Science Department’ first because it is the only concept that captures all the relevant characteristics of the query. Alternatively, each term in the expression may be assigned a weight that represents semantic distance. The Item Store 10 can receive such a query and choose to process it on the basis of the semantic order supplied by the client or it may use other criteria. This can include criteria such as the Item Store 10 having usage data on what drill down category the group uses with this context and processing that sub-query first, or using a previously cached results of a sub-query to give a quick response.

### Browse Path Process

By defining the ‘related-To’ relationship as above, it may serve as a browse path in the reverse direction. Referring back to FIG. 6, when a user is looking at items 11 matching the context (‘Computer’), they may be interested in items 11 tagged ‘Computer Science’. When drilling down, the concept (‘Computer’) in the context is replaced with ‘Computer Science’. When looking at items 11 matching (‘Computer Science’), they may be interested in items 11 tagged ‘Computer Science Department’. The inherent structure in the related-To information is leveraged to create a browse path behavior that is similar to web directories or folders in a file system. Such a browse path behavior is not that of traversing a tree like current directories but the equivalent of walking a general cyclic graph.

Browse path behavior requires that an item 11 that is either tagged or typed with a concept that have an outgoing ‘related-To’ relationship with a concept in the context 21, to be matched against the context 21. This is different from the default matching process where only the items typed would match because they inherit ‘related-To’ relationship to the context concept. This may be valid because many, if not most, of the items 11 stored in a directory are typically about something. As an example, a book about bridge construction may be considered also a book about bridges. So if a user is looking for books on bridges, they may have some interest in a book on bridge construction. All the defining characteristics of each tag 12 are considered to be in the set of defining characteristics of such an item 11. A query for a superclass of a tag 12 of an item 11 should match against the item tag 12 as well. Thus, the query expansion of the above example would work with tags 12 as it would with types 13. It should be noted that for items 11 that are not about something (e.g. a laser printer toner, etc.) this might not be the case. If a directory involves many such items 11, then an implementation may cater to this by defining a new relationship type like ‘about’ that can be used instead of ‘related-To’ for items 11 that are about something to reflect inheritance and use ‘related-To’ for the rest. All items 11 in the Directory are assumed to be about something and only the ‘related-To’ relationship is used between items 11 and concepts.

Another important benefit of such a behavior is that the ‘TRelated-To’ relationship, if one exists, for a tag 12 may be collapsed and inherited by the item without having to require the user to place a ‘TRelated-To’ relationship with the item. For example, if an item is tagged ‘New Delhi’ in FIG. 4, may be considered to be related to ‘India’ and ‘Asia’. This behavior allows all the information available in a graph of concepts to be adequately mapped to items 11 just on the basis of the ‘is-A’ and ‘related-To’ relationship.

### Lexicons and the Lexicon Store 30

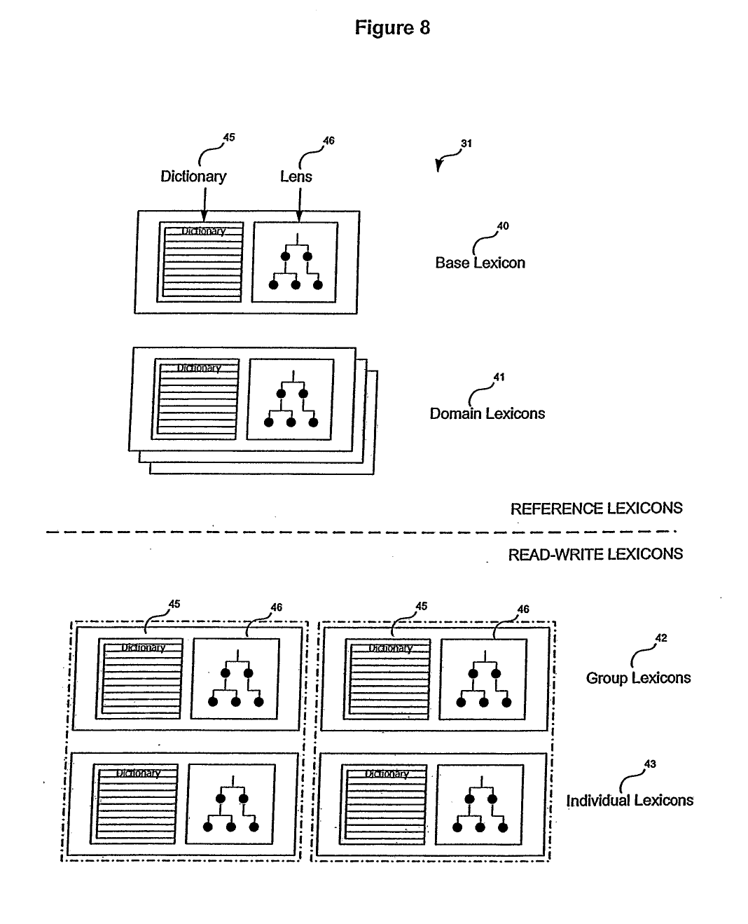

Referring to FIG. 8, a Lexicon 31 is a logical collection of concepts and their relationships. It consists of two separate components: a Dictionary 45 and a Lens 46. A Dictionary 45 is the collection of all the concepts within the Lexicon 31 and their corresponding definitions like unique identifier, keywords, and description. This is a flat structure with no inter-relationships between concepts and in many ways is similar to a traditional dictionary. A Lens 46 corresponds to all the inter-relationships (as defined by the above relationship types) between concepts. Such concepts may be from the Dictionary 45 associated with the Lexicon 31 or from Dictionaries in other Lexicons 31. The Dictionary 45 defines the concepts held within a Lexicon 31. The Lens 46 allows structure to be placed against concepts. A Lexicon 31 has either a Dictionary 45 or a Lens 46 or both. A Lexicon 31 that contains only a Dictionary 45 means that concepts within the Lexicon 31 have a flat structure. A Lexicon 31 that contains only a Lens 46 is a Lexicon 31 that may provide structure to other Lexicons 31. Each Lexicon 31 is identified by a unique identifier. Each concept within a Lexicon 31 has a unique identifier within it. Lexicons 31 may also have globally unique identifiers so that they may be shared across an open system like the Internet. Concepts may also be named with other globally unique naming scheme such as URI (Universal Resource Idenitifer).

Relationships within a lens 46 such as ‘Concept A’-related-To→‘Concept B’ are assumed to hold generally true, even if there is no item in the Item Store 10 that is explicitly typed or tagged with ‘Concept A’ or ‘Concept B’. This serves as the basis of a reusable Lexicon 31 of concepts and their inter-relationships such that commonly known associations exists prior to the use of a Directory and users leverages them. Such commonly accepted relationships are complemented by new relationships that occur in a more restricted domain or even based on the actual items within the Item Store 10. Existing relationships may be updated or deleted depending on the user or group. Concepts are created or updated. All this is done at the Lexicon level so that a group interacts at one Lexicon 31 without affecting another group that interacts in another Lexicon 31.

Referring to FIG. 8, a Lexicon Store 30 manages Lexicons 31 stored within it. There are four types of Lexicons in the Lexicon Store 30. They are broadly categorized into Reference Lexicons and Read-Write Lexicons. There is a Base Lexicon 40 that covers core concepts across a language and is similar to a general lexical dictionary of concepts across a language. Such a Lexicon 40 is widely used and serves as a base lexicon for all users. A user typically requires a number of domain specific Lexicons 41. All these Lexicons 40, 41 are considered to be Reference Lexicons. Reference Lexicons 40, 41 are stored within the Lexicon Store 30 in a read-only fashion, which means that users of the system are not allowed to modify it.

Group Lexicons 42 are Read-Write Lexicons in that they allow the users to modify the Lexicon by adding new concepts or changing relationships between existing concepts. These Lexicons 42 are there to allow the emergence of concepts within a group. In the case of Reference Lexicons, the group associated with the Lexicon may be a broader population and therefore it does not make sense for anyone group to alter without interacting with others. Since the Group Lexicon 42 completely captures its intended group within its users, it is maintained by the group.

The above categorization does not have to be the case and serves merely as an example. A Lexicon used within a group may be in the form of a read-only Reference Lexicon. A Base Lexicon may be in the form of read-write Group Lexicon maintained over the Internet.

Each user may have their own Group Lexicon 42 in which case the Lexicon corresponds to a group of one. However, separate to the Group Lexicon 42 is an Individual Lexicon 43 that is attached to a corresponding Group Lexicon 42. This allows the user to manage concepts and relationships that do not make sense to share across a group or override existing relationships in the Group Lexicon 42 that do not make sense to the user. So even with a Group Lexicon 42 that is shared with a group, this Lexicon allows the user to create a personal view to the items 11 in the Directory.

The set of concepts and their relationships available to a user is restricted to the Lexicons 31 mounted by the user. These Lexicons 31 are also used in determining the concepts available to the Input Method, Directory Viewer 20 and the Tagging Interface 25 in determining the concepts that is shown in a result set for a context. Since items 11 of a result set may be tagged with tags 12 from many Lexicons 31 some of which are not mounted, the Lexicons 31 mounted for the user at the Lexicon Store 30 allow the Item Store 10 to determine which tags 12 to return and which not to. A user mounts only one Group Lexicon 42 at any one time and therefore one Individual Lexicon 43 at a time. This is due to the fact that merging different Lexicons 31 is a complex task. As many Reference Lexicons 40, 41 may be mounted simultaneously. This is achieved by requiring such Lexicons 40, 41 to be read-only, to have no cyclic dependency between them and restricting relationships between Lexicons 31 to a pure inheritance structure. This allows different Lexicons 31 to be merged at mount time automatically as well as in any order. While these restrictions may not be onerous in the case of a Reference Lexicon 40, 41, it is not possible with Group Lexicons 42. Therefore, the user is limited to a single group view. However, the user may choose to unmount one Group Lexicon 42 and mount another at any time. Over time, concepts from different Group Lexicons 42 may be migrated to a separate Reference Lexicon 40, 41 in an administrator mediated fashion.

By allowing users to share a Lexicon 31, concepts created by users are instantly shared across the group. If they are relevant, they are taken-up by the group in tagging items or used in context to find items. Ones that are not accepted are phased out based on actual usage within a group. This allows for a group vocabulary to emerge dynamically. This is crucial to the ability to cater to real world scenarios. No matter how complete a pre-configured Lexicon is made, it evolves with the new concepts and changes that occur in actual use. Furthermore, each workflow, each group, each context has its own unique vocabulary that is exceptionally important in order for people to collaborate. Therefore, each Lexicon 31 operates as an Emergent Vocabulary. This means that concepts are dynamically created or weeded out by the activities of the group as a whole.

Some core concepts that are widely shared start forming equilibrium and remain stable over time. These concepts and Lexicons 31 are different depending on the size and composition of the group. The base Lexicon 40 is governed by a general population and therefore is maintained by a source like a dictionary publisher. Such a source is configured as read-only for an implementation as there are considerable advantages in sharing a common set of base concepts. Similarly, domain lexicons are maintained by a third party reflecting the population of people in that domain and are unlikely to be useful if a group changes it. The group Lexicons 42 are the venue for a group of people collaborating to create concepts, relationships, etc. Like the case of individual Lexicons 43, such group Lexicons freely override the structure of the base 40 and domain Lexicons 41 to better reflect the requirements of the group.

Lexicons 31 stored in the Lexicon Store 30 have concepts that use or inherit from concepts in other Lexicons 31. It is important to have multiple and separate Lexicons 31 by groups for the emergence of concepts at the different levels, guided by different requirements. However, by integrating these different Lexicons 31 in one system, one allows the reuse and ultimately the feedback of concepts across groups.

Concepts are created in response to describing actual items in a shared context. Some of these are promoted and widely used, other die out. However, unlike the progression in natural language, the rate of information flow is much faster. Therefore, the speed to emergence is correspondingly faster.

### Item Store 10

A directory contains items 11. Items 11 may be web pages, files, documents, emails, instant messages, bulletin board postings, etc. In the case of an E-Commerce site like Amazon.com, items 11 may be books. For an auction site like EBay, items 11 are the items for auction. For a file share, items 11 are the files contained in the Directory. The Item Store 10 is the component that manages all the items in the Directory. The Item Store 10 manages any item with a unique identifier. Each Item Store 10 must have a unique identifier such as a URL. The Item Store 10 may not physically store the item 11 as long as it is locatable on the basis of its unique identifier. Web sites and web pages are handled in the Item Store 10 on the basis of their URL without having to store a local copy. This means that a bookmark manager may be implemented within the Item Store 10. Annotation may be managed within an Item Store 10. For example, a web page may be pointed to by a hyperlink in another page. As long as the hyperlink accommodates annotations with tags 12, web crawlers retrieve this annotation and add the URL to the Item Store 10. In this example, the entire Internet may be considered a form of virtual Item Store 10. In the case of PC file system or a file share, instead of having to store a copy of the file system, this mechanism functions with just a path (such as UNC paths in Windows systems) to the desired file.

The only requirement for the Item Store 10 is to have a unique identifier for the item 11, so it handles many different types 13 of items 11. Physical objects such as paper files and printers are brought into the directory as long as they are consistently tracked by a unique identifier such as a bar code or an RFID tag. The same is true for people. For example, in many countries assign unique identifier numbers to the residents of the country. Information about each such person may be managed within the mechanism of this directory. All these are considered items 11 and included in the Item Store 10. This implies that the Lexicon Store 30 may also be implemented on top of the Item Store 10, with concepts represented as items 11.

The only relationships allowed in the Item Store 10 for items 11 are the ‘is-A’ and ‘related-To’ relationships going from an item 11 to a concept. Items 11 with an ‘is-A’ relationship to a concept is said to be typed by the concept. Items 11 with a ‘related-To’ relationship to concept is said to be tagged with the concept.

Items 11 are stored separately from concepts and whether an item 11 is explicitly typed (i.e. has an explicit ‘is-A’ relationship to a concept) or not, it is implicitly typed to a reserved type called ‘Item’. Embodiments may allow items to exhibit multiple inheritance with respect to concepts. Such embodiments will allow explicit ‘is-A’ relationships to multiple concepts. When an item is tagged with a concept, it implies the concept is a characteristic of the item. If an item 11 is tagged with multiple concepts then it is considered to have all these concepts has characteristics. From this perspective, a concept or a meaning is defined as any recognizable discriminator for items 11 that is useful for a particular purpose.

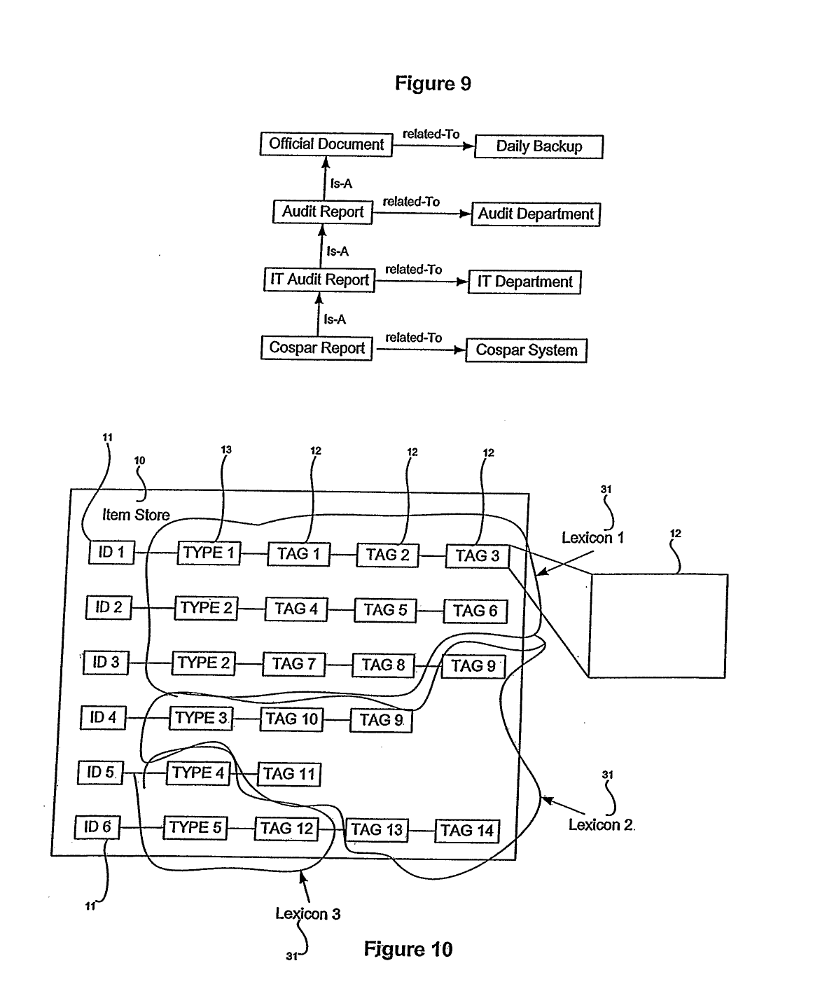

Referring to FIG. 9, document typing is illustrated. A specific document ‘COSPAR Report’ has an ‘is-A’ relationship to the concept ‘IT Audit Report’. As the document has this type 13, it becomes possible for a Lexicon 31 to associate tags 12 with the document in a controlled and automated fashion. In this example, it shows that ‘IT Audit Report’ is automatically categorized into ‘IT Department’, ‘Audit Department’ as well as ‘Daily Backup’. This allows different groups of people to readily discover this document (in this case—the IT Department, the Audit Department and the System Administrators). The actual information contained with the item 11 is nothing more than the type 13. Therefore, each user is free to interpret this according to the individual views in their Lexicons 31.

The user may assign a type 13 to the item 11 and such a type 13 may be any concept in the Lexicons 31 available to the user. Currently, it is the application that types a file. Microsoft Word creates a .doc file, etc. User typing allows the user to control their data instead of the application. This mechanism may also be as a system wide service.

An advantage of strongly typed items 11 is that it allows a system to distinguish between an item 11 that is related to a concept and an item 11 that is an instantiation of the concept. In the above example, a document ‘related-To’ ‘IT Audit Report’ may not be backed up whereas a document that is an ‘IT Audit Report’ may be backed up. An automated program requires the disambiguation provided by the type 13 of document to function properly. At the same time, human beings may be comfortable with the ambiguity of the ‘related-To’ situation by browsing items 11 and understanding the context 21. Strong typing has been used advantageously by Document Management Systems for some time. The Item Store 10 allows this to be extended to any kind of item 11. This includes resource definitions or ontologies in RDF as well as with data in Relational Databases.

Referring to FIG. 10, the Item Store 10 contains the relationships between the item 11 and the concepts associated to the item 11. Tagging a web page 11 with the concepts ‘World Cup’, ‘Soccer’, ‘History’, ‘Great Players’, ‘Important Goals’, implies that the page is about all the concepts and each concept is a useful discriminator for identifying the page from other pages. It is possible for an implementation to allow tags to be placed against text in the web page in a manner similar to hyperlinks and the tags for the item are extracted from the web page when stored in the Item Store. Any item 11 has a number of such tags 12. As tags 12 are related to each other, in conjunction with a Lexicon 31, a page may potentially be associated with many such tags 12.

An item 11 in the Item Store 10 also has tags 12 from multiple Lexicons 12. The primary idea of a Lexicon 12 is to capture the vocabulary of a group of people. Frequently, the same document is tagged by two groups of people with tags 12 from different Lexicons 31. All these 12 tags co-exist in the same item 11.

Referring to FIG. 11, items 11 in the Item Store 10 may be unstructured, semi-structured or structured. The primary form of organization for such unstructured data is through tagging. However, by supporting explicit typing through the use of the ‘is-A’ relationship, it is possible to include semi-structured as well as structured data into the Directory. This is done by associating/linking a concept to a schema definition in a suitable technology such as RDF or OWL. Semi-structured data occurs when each item 11 has a varying set of properties defined in its class definition populated. Structured data typically has a certain set of properties with minimum cardinality more than zero that is populated consistently for each item. However, in both these situations, such properties co-exist with the ‘related-To’ and ‘is-A’ relationships.

Items 11 are managed separately from concepts. This implies that items 11 are not equivalent to concepts and concepts are not equivalent to items. However, neither is a necessary condition to implement the mechanism and an embodiment may have concepts derive from items 11 (the generic concept ‘Concept’-is-A→‘Item’, in which case concepts and items 11 are not maintained separately and the Lexicon Store 30 may store its concepts in the Item Store 10).

The Item Store 10 is independent from the actual representation of the graph structure for concepts. Each tag 12 or type 13 associated with an item 11 has its semantic content specified in the tag itself. Therefore, items corresponding to a concept can be found by looking for items tagged with the tag directly. The graph structure allows the item to be discoverable from a number of different contexts. In querying the Item Store 10 for items corresponding to a context, each user's graph structure is collapsed into the context such that the Item Store 10 searches and returns items that match the context expression without having to know the original graph structure that created the expression. Similar semantics are also possible by also sending the sub-graph.

### Search Context

The context 31 passed to the Item Store 10 is a Boolean expression of predicate functions. The form of this predicate function used by the Item Store 10 for unstructured data is f(relationship, concept). This function accepts the relationship type (one of ‘is-A’ or ‘related-To’) and any concept. The function f(‘related-To’, ‘Concept A’) for an item only returns true if either the item is tagged by ‘Concept A’ or is typed by ‘Concept A’. The function f(‘is-A’, ‘Concept A’) returns true only if the item 11 is typed by ‘Concept A’. Otherwise the function results false in both cases. The context 21 is any Boolean expression of functions where the expression computing to true implies the item 11 is a part of the result set, and false if it is not.

### Directory Viewer 20

The Item Store 10 accepts a context 21 and returns the items 11 that correspond to the concept. It also returns other concepts that are tags 12 for the items II that are returned. Such concepts serve as further categories to allow the user to drill down or focus the context. Drilling down is equivalent to placing that concept in the context 21 with a logical AND. Since a result set may contain a large number or items 11 and such concepts, these items and concepts are ranked by relevance when returning the result set. Firstly, a user may not be able to view not all such concepts. Therefore, the Item Store 10 returns only those concepts that correspond to the mounted Lexicons 31 of the user. It can also take out concepts that do not serve as discriminators, i.e. where the number of items corresponding to the concept equals the total number of items in the result set. Secondly, the concepts may be ranked on the basis of a number of different parameters, including:
Number of items 11 tagged with the concept in the context 21
Number of items 11 tagged with the concept overall in the Item Store 10
Usage of the concept in the context 21 for drilling down
Usage of the concept in the overall Item Store 10
Recency of the usage of the concept overall in the Item Store 10-Recency of the usage of the concept in the context 21

Strategies may include any combination of the above as well as any others that may make sense to an implementation. In order for usage based ranking of items, it is necessary for the item to be retrieved through the Item Store 10. This is natural if the item 11 is stored in the Item Store 10 otherwise the Item Store 10 forwards the request for the item 11 to its storage location while tracking the actual usage.

The ranking strategies for items 11 may include offline as well as online components. These may include the above online strategies retrofitted for items 11 as well as offline methods like PageRank™ for web pages, bookmarks or other standard file system features like last modified time, last access time, etc.

The Item Store 10 returns a relevant subset of such items and concepts in response to a query with a context. This may be paginated so that the Directory Viewer 20 or Tagging Interface 25 accepts results a page at a time.

During a search for items 11 in the Directory, it is possible to restrict the search to a specific item type 13. This is the equivalent of placing a logical AND to a predicate function corresponding to ‘is-A’ and the concept that represents the type. Such a context 21 allows the Item Store 10 to search only items of a certain type. It is also possible to specify the type ‘Concept’. In such a case, only concepts matching the context 21 are returned. This is processed entirely within the front-end and the Lexicon Store 30, however in an embodiment where the Lexicon Store 30 is also stored in the Item Store 10, such a context 21 is processed as above. The advantage of conducting a concept search at the Item Store 10 is that the result set is ranked based on items 11 associated with the concept or the actual usage. This is possible if it were limited to only the Lexicon Store 30.

A collapsing mechanism like the context 21 is employed with any directory that has a set of standardized metadata not just those that are based on natural language. As the semantics of such metadata 12 are standardized, the associating of an item 11 with the metadata 12 and the query 21 for that item 11 on that metadata 12, even if done by two separate entities independently from each other, will still match the correct item 11. Therefore, collapsing an organization structure into an equivalent Boolean expression of predicates or a sub-graph of it, is a method for addressing the problem of maintaining two separate worldviews.

### Directory Viewer 20

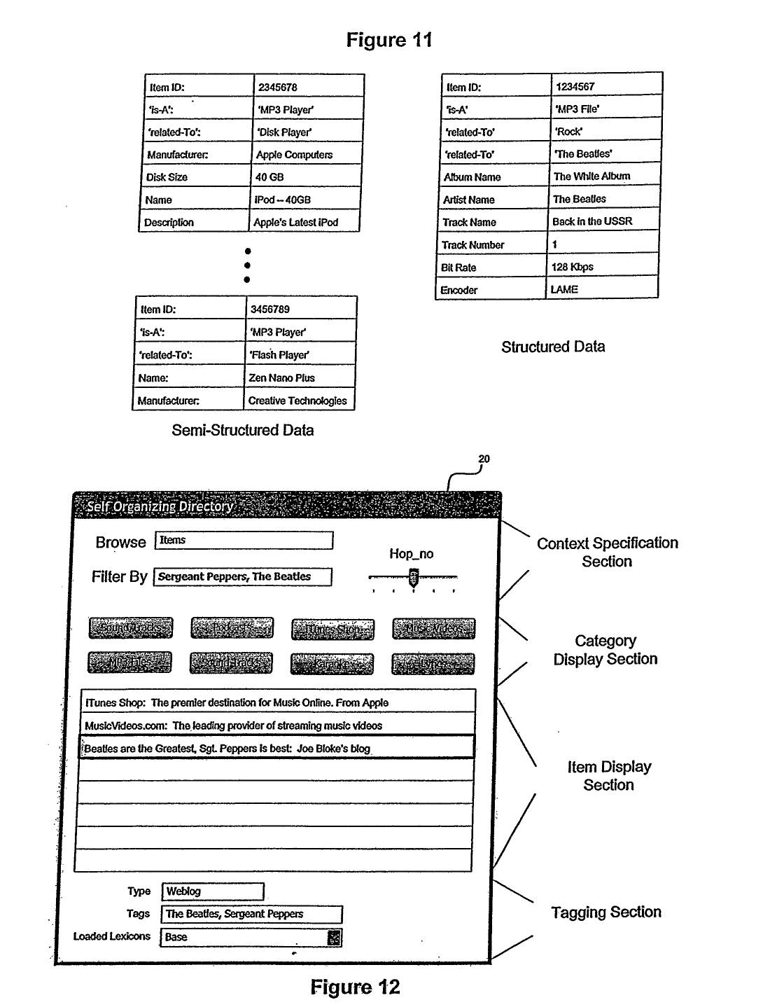

Referring to FIG. 12, the Directory Viewer 20 is a front-end application that allows the user to search for and browse items in the directory. The user interface of the Directory Viewer 20 is divided into three portions. The first is the Context Specification section where a user specifies the kind of items they are interested in browsing. The Item Display section shows the items that match the criteria specified by the Context Specification section. The Category Display section lists concepts that the matching items 11 are tagged with. These serve as drill down categories where selecting one of them includes the concept into the context and a narrower subset of the items 11 are returned.

The primary method for organization in the Directory Viewer 20 is through a context 21. The context 21 is a Boolean expression of predicate functions corresponding to relationships and concepts. However, at the user interface level, the user enters concepts that the user is interested in and the expansion of these concepts necessary to form a context 21 is done by the Directory Viewer 20. In the example above, the Filter By input box allows the user to enter concepts and has the concepts—‘Sgt Peppers’ and ‘Beatles’. Similar to web search engine query boxes, these entered concepts are linked together with a Boolean expression. In this case there is an implicit AND in the expressions where the returned items 11 are ones that have both concepts. However any Boolean expression between the concepts are used in a separate advanced search window. In the background, the Directory Viewer 20 expands each concept into a logical OR of all its related or subclass concepts and creates the full context expression.

The Browse input box in the example allows a user to specify a type 13 to restrict the search. Depending on the implementation, concepts may be included in the Item Store 10 in which case it may be possible to browse concepts rather than items 11. Also, the browse is limited to types 13 of items 11 such as ‘Official Documents’ or ‘Network Printers’ or any Boolean Expression of such concepts. Such typed browsing is complemented in a number of interesting ways. For example, while the basic Item Display format for an item 11 is along the lines of a Web Directory like Yahoo! (Description, link, etc.), with a typed item it may be possible to alter the display to better suit the type. So each type 13 has a custom-made display. Also, the input method has features that allow it to leverage schema information for a type if it has one. It further specifies the concept during entry into the browse window. For example, during entry of the concept ‘mp3 files’, the input method may allow the user to specify a value for the Artist property such that this is converted into a query in a query language such as SPARQL or SQL. Therefore, this directory is made to seamlessly integrate with other technologies for semi-structured and structured data.

The Category Display section shows a ranked subset of the concepts that the items in the Item Display section are tagged with (after removing the concepts in the context). Each concept tagged on an item 11 serves as a useful discriminator in a set of concepts. Therefore, each such concept serves as a natural category of the items. Thus, much like sub-folders in a file system or sub-categories in a directory, clicking on one of these concepts is like drilling down into a narrower set of items. However, the actual mechanism is the equivalent of adding the clicked concept to the context 21. Therefore, if the user knows what they are looking for they enter that concept directly in the Context Specification instead of drilling down through a sequence of pages. It allows both search-like as well as browse-like behavior. The concepts in the Category Display section for a context 21 are dynamically determined on the basis of actual tags in matching items 11 for that context 21. This implies that these categories 22 emerge from what the group of users using this Directory consider important rather than that specified by a set of catalogers. This also implies that there may be potentially a very large number of concepts in the Category Display Section that are associated with the context 21 with varying degrees of relevance. These concepts are ranked by the Item Store 10 according to a number of criteria including the actual usage by the group with respect to the context 21. It is also possible for the user interface of the Directory Viewer 20 to add a control that allows a user exclude items from a category. This is done by checking a combo box which is the equivalent of placing a NOT against this concept in the Filter By box. The resultant context 21 excludes such items 11 from the context 21. However, like any Boolean based expression using the NOT operator the results returned may not be what a user expects. This is because the absence of a tag 12 may not have the same meaning as NOT that tag 12. The result may include items 11 that do not have clear relevance to the NOT specification. This interface does allow a user to input an expression with logical OR (due to concept expansion at context), AND (implicit AND in the Filter By box) and NOT (by checking combo boxes). Thus it gives a user access to a somewhat full featured access to Boolean algebra in an intuitive fashion. Finally, the Directory Viewer 20 implements a “Back” or a “Forward” button that allows the user to revert back to a previous context 21 much like the Back button in a browser or move forward again.

Many things are expressible in the form of tags 12. Tags 12 in a context 21 can include specifying system behavior in an intuitive manner. A given implementation may reserve a tag called ‘Today’ where entering such a tag in the context will limit the results to items that were added or updated in the previous 24 hours. Yet another implementation may define reserved tags in an individual Lexicon like ‘Pages Visited’ or ‘Bookmarks’ where the items returned are limited to items seen/visited by the user or bookmarked by the user.

### Tagging Interface 25 & Input Method

Referring to FIG. 14, the tagging of items II is done by multiple participants in the system and in multiple ways. The most relevant form of tagging is done by people describing items 11 in terms that make sense to them. However, this is combined with automatically generated tags 12 that serve as suggestions to an individual. There are three different types of users that may tag an item 11: the author of the item 11, the user of the item 11 and possibly an administrator of the system 5. The Tagging Interface 25 uses the input mechanism to allow the tagger to apply any tag 12 from mounted Lexicons 31.

The Tagging Interface 25 is supplemented with a Directory Viewer 20 display that allows the author/user to add tags 12 based on context 21. The author/user enters a context 21 to find the item 11 in and sees how many other items 11 are already categorized into the context 21. The Category Display section in such a window provides hints to relevant categories for the items 11 (that the group overall uses and even to concepts that the user may not be familiar with). The author/user keeps narrowing the context with more tags 12 until a suitable context level is found. The mechanism tries to maintain the most restrictive definition of concept terms in the Context Specification Section. The Tagging Interface 25 tags the item 11 with the concepts in this context 21. This is done with a number of GUI metaphors including drag-and-drop of item into the Directory Window with that context. An item 11 may correspond to a number of relevant contexts 21. Therefore the author/user may repeat this process as many times is required to get an adequate set of tags 12 for the item 11.

The Tagging Interface 25 is supplemented into the Directory Viewer 20 so that users of the item 11 add tags 12 that are relevant to the item 11. This allows for the group as a whole to tag an item 11 and therefore complement the author's tags 12 with their own to address their respective point of view. This creates a mechanism where relevant tags 12 missed by the author are added and also other perspectives that the author has not catered to.

Tags 12 that are available to one user may not be available to another with multiple Lexicons 31 depending on the group. Tags 12 that are limited to the Lexicon 31 of one group allows that group to find the Item 11 by that tag 12 in a more specific manner without being cluttered by items 11 that may share the other tags 12 but not the specific one. There, the group's view is more focused and pertinent to that group. The item 11 occurs in a more general set of items 11 for users in other groups who find it necessary to tag it further in tags 12 of their own Lexicon 31 to increase discoverability within the group. This is a continuous process where if a particular context 21 gets flooded with items 11, users find it necessary to keep categorizing so that important items 11 are easily located. This allows for self-organizing and self-correcting behavior for tagging items.

It is during tagging that users may want to create new concepts, as their current Lexicons 31 may not have the required expressiveness. The Tagging Interface 25 allows the user to mount/unmount Lexicons 31 as required to find a relevant concept. The input method allows the creation of new concepts in a Lexicon 31 if such a concept does not exist. This allows the emergent growth of the Lexicon 31. Such new concepts are immediately available to all users of the Lexicon 31. If it is a relevant concept, it is taken-up by the group and used for tagging, querying or browsing in the Directory. If the concept does not get take up, others will not use it. There is the case where the new concept is associated with a keyword that is used often by the group to input another concept. Therefore, if a new concept is not useful, then the keyword to it spams the input method for others. Like ranking of items 11 and concepts with a context 21, keywords in the Input Method may be ranked against concepts. Typically, there is limited space on the Input Method window to show concepts against an entered keyword, the ranking effectively makes an unused concept disappear from the vocabulary. This ranking is done in a group basis as well as individual. A keyword may correspond to a number of concepts in a number of different Lexicons. Each lexicon gives a hint for the rank of the concept. The actual usage by a user gives a hint for the rank as well The Input Method may accumulate all this hints to compute the final rank (e.g. weighted average). Therefore, given a keyword a user continues to get a concept that may be fairly esoteric with regards to the rest of the group but is important to the user. The rest of the group do not see it unless they use it. Again emergence does not compromise individual expression but through individual expression new and relevant concepts emerge. Correspondingly, given a concept, it is displayed to the user by the highest ranked keyword for the concept for the user.

There are a number of mechanisms that are aimed at empowering emergence of commonly used concepts within the Lexicon. Semantic tags are based on natural language words or phrases. This allows the mechanism to leverage emergence that is continually taking place in language.

When tagging an item 11, the Directory Viewer 20 and Tagging Interface 25 windows helps the user to choose tags 12 that are most relevant to items 11 that they are tagging. They give the user an instant feedback on the use of concepts by the group overall. This is because as the user enters tags 12 for an item 11, the Category Display window shows the concepts that the group is to associate with the context 21 represented by the tags 12 entered so far (almost like “people who thought this also thought that” or ″, “People who found this context interesting, also found the following categories interesting”). This gives the user hints on what is the best way to characterize the item 11. It also gives the opportunity to the user to discover relevant concepts that the user may not have considered or knew about. The number of items 11 matching the context 21 also lets the tagger know whether they have to keep tagging or there is sufficient specification. The Directory Viewer 20 plays the same role for the user and the author. The user is able to see a list of items 11 for a context 21 and click any one to see the tags 12 attached to it. This allows the user to learn how other people are tagging something. It also gives the user the opportunity to tag it in a fashion that best reflects their point of view. If there are too many items 11 at a level of context 21, users sub-categorize them further with tags 12. This allows for a natural progression from ambiguity to precision.

These mechanisms allow people to converge on tag usage by defining a shared context through the item 11 being tagged. Since the item 11 is visible to all who are tagging it, it allows users to observe and comprehend the meaning of tags 12 used by the group. New concepts are created during tagging. This is because if an existing concept serves the purpose at hand, it is used. However, a new concept is required to adequately differentiate an item 11 from the others within a context 21. This allows for new concepts to be created.

Concept creation is at the Lexicon level and therefore is available to the group immediately. This allows for timely and topical tags 12 to be adopted by the group. In order to lessen the impact of spurious concepts or spamming, the concepts in the input method are ordered with respect to use in both tagging as well as browsing. Thus a tag 12 that is not useful is crowded out of the input method window by more used tags 12 that are used more. Both the immediacy of the concept availability as well as ranking of concepts promotes convergence within the group on useful tags 12. Furthermore, since concepts themselves can be searched and browsed in the Directory as well as items 11, less often used or highly specialized concepts are found when desired.

The concept of Lexicon 31 allows groups to share a set of concepts without conflicting with other groups. This represents the right level of granularity as each group level operates with different tradeoffs. The Base Lexicon 40 does not introduce a concept until there is broad acceptance of the concept by the general population. But a concept with only a local meaning is not introduced into a general Lexicon such as the Base 40 or the Domain Lexicons 41. To use a Lexicon 31, the user must be familiar with the concept itself. The user intuitively navigates different Lexicons 31 easily. Over time such usage causes the migration of concepts from one Lexicon 31 to another.

The Directory is self-organizing and scalable. The structure within the Directory emerges from group usage and the categorization takes place dynamically and with full richness of a general network. This categorization (at any level of context) is based on actual tags 12 of items 11 and therefore reflects real and relevant groupings as opposed to arbitrary and brittle categories found today. Since this categorization is dynamic, the directory effectively organizes itself and therefore scales to the size and complexity of the Internet. Thus, this may be used efficiently integrated with other automated mechanisms like a web search engine. As an example, a web search results is automatically categorized based on the tags 12 of the items 11 and a user drills down based on such categories 22. This extends to any item 11 that is described by a unique identifier. Therefore is it possible to include physical files. Workflow is integrated by the directory. This allows for greater collaboration in the work environment. Context sensitive communication and collaboration is created. Messaging like email, IM, forums, are considered items 11 in the Directory and are delivered on the basis of context 21. This allows workgroups to emerge dynamically based on needs in the organization quickly and efficiently. Since all items 11 are managed uniformly at the Directory, this increases the number of touch points between members of a group and therefore increases the information flow between them. This encourages emergence of core concepts and their relationships.

Although a Directory that is shared within a group or a Community has been described, it may accommodate a group that scales to the size of the Internet. In practice there is likely to be a number of such Directories, each such Directory may cater to a specific group. There is a need to merge the organizations of these different Directories.

Also, the directory as described above requires that users tag each file 11 in order to use the Directory effectively. Yet, the user does not create the majority of files that are in the user's computer. Most of them are acquired from other sources such as the Internet, Intranet or file shares. Many files are from Controlled Vocabularies. The majority of existing files from such sources may be converted into an accepted format of the directory. If such files were already tagged with semantic metadata 12 such as the Directory described above they may be incorporated into the Item Store 10. However, as they have been tagged by different groups, they come from different Lexicons 31. Such Lexicons 31 are downloaded to the Lexicon Store 30 also. There is a need to merge such organizations.

Each group creates their own lexicon. Since each Lexicon 31 and concept is assigned a globally unique identifier, namespace clashes are avoidable at the concept level. However, the same may not be true with regards to the relationships used between the concepts. Generally, it may not be possible to download a Lexicon 31 and mount it for a user. There is a further problem associated with the keywords used for concepts within the Lexicon. Keywords may clash with existing keywords of other concepts already present in the users mounted Lexicons and create confusion. In general, such keyword clashes are of three types: same concept, same keyword; different concept, same keyword; same concept, different keywords. This clutters the Directory Viewer 20 and makes the interface counter-intuitive.

### Taq-Mounted Lexicon

To solve the Lexicon merge problem, this mechanism uses the idea of a Lexicon 31 that is loaded only when a tag 12 representing the Lexicon 31 comes into the context of the Directory Viewer 20 or the Tagging Interface 25. This tag 12 is separate from any concept within such a Lexicon 31 used for tagging. When items 11 with tags 12 from the Lexicon 31 are included in the Directory Viewer 20, the only tag 12 that appears in the Category Display section is the Lexicon tag 12. It serves as a proxy for all other tags 12 from the Lexicon 31. Every item 11 from that source may optionally be tagged with this tag 12 where such a tag 12 serves as a proxy for the source itself. This tag 12 also is added to the input method so that it may be entered directly into the Context Specification section. If the user clicks on this tag 12 or enters it such that this enters the context 21, then the current set of Lexicons 31 available is temporarily unmounted and the Lexicons 31 represented by the tag 12 are mounted allowing the user to take advantage of all the mark-up available for the items 11. Since only items 11 from that source have this tag 12, once the tag 12 is in the context 21, the matching items 11 are from that source limiting the problem of clashes. If the concepts in the Lexicon 31 have self-evident descriptions then the user has a seamless browse experience.

The large number of items 11 that are already in Controlled Vocabularies (and hierarchies in general) can be incorporated into the mechanism in a distributed fashion by constructing them as Tag-Mounted Lexicons. This method allows the user to users leverage existing organization. Each user is not required to manually tag each file. Organization of items 11 spreads virally each time a file is downloaded. This is efficient as most producers of content have a vested interest in categorizing it so that they may be easily found. Secondly, a useful item 11 is read many more times more than it is written.

Group Lexicons that are read-write Lexicons can be mounted only one at a time. However, using the mechanism of Tag-Mounted Lexicons, the user can have different Group Lexicons appear as Tag-Mounted Lexicons according to their tags and allow them to be mounted in a similar fashion. Thus the user can view other and potentially useful Group Lexicons and work with them in a seamless fashion.

Tag-Mounted Lexicons 31 allows some augmented functionality that is useful. In order to aid branding, tags of such a Lexicon 31 can be cryptographically signed by the source to ensure the tagging was done at the source. The tag 12 of the Lexicon 31 can contain hints to the Directory determining whether a user of the Lexicon 31 may use concepts from it in their own tagging or not. This further involves authentication and authorization of a user against the Lexicon. The tag 12 itself can contain an optional image file that is used instead of text to render the tag 12 on the Directory Viewer 20, Tagging Interface 25 and the input method, thereby allowing a Logo to be used.

### Federated Directory

In another embodiment, such Tag-Mounted Lexicons 31 may be extended to encompass Federated Directories as well. This allows for items 11 within another Directory to be returned against a context for a Directory Viewer 20 or a Tagging Interface 25, along with the items 11 stored in the incumbent Directory. A federation is desirable in a number of situations where the federated directory comes from a trusted source. In an Intranet scenario, such a directory is based in another part of the organization or in a different country. In the Internet scenario, it may connect directly to the source of a file rather than downloading it. It is also possible for the Directory Viewer 20 or the Tagging Interface 25 to directly connect to such a Directory in a manner akin to web-browsers access a web page directly by entering the URL. However, federation operates similar to a cache server for such items 11 while merging them with other Directory items 11.

The federated directory replies with items 11 corresponding to a context 21. When a user enters a context in the Directory Viewer 20 or the Tagging Interface 25, the Item Store 10 may forward such a context 21 to a federated Item Store 10. The concepts in the context may be the basis for the federation. A Federated Item Store 10 can register itself as a specialized directory for certain concepts so any context including such concepts should be forwarded to it. This may be done in a chained manner similar to what is found in the DNS scheme on the Internet. This allows for the creation of a self-organizing and emergent network topology for directories based on content without requiring a central authority. This shares many of the advantages of the DNS scheme but extends it to not just partition the name space on commercial, educational, country, etc. basis but could encompass the richness of language in the naming space.

In such a distributed arrangement, it is quite likely that the overlap between the Lexicons used by the user and the final directory may be small. The context 21 may have concepts that do not exist in the targeted directory, and the directory may put false against such concepts and recompute the context 21. If the context 21 becomes false, it returns a null set. It then matches items 11 within itself against the simplified context 21 and return matching items 11 or null if there are none.

There needs to be common Lexicons 31 shared between directories for this to be useful but the Base Lexicon 40 and the Domain Lexicons 41 are likely to be shared. The concepts returned against the items 11 may come from a Lexicon 31 not available at the original Directory. Such Lexicons 31 may be added by the Directory at the time of attaching to the federated directory or later. Once the Lexicon 31 is in the Lexicon Store 30, the items 11 from the federated directory behave similar to the Tag-Mounted Lexicon case. Thus, if a person drills into the tag 12 of the federated directory, they get a complete view of the concepts. At this point, the front end communicates directly with the federated directory if desired. This is called a Tag-Mounted Directory.

In the case of federated directories it becomes more difficult in general to implement a ranking mechanism for items 11 or concepts corresponding to a context. There are a number of solutions to this such as accepting ranking hints from the federated directory or by ranking items 11 tagged with more commonly used tags 12 higher than other ones. In the case that the federation is not purely based on trusted sources as would be the case if the directories were from the Internet, it is possible to rank such sources on the basis of actual user usage of query results from the directory or user based ranking. Such ranking is done at the Directory to which the directory is federated, thereby allowing for management of quality to be done at the point that can evaluate it the best and/or possibly has the most vested interest to prevent bad directories.

Since the primary interaction is between Item Store 10 to Item Store 10, all results are cached across all users of the Directory and therefore the receiving Directory may serve as a caching server for its users. This REST-like behavior may be quite efficient and many such Directories may be daisy chained to offer the final functionality.

### Semi-Structured and Structured Data Items

A lot of data in the world today exists in a structured form in Databases or Application Systems. The Directory method enables seamless interoperation with data that may be in structure or semi-structured form. This allows the Directory Viewer 20 to be a generic viewer across disparate systems or databases. This takes the general form of system integration.

The Directory shares a number of similarities with Relational Databases and may be integrated with them at a deep level. The notion of a concept in this mechanism and the notion of an entity in RDBs are very similar. The relationships of this mechanism have counterparts in the Entity Relationship model of RDBs. The notion of searching for items based on a Boolean expression of context has a parallel with a query language such as SQL. The Directory gives the user the ability to specify concepts directly to the system that is used to query an RDB at the entity level, thereby allowing the user to browse data model of the database in an intuitive fashion.

The Directory can leverage Entity Relationship diagrams discovered by P. Chen, to define concepts and relationships. Although many databases are modeled with ER diagrams, even if there isn't an ER diagram, such a diagram can always be created for a relational database, both semi-automatically as well as manually. Starting with such an ER diagram, identifying concepts becomes relatively straightforward. All independent and dependent entities that the user may refer to directly in the Directory Viewer 20 can be represented as concepts. The primary keys for these entities may be mapped to the identifiers for the concepts and they may be further described by a Description and keywords. The entity sets would also be concepts. Entities in an entity set may be connected to the entity set with an ‘is-A’ relationship. A generalization hierarchy of entity sets may be modeled with the ‘is-A’ relationship in a similar fashion. Entity instances in RDBs may show multiple inheritance. Therefore, concepts that correspond to entity instances exhibit multiple inheritance. The embodiment used to connect to RDBs allows the graph of the ‘is-A’ relationship to be a set of Directed Acyclic Graphs.

All relationships of the ER diagram should be one-to-one or one-to-many binary relationships (although ER diagrams allows many-to-many, recursive, n-ary as well as cardinality constraints, these are not supported by the relational model). It is assumed that all relationships that cannot be represented directly in the relational model are done through an associative entity. Each such entity can correspond to a concept. Multiple relationships between any two entity sets are considered to be named relationships. Each entity in a relational model typically has a set of attributes that take values.

The mechanism described thus far has been directed at unstructured data. To extend this to semi-structured and structured data, the RDF notion of triples are used to describe named relationships as well as attributes. Both concepts and items 11 may take attribute values as well as named relationships that take concepts as their objects. This is further described with an OWL Full schema that serves as a super set of the expressive capability of an RDB schema and allows any RDB to be represented in this form.

The principle motivation for defining the above mapping is that given a concept in the context 21, it should be possible to retrieve the relevant rows from the database and present them as items along with their corresponding attribute values. This may be done in a standard tabular form where the user may select a sub-set of the rows by using a GUI method. Such selection may be used to in conjunction with the context 21 to perform the function of a “select” clause in SQL. The ‘is-A’ hierarchy may be represented in the drill-down categories that allow the user to narrow the context 21 to the desired level. It is also possible to expand the notion of the predicate in the context 21 to include attributes. This can be done in the general form of F(concept.attribute, operator, value), where the operator can be any standard operator like equal-to, less-than, greater-than, not-equal-to, contains (for text matching), etc. This may be implemented in the GUI of the Input Method such that the user may specify such a predicate expression, while entering the concept in the context 21.

However, in general, it is not trivial to extend the Boolean expressions in the context 21 and drill-down behavior to the relational model. This is due to the fact that both of these situations require a join between tables. As an example, let us assume that a database consists of two entity sets called “Employee” and “Salary History”, such that there is a one-to-many relationship between them. That is, every employee has multiple rows in the Salary History table corresponding to their salary history. The context (Employee AND Salary History) would correspond to a join between those two using the Employee table's primary key. In many simple situations, this would be adequate. Tables that are connected with an identifying relationship only may be joined on that basis. Even in situations of non-identifying relationship, it may make sense to do so. Joins through named relationships may be modeled by populating the attribute corresponding to the named relationship in the context, thereby allowing the join to take place on that relationship. But for complex models, the join behavior becomes dependent on the nature of the data in the database. As a person skilled in the art will note that there are potentially many joins possible between any two tables as a given table may have many candidate keys. Furthermore, given any two tables, there may be multiple relationship paths between them or there may be none. Also, the nature and definition of the concepts allows for a more fluid definition than is necessarily available at the table level of the database. In the above example, it may make sense to define a concept such as ‘Manager Salary History’ or ‘Highly Paid Employee Salary History’ that may reflect joins on specific attribute values of the Employee Table. Also, in real world systems, tables may be intentionally de-normalized to gain better query performance. The primary keys of tables may be done through synthetic keys. This requires the task of join specification to be manual.

The preferred embodiment to interface to a RDB is through stored procedure calls. Even the basic queries modeled above is easily represented through stored procedures. This method can be extended to any arbitrary information requirement supported by the RDB data model. The stored procedures can be modeled as concepts in the mechanism. Entities and entity sets are still modeled as concepts as above and used to specify parameters to the stored procedure.

A generic service is created to integrate into the database that accepts such stored procedure calls. A tag describes the service and accessing the service is equivalent to a Tag-Mounted Item Store 10 with a Tag-Mounted Lexicon. If the user enters the db integration service tag into the context, they may have the corresponding Lexicon of concepts for the service mounted and available at the Directory Viewer 20. Such a Lexicon of concepts provides schema definitions to all such concepts as well.

Since concepts are underspecified by design, it is possible to use the same concept ‘Employee’ in multiple contexts with different schemas describing it. Such schemas are loaded seamlessly in the background in a fashion similar to Tag-Mounted Lexicons. One of the major problems in system integration in general is that there is no standard definition of a given concept. The concept employee may have different definitions in different databases, but as noted before, they all try and model a real-world entity. A human user may be quite comfortable with different systems modeling the concept of employee in different ways as long as they understand that it is within the context of that system. Therefore, the user may seamlessly use the same underspecified concept in different contexts, each with their own definition. The same thing is difficult to achieve with an application program.

Once the service tag is in the context, the stored procedure tag is specified. This may be done through a number of different ways. The user may be presented with the set of stored procedures as drill-downs tags in the Category Display Section. An embodiment may also exhibit a behavior where the first query of the user is for searching stored procedure tags. This query may be specified with normal concepts and the stored procedure tags that correspond to this are matched in the Item Display section or Category Display section. The user either selects the desired stored procedure tag or enters the desired tag directly into the context.

A stored procedure can take a number of parameters and deliver corresponding results. Simple stored procedures may take reasonable default values for parameters and return a set of items even without explicitly specified parameters. In the employee example above, there can be a stored procedure that returns information on employees. This presents results even without parameters. It optionally accepts a parameter that specifies either a subclass of employees like managers or a specific employee. If the parameter is specified, the procedure will return information regarding managers or that employee respectively. The parameter may be entered directly by the user using the input method or they may be presented as drill-down categories. If a particular query is heavily used, for example manager information, then a specialized stored procedure may be introduced and associated with a new concept that returns manager information. This may be related to the broader query through an ‘is-A’ and related to the concept manager with a ‘related-To’. This has two desirable effects—the subclass stored procedure will available in the Category Display section of the superclass stored procedure so that users not familiar with it may discover it. Also, for users searching for stored procedures related to managers, they might find this procedure. Therefore, stored procedures may be given the same semantics as other unstructured data in the mechanism.

The stored procedure drill-down semantics may be made compatible with other data as well. For example, a subclass stored procedure drill-down will always replace the superclass stored procedure in the context. If a stored procedure is ‘related-To’ another that is in the context, drilling down will replace the other. Each of the parameters of the stored procedure is considered unrelated/independent so they are added with a logical AND to the context. The stored procedure itself is a concept; it may be modeled with a schema that specifies the parameters as its named attributes and their corresponding cardinality. This may be translated at the front-end to a form-based representation or the potential/commonly used parameter values may be specified as drill-down categories. If a stored procedure requires a minimum set of parameters to return a result, such parameter concepts are offered as drill-down parameters with a visual cue such that the user may select them one by one. An experienced user can at any time, enter all the parameters required/optional into the context and get a response immediately. Each such parameter concept may be associated with a schema so that the user may enter attributes of the concept as well through the Input Method.

The context is modeled as a Boolean expression of predicates. In the case of stored procedures where the parameters may be disambiguated in the basis of type, then context representation of the stored procedure may be modeled as a set of F(concept, operator, value) or F(concept.attribute, operator, value) predicates, each joined a Boolean AND. In the case where the stored procedure requires a number of parameters of the same type, then it is possible to modify the predicates used to F(procedure.parameter, concept.attribute, operator, value) and apply the same behavior. Any stored procedure Application Programming Interface (API) call can be modeled as a Boolean expression of such predicates.

The result set of a stored procedure will be a table of values that may be displayed through the same process as described before. The specific view of such data may be customized per stored procedure or per context.

Using stored procedures as the interface to the Directory Viewer 20 offers many advantages over interacting with the table directly. It is a cleaner solution that can apply to any database without imposing difficult requirements. It may be made as efficient as required by pre-processing the procedures, implementing query optimizers, caching results, implementing three-tier processing architectures, etc. It can leverage stored procedures that may already be present in such a database. The concepts of the stored procedures and parameters are still based on the database's entity model and therefore provide a clean fit to the database. It allows unstructured data to exist cleanly with structured data. This enables aligning metadata of unstructured items with entities modeled in enterprise databases so that a uniform and more complete view of an enterprise's data assets is made available through the Directory Viewer 20. By creating Group Lexicons based on entities defined in such enterprise databases it is possible to leverage significant investment that the enterprise has already made to process modeling and knowledge organization such that unstructured data like files and email are more readily accessible to a larger group with little training and without significant disruption or change.

The method of the above example is not limited to just databases within an enterprise. The same basic methodology used in the case of stored procedures, may be readily extended to all forms of RPC-like system architectures including Service-Oriented Architectures, Web Services, J2EE, CORBA, COM/DCOM, Net Remoting, Unix RPC and all REST-based architectures. This list is not exhaustive and should be considered to include any function call. Furthermore, any enterprise modeling technology may be used in connection with definition of entities, not just ER models of databases. Process modeling done through UML allows the Class diagrams or Object Model to be leveraged. This enables the Directory Viewer 20 to be a viewer for data in application systems. This implies that structured data, not just in its raw form, but also in its processed or value-added form is brought into the Directory Viewer 20 in a seamless fashion. Object-oriented programming class models may be exposed through concepts. Environments like C# in Microsoft's .Net allows the programmer to specify attributes against assemblies, modules, types, members, return values and parameters. This may be leveraged to specify semantic metadata that may allow the user to interact with it directly. As an example, a user may specify (‘Control Panel’ AND ‘Network Settings’) which may result in that specific section of the Control Panel application to be discovered and/or launched.

As a person skilled in the art will note that any API may be modeled in the form of semantic metadata with their corresponding attributes/parameters assembled together in a Boolean expression. A “verb” may be modeled as an action request to a suitable agent. The agent may be an item in the Directory. The directory is the agent of first choice to find an agent or service. Agents, or service providers, are identified using semantic metadata and may be suitably described with other tags to allow a user to search for it like any other item. The directory serves as a dispatching agent of the context to the service based on its tag. The action request is in the form of a Boolean expression of context.

By modeling “verbs” as items of the directory in the manner above, it is also possible to model a process as an ordered sequence of such queries. Decision paths or control flow in processes are the equivalent of drill-downs at each stage of the process. Workflows are implemented in a controlled manner through drill-down behavior.

Through the use of a context using Boolean AND operators, it is possible to restrict the scope of the query to arbitrarily narrow contexts such as a single application module or a database stored procedure. The underspecified semantic metadata may be supplemented with the schema information for such a service. This allows the target API to be the naming authority of any parameters or entities with no loss of generality in API invocation. However, it is also possible for the API to leverage semantic metadata in commonly used Lexicons within the properties and attributes defined by the schema. This allows the service to be discovered and invoked on the basis of commonly used concepts and a result set retrieved.

This is a significant departure from the state of art that allows new and useful behaviors that are currently not possible. A summary of architectural styles is found in Roy Thomas Fielding's dissertation, “Architectural Styles and the Design of Network-based Software Architectures”. In this he also describes the notion of Representation State Transfer (REST) as it is used on the World Wide Web is discussed. He notes that the REST-like architecture was a significant reason for the rapid and wide spread adoption of the web. Previous RPC architectures as well as newer ones like Web Services and Service-Oriented Architectures have proprietary protocols and significant semantic handshakes that make many pieces of the system inter-dependent. This dependency makes the entire system brittle and localized. Therefore, one typically needs to create custom front-end applications for each service. The web leveraged three basic technologies to make it ubiquitous. These three pieces were URLs, http and html. URLs allowed resources to be located anywhere on the network; http was a simple transfer protocol that could allow transfer of data in a standard fashion and html allowed the creation of a generic browser interface. A user armed with a browser could go to any URL and access what it had to offer. He notes that the notion of URLs was quickly modified to URIs as what was being represented was not just a location but the resource itself. The actual representation of a resource could be done in any fashion that the service provider chooses (e.g. static web page, dynamic page from a servlet or an active server page). The user would still get the same service. He highlights that the URI is not just a location but also the semantic equivalent of the service itself.

The Directory leverages the same separation between representation and resource as REST architectures. The stored procedures in the example above are based on the same principle. Yet there are many deficiencies of existing REST-like approaches. Such deficiencies are overcome and the notion of URIs is extended with semantic metadata.

The primary deficiency of current approach is that the semantics of the service URI is private to the service provider. Web pages and forms allow the user to interact only in a way that service can control it. This is essentially true of any API. Even published API that specifies a public contract like WSDL in Web Services or the Win32 or WinFX API, an application that calls such an API must conform to the semantics assumed by the service provider. However, if semantic metadata as defined is used, then the semantics of both the service as well as the parameters of the service are shared. The second and major change is the notion of a context based on a Boolean expression serving as the API for a service to any client. By designing applications to handle user requests in this form as opposed to an API-defined handshake, the API may be discovered and invoked in many different and unplanned ways. A declarative interface is commonly used in SQL for RDBs, but is not currently possible for applications. It is possible to attach to any API, and to convert an API to one that works purely on a Boolean expression of shared concepts. This fundamentally changes the way application functionality may be accessed, either by user or by program.

In an example scenario, the service request is specified with semantic metadata not merely at the entity level but also at the attribute level for such an entity. Instead of describing a request according a specific schema or schemata, the user may construct their own representation of required attributes as per their requirements. This is then searched in the directory for matching services. If a service provider can handle the request at the entity level of the specified context, the context is passed to the service API for determination of whether it can handle it or not. The service provider can go through the separate pieces of the request and if it understands enough of the entities and attributes of the request to return a result set, it may indicate to the system (or the Item Store 10) that it can service the request. This allows serendipitous matching of service providers with fine granularity. The requestor may specify a request without necessarily knowing whether the service provider can process it. The coupling is done dynamically without a premeditated protocol as is commonly required today. By having the interface defined on the basis of a Boolean expression of commonly shared semantic metadata, APIs are no longer proprietary to the service provider. This makes services full-fledged citizens of the Directory along with other objects like files. They may be discovered and used like any other item in the Directory.

Having publicly shared semantic metadata at the core of entity and attribute definition of a service allows new modes of service provision. Currently, the basic mode is one service provider and many users. However, if the entities/attributes of the service are comprised of semantic metadata that are shared, then three other modes are possible—one user to many service providers, many service providers to many service providers and many users to many users. An example of one user to many service providers is the discovery of multiple service providers based on a need expressed in the context and getting responses from all of them. The Federated Directory is a basic example of that. An example of many users to many users may be multiple users' photos of a person at a party shared such that each person's photos may be collected together from everyone's collections. Another example may be a user creating a spreadsheet with the table name and column names based on semantic metadata, exposing it some fashion such that it may be searchable by other users or systems across a network without explicitly having to make the connections. An example of many service providers to many service providers may be system integration or user-mediated service-to-service invocation. In the user-mediated case, a user may get a list of managers from a personnel database and dynamically get their phone numbers and desk locations from an administration department web service application. Many of these use cases potentially have compelling uses in the enterprise scenario where accessing information, functionality and knowledge is always a challenge and there needs new technology approaches to these challenges. Allowing and possibly making application developers leverage shared semantics makes the task of system integration planted firmly into the early stages of the design cycle for systems thereby allowing for powerful new integration possibilities downstream in the development cycle. By having the core integration based on semantic metadata that emerges from the activities of the group, the semantics will correspond to the requirements of the group instead of an artificial standard. System developers will have access to and indeed participate in the creation of such semantic metadata. By having the entities of the enterprise systems modeled on commonly understood concepts, the feedback loop is further extended to application systems. By having the API based on context, the developer may be able to track queries across the directory, whether or not their service satisfied them, and allow them to emerge per requirements as well.

Semantic metadata can be used in database tables. Typically, each table's attributes are specified with semantics private to the database. This does not have to be the case. In practice there are many columns that stand for common purposes like specifying the name of an entity or a description of the entity or the zip code of the entity. If these columns are described with semantic metadata that are commonly shared, then it is possible to connect data from diverse tables in diverse databases on the fly. In the case that such a common concept is further described through a common schema such that the value-set is also commonly understood, it becomes possible to dynamically join to connect two tables that may have been created by parties independently of each other. This notion may be extended further to service APIs based on such data such as stored procedures and any application that offers a service API built on top of such database data that provides value-added services for the data.

Another important class of EAI technologies commonly used in System Integration is the Messaging Bus architecture. They typically rely on subject based addressing and self-describing data sent out on a publish/subscribe based paradigm. Semantic metadata is a natural complement to such architectures. The contents of the messages are modeled on the entities of the system. These typically take the form of attribute/value pairs. This may be modeled with semantic metadata just like the other architectures noted above. Subject-based addressing is the equivalent of a Boolean expression of semantic tags. The subscribe behavior is merely the equivalent of a persisted query. Any current messaging bus data model and behavior may be modeled within the directory mechanism with the above modification. However, by using semantic metadata, it becomes possible for the user to query such buses directly integrate information from different programs.

This description does not specifically address the design and implementation of a viewer interface for semi-structured and structured items. It notes that there are number of possibilities. For unstructured data, a simple list of titles of items, and where relevant—hyperlinks, may be adequate (essentially equivalent to a current search engine results page). For structured data like database rowsets, a generic table format may be sufficient. For more complex interfaces, it is possible to leverage technologies like XSLT, XHTML and others to create more sophisticated views on the fly that are customized for a particular service. Each type or context may have its own custom view. New technologies like XAML of Windows Longhorn may also allow the creation of rich interfaces on the fly. Other standard technologies like html, XHTML, CSS, Mozilla XUI, Macromedia Flash, JavaScript, Java Applets, ActiveX and others may be used. There are other applications within which such browsing behavior may be embedded. As an example, the user can take an Excel worksheet and specify attributes that they are interested in with semantic metadata in columns (that serves as the equivalent of a select clause) and then specifies a context such that service providers that return such attributes may be matched and allow the user to retrieve items from such a provider directly into the spreadsheet. By using function calls as an interface to getting results in the case of structured data, it is possible to implement both facet-oriented browsing and path-oriented browsing. Each parameter may correspond to facets and the schema for the call may define the attributes and their value types. Similarly, each parameter may correspond pieces of a path being followed and they may be represented by breadcrumbs. All the technologies and methods for display of items are currently available or used in the state of art. The primary interface that this mechanism specifies is the ability to specify a context and have a Category Display section that allows the user to drill-down. This may be easily implemented by any of the above technologies.

The technologies defined for the Semantic Web may be advantageously used to implement the Directory. Semantic metadata 12 may be represented in RDF or OWL. Query interfaces may be implemented within the SPARQL standard. Unlike the Semantic Web where metadata is mainly used to make unstructured data machine-readable, semantic metadata is also used to provide user interfaces with applications and data at the semantic level. The definition of semantic metadata 12 is based on natural language in an underspecified manner. By leveraging emergence, a set of shared semantic metadata 12 is created that may be used to overcome the entry barrier to Semantic Web adoption—lack of standardized metadata. Another difference is that a major thrust in the Semantic Web community is to cater to semi-structured data through technologies like SPARQL. Another important category of use is added, where the user submits a “semi-structured” query against structured data sources. Therefore this Directory is symbiotic with Semantic Web technologies and represents a novel and practical use of it.

### EXAMPLE

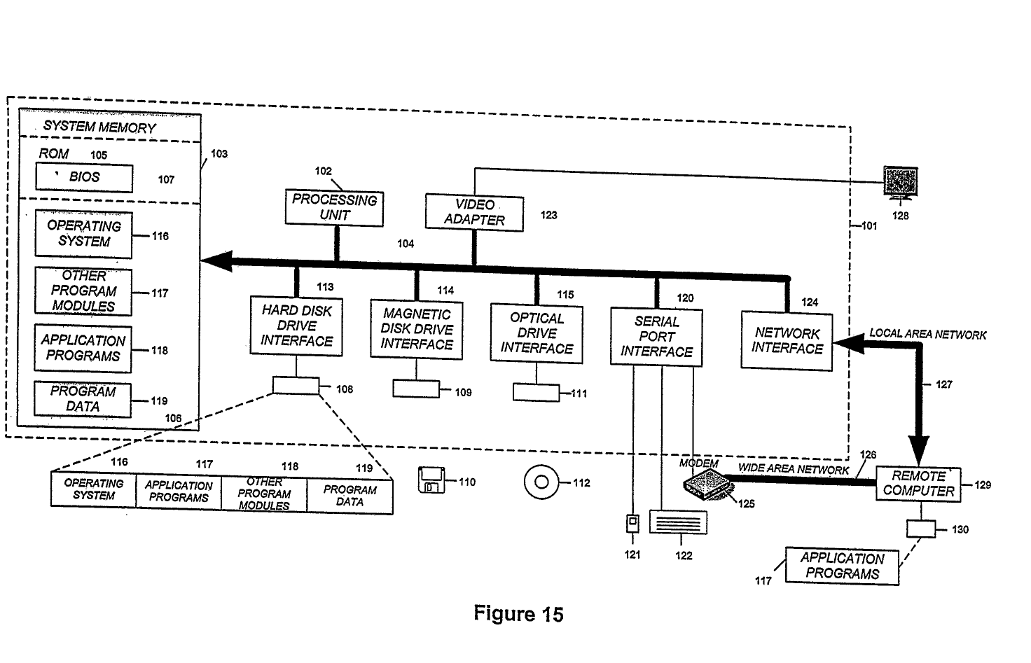

Referring to FIG. 15, there is provided a general-purpose computing device in the form of a conventional personal computer 101, which includes processing unit 102, system memory 103, and system bus 104 that couples the system memory and other system components to processing unit 102. System bus 104 may be any of several types, including a memory bus or memory controller, a peripheral bus, and a local bus, and may use any of a variety of bus structures. System memory 103 includes read-only memory (ROM) 105 and random-access memory (RAM) 106. A basic input/output system (BIOS) 107, stored in ROM 105, contains the basic routines that transfer information between components of a personal computer 101. BIOS 105 also contains start-up routines for the system 5. Personal computer 101 further includes hard disk drive 108 for reading from and writing to a hard disk (not shown), magnetic disk drive 109 for reading from and writing to a removable magnetic disk 1010, and optical disk drive 111 for reading from and writing to a removable optical disk 1012 such as a CD-ROM or other optical medium. Hard disk drive 108, magnetic disk drive 109, and optical disk drive 111 are connected to system bus 104 by a hard-disk drive interface 113, a magnetic-disk drive interface 114, and an optical-drive interface 115, respectively. The drives and their associated computer-readable media provide nonvolatile storage of computer-readable instructions, data structures, program modules and other data for personal computer 101. Other types of computer-readable media which stores data accessible by a computer may also be used in the operating environment.

Program modules may be stored on the hard disk, magnetic disk 110, optical disk 112, ROM 105 and RAM 106. Program modules may include operating system 116, one or more application programs 117, other program modules 118, and program data 119. A user may enter commands and information into personal computer 101 through input devices such as a keyboard 122 and a pointing device 121. Other input devices (not shown) may include a microphone, joystick, game pad, satellite dish, scanner, or the like. These and other input devices are often connected to the processing unit 102 through a serial-port interface 120 coupled to system bus 104; but they may be connected through other interfaces, such as a parallel port, a game port, or a universal serial bus (USB). A monitor 128 or other display device also connects to system bus 104 via an interface such as a video adapter 123. A video camera or other video source is coupled to video adapter 123 for providing video images for video conferencing and other applications, which may be processed and further transmitted by personal computer 101. In further embodiments, a separate video card may be provided for accepting signals from multiple devices, including satellite broadcast encoded images. In addition to the monitor, personal computers typically include other peripheral output devices (not shown) such as speakers and printers.

Personal computer 101 may operate in a networked environment using logical connections to one or more remote computers such as remote computer 129. Remote computer 129 may be another personal computer, a server, a router, a network PC, a peer device, or other common network node. It typically includes many or all of the components described above in connection with personal computer 101. The logical connections depicted in FIG. 15 include local area network (LAN) 127 and a wide-area network (WAN) 126. Such networking environments are commonplace in offices, enterprise-wide computer networks, intranets and the Internet.

When placed in a LAN networking environment, PC 101 connects to local network 127 through a network interface or adapter 124. When used in a WAN networking environment such as the Internet, PC 101 typically includes modem 125 or other means for establishing communications over network 126. Modem 125 may be internal or external to PC 101, and connects to system bus 104 via serial-port interface 120. In a networked environment, program modules, such as those comprising Microsoft Word which are depicted as residing within 101 or portions thereof may be stored in remote storage device 130.

### Concepts and Lexicons

The system 5 relies on interactions of members within groups to allow for emergence of concepts and relations. The equilibrium is dependant on the initial conditions and the mechanisms. The initial conditions refer to the tags and concepts available in the Lexicons 31 before usage begins of the Directory.

The system 5 leverages the emergence constantly taking place in natural language. Preferably, the Base Lexicon 40 for the mechanism is constructed from a dictionary such as a lexical dictionary like WordNet. Other ways include analyzing corpora tagged with word-sense, existing ontology efforts like OpenCyc, SUO, SUMO, uses of terms in web search engines or investigation the tags used in current Folksonomies.

In terms of the Lexicon 31, dictionary word-forms have a parallel in keywords and word-senses have a parallel in concepts. Synonymy is effectively equivalent to placing a number of keywords against the same concept. Polysemy (which is the word-senses associated against each word-form) has its parallel in a keyword matching a number of concepts. In general use, an underspecified concept may serve a large group of people. In situations where a specific group of people require a specialized meaning to a word, they create a separate concept that clearly differentiates between the meaning it embodies from the general meaning associated with the first concept. If the group is a general audience, this specialization may never take place. In a specialized audience, once the specialized meaning is created it is more used than the general concept. By having an input method that matches keywords to concept based on actual usage, the specialized meaning is automatically ranked higher than the general one and may be the default. If a group of users embody both a general audience and a specialized audience, then individual usage based ranking automatically ranks the right concept higher for each individual's use. Therefore, usage based ranking allows for intuitive use of concepts at the right level of meaning.

The set of associated meanings in the Base Lexicon may be limited to ones of common use. A lexical resource like WordNet is leveraged to find common usage in a language. The goal for the initial condition is coarse-grained concepts that correspond to a broad consensus and general use, and their mapping to keywords. This allows special interest groups to create such meaning as required in a separate Lexicon 31. This source is relatively stable and updated responding to the language overall because it takes time for words and meanings to find common usage in a language.

Word-senses with a relatively larger number of word-forms may be a good indicator of coarse-grained concepts. Word-senses that are shared across languages may be good candidates for coarse-grained concepts as well. Word-senses that are frequently used in mass publication may serve as a seed as well. The keywords corresponding to such concepts include common abbreviations and word-forms from other languages where possible. The mechanism also allows the ability for a user to associate keywords on an individual basis like aliases. Frequently used keywords is automatically be ranked higher against the concept so that common usage is not encumbered by the presence of extra keywords. Therefore, there is no requirement for general agreement on keywords and they may be added freely against concepts.

The problem of multiple fine-grained senses against words is handled differently. Broadly, it is divided into homograph/homonym, related polysemy, and systematic polysemy.

In the case of homonymy, each meaning is typically unrelated to the other and therefore is included as concepts. However, some homonym meanings are not broadly useful for the purposes of categorization of things and are left out. If such a meaning is required in the future, the group can create it.

However, homonymy accounts for a small part of the polysemy seen in a natural language. One major category is related polysemy. This occurs when the different meanings are related to some common meaning. In general, related polysemy is approached by ignoring related senses where they do not serve as generally useful categories. Systematic polysemy refers to the pattern of meanings attached to a word is found in other words as well. Including one meaning may adequately service most of the use even if the other meaning is left out. This may be repeated across all word of the same system of polysemy. As an example, baseball, football, volleyball, etc. all have the two meanings—game and ball. In most usage, the meaning referred to is the game. Therefore, reduction of polysemy to the game may be applied uniformly across this system.

In terms of concepts, the Base Lexicon can leverage readily available linguistic or ontological sources to initialize it. Once this mechanism has been used, then future base lexicons can evolve out of the mechanism itself. In terms of the relationships used between concepts in a Base Lexicon, it is preferable to limit these to relationships of broad consensus. There are certain concepts that specifically created to convey meanings that are inherently hierarchical, such words may use an ‘is-A’. Other concepts may have a more ambiguous relationship such as the case of related polysemy and are better candidates for the ‘related-To’ relationship or none at all. Certain concepts like names of places have an inherent transitive relationship because they are mostly located in some other place. Such places may have a ‘TRelated-To’. But mostly and in general, concepts can exist without any such relationships and will often times do so. The more general the concept, the less likely it will have relationships. It is fine for concepts to start of with no relationships whatsoever as long as they can be added when needed for a specific implementation. It is likely that a preferred embodiment for the Base Lexicon will include a Dictionary of concepts and an optional Lens of relationships that a given implementation may choose to incorporate or not.

Domain Lexicons 41 aim at capturing concepts commonly used by people in a domain. Unlike the Base Lexicon 40, Domain Lexicons 41 are constantly adding new concepts and many fade out over time through the lack of use or relevance. This mechanism allows for rapid addition of concepts that are shared by people in a domain and the usage based mechanism allows concepts to fade out if they are not used. There are many domain-based resources that are leveraged to create a Domain Lexicon 41. As an example, the life sciences community has many resources like MESH and other that attempt to define medical terms or place them into ontologies. Domains like finance have specialized dictionaries that may be leveraged. Like Base Lexicons 40, Domain Lexicons 41 leverage the Input Method mechanism for assigning keywords to concepts. Perhaps, one of the significant benefits of this mechanism is the definition of the relationship structure. Many domain specific terms leverage noun phrases, complex nominals, genitives, etc. Even these terms may be included into a relationship structure easily. Generally, the Domain Lexicon 41 and include a rich set of relationships between concepts thereby allowing the user to find items easier.

Group Lexicons 42 cater to the vocabulary with a group or an organization. Unlike the Base 40 and Domain Lexicons 41 that serve like as Reference Lexicons and remain read-only, the Group Lexicon 42 is read-write. The Group Lexicon 42 focuses on concepts that make sense only within a group. “Computer Science Department” may not make sense in the general language but has a very specific meaning in the context 21 of a university. Many such concepts, like the ones in a domain, occur as complex nominals or noun phrases that leverage the expressive power of the relationships. It is preferable that such concepts are added to the initial state of Lexicon 31 before the group starts to use and modify it. Turning to FIG. 9, such a Lexicon 31 may define organization structure so that document management and workflow is aided in a controlled fashion. A set of common concepts that are created by a system administrator that is leveraged across the group.

Unlike the polysemy observed in the Base Lexicon, the concepts created here can have many unique characteristics that are not observed in the language at large. For example, a hypothetical brand consultancy company like ABC may define Sony to be a customer, a brand and possibly a vendor. A Group Lexicon in such a firm should clearly define all these concepts and attach them to the keyword Sony. Also, it is likely that such a firm may have unique definitions of the concepts ‘Brand’, ‘Customer’, ‘Vendor’, etc. As shown in FIG. 16, these concepts may be expressed in the system to the requirements of the given situation. These would be in addition to the more commonly associated meaning for Sony as an electronics manufacturing company that may come from either a Domain or Base Lexicon. What this allows is that a person searching for Sony the company can still find all the different aspects of Sony in ABC, but for a person in Creative Department, Sony can still mean the brand and all items associated with the brand will be categorized separately. It is possible to have a Reference Lexicon that caters specifically to terms used in the group. This may be built from ER models of databases, UML models of enterprise processes, entities and attributes of enterprise services, etc.

Therefore, by having Lexicons 31 at different levels, polysemy is managed at the level most relevant to the users and thereby solving the overall problem of creating a generalized resource with too many fine-grained senses that a lexical dictionary like WordNet faces.

For initial conditions for each Lexicon 31, every concept that is commonly used by the corresponding group of people is included in the Lexicon 31. An implementation may achieve this goal to a greater or lesser extent, however the fact that commonly shared meanings are captured is not compromised. The superior implementations have better coverage of the user population than an inferior one. Even if each Lexicon 31 is not complete or adequate, an equilibrium is achieved. The rate at which this equilibrium is formed depends primarily on the mechanisms but the actual equilibrium achieved depends on the quality of the initial Lexicons. In practical situations, it may be appropriate to develop a Lexicon using a pilot implementation and have that Lexicon serve as the initial conditions for a broader roll-out. This is because the language used is commonly shared and even a small group may demonstrate a comparable range of terms as the broader population. For greater resource sharing, a better initial Lexicon provides broader sharing.

### Lexicon Mechanisms

The Lexicon Store 30 differentiates between “read-only” Lexicons like the Base Lexicon 40 or Domain Lexicons 41, and “read-write” Lexicons like the Group Lexicons 42 or the Individual Lexicons 43. Read-only means that these Lexicons are not changed as the result of group activity and changed only in a controlled manner such as version upgrades. The read-write Lexicons are those that users may change in a continuous fashion. Lexicons 31 may depend upon other Lexicons 31. This means that the inter-relationships within their Lens 46 involve concepts from other Lexicons. If there are no such inter-relationships, then the Lexicon 31 is considered independent. The Base Lexicon 40 is independent. Domain Lexicons 41 may depend upon a Base Lexicon 40 or may be independent.

Dependency involves one Lexicon 31 making statements about or changes to another. It may be created in a number of different ways. Such statements are made about concepts in another Lexicon 31 or relationships with concepts in other Lexicons 31. Since Lexicons 31 are made by different parties with no collaboration between them, such dependencies have the ability to dramatically affect the consistency of the system with regards to user of such Lexicons 31. Nevertheless, there is a genuine need to integrate between Lexicons 31 and the preferred embodiment elaborates a simple set of conditions that allow large-scale inter-operability.

It is not possible to delete or change the concept unique identifier, description or keywords of a concept in a different Lexicon 31. This is because the fidelity of the concept is determined by the predictability of the Description and keywords to the user of that concept. This fidelity is undermined if any Lexicon compromises this for another. It is possible to insert new keywords to that concept. This insert may be stored in a Lexicon 31 different from the one that the concept is in. This introduces a dependency going from the Lexicon 31 with the insert to the Lexicon 31 with the concept. Both Reference as well as read-write Lexicons may have such an insert.

A number of different combinations of relationships are possible. For Lexicon A where statements are stored and Lexicon B about which the statements are about, there are three cases: a relationship from a concept in A to a concept in B (case 1), a relationship going from a concept in B to a concept in A (case 2) and a relationship going between two concepts in B (case 3). All these relationships may be stored in Lexicon A. Furthermore, it is possible store relationships in Lexicon A that override or delete existing relationships in Lexicon B. These combinations allow for a complex set of dependencies where a Lexicon completely alters the intent and functionality of another and even the order in which the Lexicons are mounted affects the final representation.

Case 1 produces a dependency going from A to B, case 2 produces a dependency going from B to A and case 3 produces a dependency going from A to B. Furthermore, in case 2 and case 3 there may be statements that override or delete an existing relationship in B. By limiting statements in A to case 1, a number of advantages may be derived. Delete or override is not an issue because the existing relationship is in A and therefore is changed with no effect to B. Also, because of the nature of the ‘related-To’, ‘is-A’ and ‘TRelated-To’ relationships, it is not possible to break consistency in B through the use of only statements in case 1, as it is not possible to introduce cycles in B without having relationships outgoing from concepts in B. The ‘same-As’ relationship is a special case of a cyclic dependency since by placing this relationship it automatically makes each Lexicon 31 dependent on the other. In the general case of cyclic dependency, even the ‘is-A’ and ‘TRelated-To’ relationships may be compromised by introducing cycles in graphs between each other.

In order for Reference Lexicons 40, 41 to be widely shared with no consistency problems, the following set of requirements are specified:
All relationships between Lexicons are of case 1 (pure inheritance)
The ‘same-As’ relationship cannot be used between Lexicons
There is no cyclic dependency between Lexicons
A Reference Lexicon cannot depend on a read-write Lexicon
The Lexicon is read-only

Cyclic dependency is defined for the purposes of this description to be any dependency between Lexicons 31 including keywords as well as relationships. This is not the only approach to solving the dependency issue nor is it the best for a given situation. A particular embodiment may not include keyword insert in defining dependency or define cyclic dependency only at the ‘is-A’ and ‘TRelated-To’ graph level and allow the ‘same-As’ relationship as well as the other cases (both insert and delete) while allowing the merge Lexicons 31 with no loss of fidelity. This can be ensured at merge level. The preferred embodiment gives a set of simple thumb rules that allows widely dispersed people making Lexicons 31 to inter-operate seamlessly. An implementation may adopt a different strategy and achieve the same semantics.

The last two requirements allow a Reference Lexicon creator to know that the Lexicon 31 is not altered in normal functioning of the system by factors that are not under their control. Therefore, a change to a read-write Lexicon cannot break the Reference Lexicon. Furthermore, a Reference Lexicon depending on another knows that the structure changes in a controlled manner and it can assert compatibility with a certain version. Finally by defining a coarse-grained cyclic dependency at the Lexicon level, all Reference Lexicons is represented by a dependency graph that is a DAG.

These requirements are relaxed completely in the case of read-write Lexicons like a Group Lexicon 42 and an Individual Lexicon 43. Such Lexicons freely insert/update/delete any relationship of any other Lexicon 31. This presents a challenge to ensuring consistency. In general this has the complexity of an ontology merge, which means it is both difficult and time consuming. In order to simplify this problem, the mechanism limits mounting to exactly one Group Lexicon 42 and its corresponding Individual Lexicon 43 at a time. A Group Lexicon 42 cannot depend on an Individual Lexicon 43. The Individual depends on as many Reference Lexicons as required but must not depend on any other Group Lexicon 42 apart from the one corresponding to it. When either Lexicon is mounted, the other is also mounted. Furthermore, a precise mount order or a stacking order is specified for these Lexicons. The Group Lexicon 42 is mounted first and the Individual Lexicon 43 is mounted afterwards. Effectively, the Individual Lexicon is a personalization Lexicon 31 for a Group.

In the case of Lexicon A and B with respect to relationships of case 2 and case 3, it is possible for statements in Lexicon A to add relationships in B where none existed or to replace existing ones. In the case of replacing existing ones, it takes the general form of an override. This may take place in different situations. Relationships are ordered according to their strictness as illustrated in FIG. 17. By replacing a less strict relationship like ‘related-To’ with a more strict relationship like ‘is-A’, there is no fundamental change in semantics and the only thing added is greater precision. The consistency of the resulting graph structure may have been changed but if not, then the meaning has been enhanced rather than changed.

However, an override may go in the reverse direction where the resulting graph consistency may not be affected but the information behind the graph may have been lost. A delete of a relationship may be simulated by incorporating a relationship called ‘no-Relationship’. During the creation of a graph structure this is equivalent to deleting any existing relationship between the concepts.

The precise order of these statements gives different results. Since there are only two Lexicons allowed to have such override relationships (the Group Lexicon 42 and the Individual Lexicon 43), the order in which they are mounted determine the final relationship between the concepts. For example, if the existing relationship is ‘related-To’, the Group Lexicon 42 specifies an ‘is-A’ relationship and the Individual Lexicon specifies a ‘no-Relationship’, if the Group is mounted first then the final state is no relationship but if the individual is mounted first then it is ‘is-A’. If neither is mounted then the relationship is ‘related-To’. Conversely, with a precise mount order for all Lexicons with such override statements, it is possible to have a predictable final outcome. In another embodiment, it is possible to include such override statements in Reference Lexicons as long as the mount order is precise and the dependency graph is a tree.

Finally, the Group Lexicon 42 is not allowed to have a dependency on the Individual Lexicon 43 as that means that separate Individual Lexicons cannot break the consistency of the Group. Therefore, there is no cyclic dependency in the entire system and the dependency graph of all Lexicons within the system is a DAG.

There is a reason for organizing these Lexicons in such a fashion. With unlimited capability to change relationships, a Group Lexicon creates a view completely independent of the one stored in Reference Lexicons. Therefore, a standard Lexicon is customized completely. This also allows that a Reference Lexicon ships only as a dictionary and the Lens is optional. All the relationships in the Lens 46 is input into the Group Lexicon 42 without having to enforce/mandate such structure at a higher level. By having a precise stacking order, the Individual Lexicon 43 overrides anything in the group. This provides a truly personalized view to a shared data source.

Each Group Lexicon 42 evolves differently with structures that are not compatible with each other. Compatibility is referred to as consistency in their graph structure of relationships. Consistency with respect to concepts is ensured by assigning each concept a unique identifier and a Description and at least one keyword as well as not allowing deletes to concepts, concept unique identifiers, Descriptions or keywords (unless there is no reference to them). Therefore, the only operations allowed are purely additive and there is no way to compromise the integrity of a concept. A specific embodiment may allow users to edit Description or keywords as it deems fit but for the general case the above might represent a superior policy. For relationships however the ‘is-A’ graph requires to be a set of trees and the ‘TRelated-To’ graph needs to be a set of DAGs. This is after all ‘same-As’ relationships have been processed and any delete/override statements have been incorporated. If the resulting graph of these relationships meets these requirements, then the graphs are said to be consistent.

Users are able to freely make such changes to both the Group Lexicon and the Individual Lexicons. Changes like insert/update/delete of the ‘is-A’ and the ‘same-As’ relationships have significant consequences. Such a change at the Group Lexicon level is mediated through a system administrator.

The above does not limit expressiveness. Firstly, the user in all respects may freely administer an individual Lexicon that is not shared by anybody else and which has no other Lexicons 31 that depend on it. On such a Lexicon 31, the user is free to make any changes to inter-relationships in any and all other Lexicons 31 without affecting anyone else. Therefore, the expressive power of the entire system as far as the user is concerned is in no way compromised and at this level all the user views may be inconsistent with each other. Secondly, even in shared Lexicons the user has comparable expressive power based on changes allowed on concepts as well as the ‘related-To’ relationship. In fact, the ‘is-A’ and ‘same-As’ relationships are typically defined by the administrator after looking at the behavior of users using the ‘related-To’ relationship. Thirdly, an embodiment for a Base 40 or Domain Lexicon 41 may ship with a Dictionary 45 and an optional Lens 46. Such an optional Lens may take the form of a separate Lexicon and the contents of the Lens 46 may be imported into a group Lens to change at will. In such a case, any third-party Lexicon got from external sources like a download of a file can rely on the concepts of the Base and Domain Lexicons 41 to be intact and include in its Lens 46 its own custom graph structure without worrying about consistency. As all the changes in the system are limited to the Group Lexicons 42 or the Individual Lexicons 43, such a third-party Lexicon may be mounted separately (like a Tag-Mounted Lexicon) without affecting any other Lexicon or having another Lexicon affect it. Also, the restriction of only one Group Lexicon 42 may not be too restrictive as the group can be as large as required. The same user may unmount from a Group Lexicon 42 and mount another Group Lexicon 42 as they desire. The structure places some restrictions to Lexicon structure while not sacrificing expressiveness. The mechanism functions with any subset of the above Lexicons 31. As an example, it functions with only a Base Lexicon 40 or an arbitrary combination of Reference Lexicons.

Mounting a Lexicon 31 is the process of taking the Lexicon 31 and all its dependencies and creating a unified representation for both the dictionaries of the Lexicons 31 as well as a merged graph of all the relationships. This merged representation contains all the concepts available to the user and all their inter-relationships. To use the mechanism, the required Lexicons are mounted so that they are available to the Input Method, the Directory Viewer 20 and Tagging Interface 25. This allows the Input Method to match keywords to all concepts in all Lexicons. If a user specifies a keyword that does not exist in the mounted Lexicons, the Lexicon Store 30 may optionally search other Lexicons to determine whether such a keyword exists and suggest the user to mount such a Lexicon if appropriate. The mounted Lexicons allow the Item Store 10 to determine which concepts to return against a context in the Directory Viewer 20 and the Tagging Interface 25 (as concepts not in the mounted Lexicons cannot be understood by the user). The user may mount as many read-only Lexicons as required in any order. The user mounts only one Group Lexicon 42. In order to mount another Group Lexicon 42, the incumbent Group Lexicon 42 and Individual Lexicon 43 are unmounted. When a Group Lexicon 42 is mounted the corresponding Individual Lexicon 43 is mounted as well and vice versa.

The mount process undergoes all the necessary checks to ensure that all the requirements described above are met and the merged representation is consistent. If the user already has Lexicons mounted, then any subsequent Lexicon merges the new concepts and graph with the existing representation. Essentially the mount operations ensure the following:
find and mount all Lexicons that it is dependent on Lexicon to be mounted
make sure that there is no cyclic dependency between Lexicons
make sure that no Reference Lexicon has any delete/override statements
make sure that no Reference Lexicon has any case 2 or case 3 statements
make sure that Reference Lexicon is kept read-only
make sure there is no concept referred to in a relationship missing
make sure each concept identifier is unique
make sure that each Lexicon identifier is unique
make sure each concept has Description and at least one keyword
make sure there is at maximum one Group Lexicon
If mounting a Group Lexicon, it mounts the Individual Lexicon as well
If mounting an Individual Lexicon, it mounts the Group Lexicon as well
make sure all Reference Lexicons are mounted first
make sure the mount of read-write Lexicons occurs in stacking order
create a keyword to concept index across all Lexicons
create a unified graph—merge of Reference Lexicons, process all override statements and do read-write Lexicons in stacking order
process all same-As relationships
make sure that ‘is-A’ graph is a set of trees and ‘TRelated-To’ graph is a set of DAGs
persist merged representation for future use by the user

Any combination of Lexicons 31 may be mounted. This includes the Base Lexicon 40, or Base and Domain Lexicons 41, or Group/Individual Lexicons 42, 43 with all their dependencies as well as Group Lexicon 42 with dependencies and any other Reference Lexicons required. A Reference Lexicon that is only a lens 46 cannot be mounted by such a mechanism. However, such a Lens 46 is incorporated into a Group 42 or Individual Lexicon 43 and be utilized. Optimizations include caching the merged representation of mounted lexicons such as Reference Lexicons where the contents do not change and their mount order is immaterial. Furthermore, each Group Lexicon 42 and its corresponding Individual Lexicon 43 may have a significant portion shared across a number of users and therefore a cached representation may be leveraged across such a group. Furthermore, changes to a Group 42 or Individual Lexicon 43 is isolated and performed piecemeal to the merged representation so that a full merge from scratch is not required.

Unmounting a Lexicon 31 is the equivalent to unmounting the entire graph of Lexicons 31 that depend on it. In the case of unmounting a Group Lexicon 42, the Individual Lexicon 43 is unmounted as well and the merged representation returns to the graph structure prior to the mount of the Group Lexicon 42. Since all other Lexicons that were mounted at that time were Reference Lexicons, this is retrieved from a cached representation. In the case of unmounting of the Base Lexicon 40, all Lexicons need to be unmounted and the resultant merged representation becomes an empty set.

In the case of the Tag-Mounted Lexicon, the mount operation is initiated automatically when the Lexicon tag comes into the context of the Directory Viewer 20 (or the Tagging Interface 25, if appropriate). This is equivalent of unmounting all incumbent Lexicons 31 (or caching it) and mounting the Tag-Based Lexicon and all its dependencies including potentially the Base and Domain Lexicons 40, 41. When the tag 12 is removed from the Concept, all the Lexicons 31 are unmounted and the previous Lexicons 31 are mounted once again.

Lexicons 31 which are mountable are stored within the Lexicon Store 30. To create a new Lexicon 31, a unique identifier and an empty Dictionary 45 and a Lens 46 are used. To import or add an existing Lexicon 31 into the Lexicon Store 30, the consistency checks required are the same as those for mounting a Lexicon 31. Therefore a mechanism is provided that creates Lexicon structures temporarily for it and all its dependents that do not exist in the Lexicon Store 30, attempt to mount it to determine whether they are consistent or not, and then depending on success or failure of the mount operations make the data structures permanent or discard them.

To remove or delete a Lexicon 31 from the Lexicon Store 30, a mechanism is provided to verify that there are no dependent Lexicons 31 in the Lexicon Store 30, concepts from it are not used in the Item Store 10 and it is not mounted by any user. If so, it deletes from the Store 30.

A read-writable Lexicon allows a group to create their own concepts and inter-relate them with each other as well as with concepts from the Reference Lexicons. This is primarily achieved through the mechanisms for insert, update and delete for concepts, keywords, descriptions and relationships. This is achieved by editing a Lexicon. All edits are made to a single Lexicon at a time. Only read-write Lexicons are allowed to be edited. Edits in a read-write Lexicon may affect or change other Reference Lexicons. In the case of the Individual Lexicon, such edits may change or override edits in a Group Lexicon.

The process for inserting/updating/deleting a concept, description or keywords allows for a temporary mount of the edited Lexicon (and all it depends upon) as well as any other Lexicons that are required for the edit. This is a separate data structure than the one used by the user for normal processing for the Input Method, Directory Viewer 20, etc. and is removed after the edit has been completed or failed. The mechanisms ensure the following behavior is achieved:
Reference Lexicons cannot be edited
Each concept identifier in a Lexicon is unique and cannot be changed (once created)
Each concept has one and only one description
Each concept has at least one keyword
Concepts cannot be deleted unless it is not used. This means that the concept is not used in the Item Store 10 for tagging or typing items or is not referred to within any other Lexicon in the system. If a used concept is to be deleted, it is deprecated such that future use is curtailed and then it is removed later in a administrator mediated fashion.
The description of any concept in a Reference Lexicon cannot be changed or deleted
New keywords assigned against concepts in a separate Lexicon are managed within the edited Lexicon. Therefore, if a user adds a new keyword to a Reference Lexicon but keep it private, the user edits the Individual Lexicon and such an edit is only seen by the user and not the group.
Keywords in other Lexicons cannot be deleted or changed, although such keywords stored in the edited Lexicon are allowed to be deleted or changed.
Description of concepts are changed for the edited Lexicon but not for others

The mechanism for the insert or delete of a relationship is described. In this case, update is the equivalent of a delete and insert, and a delete is the equivalent of inserting a special purpose relationship called ‘no-Relationship’ that instructs the system to ignore any existing relationship. Any inserts or deletes is reflected in the structure of the Lexicon 31 directly. However, for relationships that go from concepts in other Lexicons 31, instead of actually changing the structure of the other Lexicon 31, this mechanism stores such statements in the edited Lexicon and processes them when Lexicons 31 are mounted so that the resultant merged representation reflects these changes. This means that such changes can be deleted at a later time and the original state of the other Lexicon 31 may be returned to. By defining the delete operation as a relationship, one advantage gained is that the final state of the relationship between two concepts is stored by a single entry that overrides anything before it. Since the stacking order of read-write Lexicons is established, the overrides in the Individual Lexicon override the corresponding ones in the Group Lexicon. This mechanism ensures that the resultant graph after the edit is consistent. This means that the ‘is-A’ relationship defines a set of trees structure and the ‘TRelated-To’ relationship defines a set of DAGs structure. It also makes sure that cyclic dependency between Lexicons is not introduced by the ‘same-As’ relationship.

These mechanisms may require and be complemented by the use of standard technologies like authentication, authorization and access control. Furthermore, as shared data structures are being edited, the shared resource is locked. In this case it may be edited Lexicons. This locking may be done at the concept or the relationship level in order for superior performance. Furthermore, changes need to be persisted and notified. Depending on the embodiment, changes to the Lexicon are either incorporated in real time to users who have mounted the Lexicon or may be deferred till the next time such a user mounts the Lexicon. Even a single change to a Group Lexicon that introduces a dependency with a fresh new Lexicon means that all users in the group now need to mount that new Lexicon. These operations may be optimized, such as caching. In many situations, relationships between concepts may be added in an administrator-mediated fashion. As users tag items in the Item Store 10, such administrators may leverage a number of existing technologies to mine for the presence of ‘related-To’ and ‘is-A’ relationships. This may include techniques such as Formal Concept Analysis, etc.

In other embodiments, each Lexicon 31 can store information regarding the visibility of its concepts to other Lexicons. This means that if a Lexicon 31 does not make its concepts visible to other Lexicons 31, then such other Lexicons 31 cannot add keywords or relationships to concepts in the Lexicon 31. Therefore, a Lexicon that does not make its concepts visible to other Lexicons 31 cannot have other Lexicons 31 dependent on it. Such Lexicons become the equivalent of a Controlled Vocabulary. There may be a number of other meaningful restrictions that may be placed with regards to visibility such as specifying a subset of the concepts that are visible while the others remain invisible or metadata may specify that a Lexicon 31 may have visibility to it. In another embodiment, each Lexicon 31 may optionally specify whether the concepts within it may be used within the Tagging Interface 25 by a user, group or all users. In case the Lexicon 31 does not allow such use, all users are able to use the concepts and relationships of Lexicon in the Input method for the context of the Directory Viewer 20 but not the specification of concepts in the Tagging Interface 25. This allows for items to have tags that are known to come from a specific source.

In conjunction with the Input Method, the user of the Directory uses concepts from any of the Lexicons in the Lexicon Store 30 in order to tag or view items. The Lexicon Store 30 is converted to the semantic equivalent of an Ontology Engine. This implies that the front-end of the input method communicates with the Lexicon Store 30 allowing the user to convert entered text into any concept stored in the Lexicon Store 30. This is based on the same mechanism of matching keywords with the concepts. Such matching may use stemming, partial completion, etc. The mount mechanism effectively creates a merged Dictionary structure for the user such that the Input method matches keywords to concepts across different Lexicons 31. Such concepts are then passed to the Directory Viewer 20 or the Tagging Interface 25 as required. Each keyword or description is a text string and may exist in a number of different natural languages thereby providing support for different languages seamlessly.

There are some differences in the semantics of the Lexicon Store 30 versus the Ontology Engine. A major change is the structure of the concept relationships. In the Ontology engines there is only one type of relationship and the structure was a DAG. In this embodiment, the input method may leverage the set of trees structure of the ‘is-A’ relationship and/or the structure of the ‘related-To’ relationship. This embodiment limits it to the ‘is-A’ relationship. Usage in the context 21 of this mechanism corresponds to each time a keyword is matched to a concept. This occurs at the Input Method during tagging or specifying concepts in the context 21. It also occurs during drilling down to a concept in the Category Display where the display text of the concept serves as the corresponding keyword used in that situation. Such usage may be normalized within the group and stored as a hint within the Lexicon 31. In the situation where a keyword has been inserted in one Lexicon 31 to a concept in another, the usage weight is stored in the Lexicon 31 of usage which is the one that stores the keyword. These normalized weights are collapsed at the Input Method giving precedence to individual preference. Therefore, the ranks in the Individual Lexicon 43 may have more weight than the ranks in the Group, similarly the group more than Reference, etc. The final arbitrator is the actual usage of a user of a concept corresponding to a keyword rather than something based purely on Lexicons 31. However, in the absence of such a weighting and complementing it, the sort order of the concepts within the Input Method is calculated from all those weights.

### Item Store 10 Mechanisms

Generally, the Item Store 10 is a server that allows the front-end functionality like the Directory Viewer 20 and the Tagging Interface 25 to be implemented as a client. This is done in the form of an API that is called over RPC, web services or other similar mechanisms.

The principle functions supported by any Item Store 10 are as follows:
add/remove items
insert/update/delete tag on item
insert/update/delete type on item
get an item
select and return items and their corresponding concepts for a context

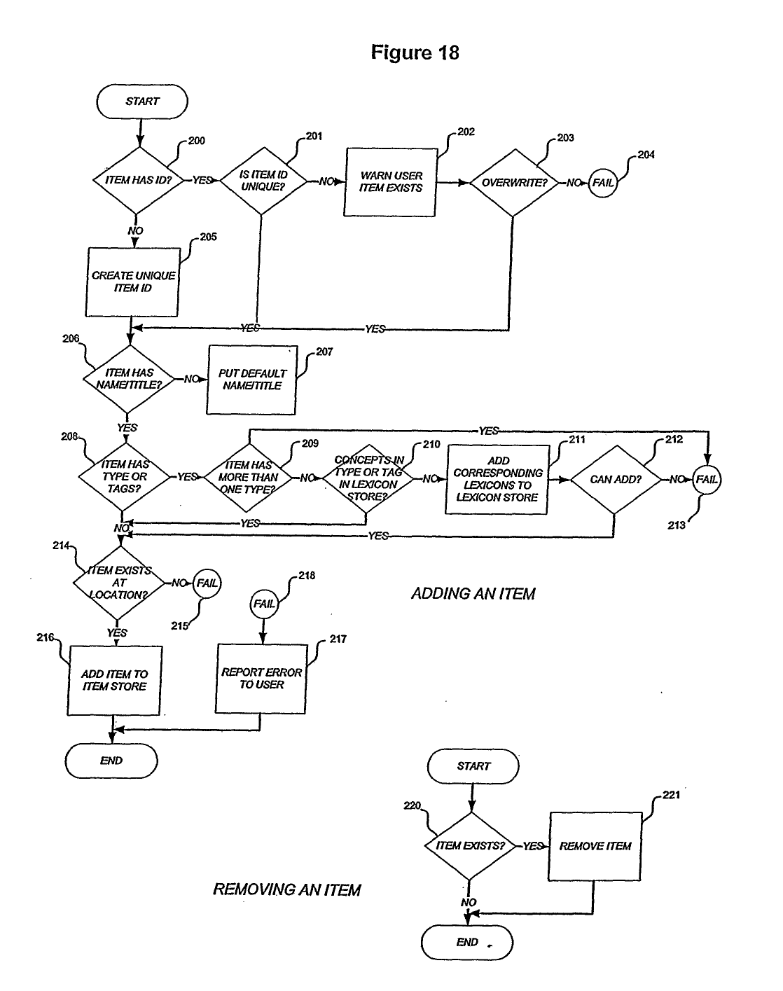

Referring to FIG. 18, the Item Store 10 may not actually store the item 11 but uses a unique item identifier in place of the item 11. This is unavoidable for items 11 like web pages or physical items that may have a bar code. Depending on the implementation, the Item Store 10 may also store the item 11 like a file system. However, an item 11 is defined 200 by an item identifier which is unique 201, a reference that locates the actual item, a name or description 206 which is a human readable text string describing the item 11. A check 208 is made to determine if the item 11 has a type 13 or a tag 12 or neither. A check 209 is made to determine if the item 11 has one type 13 but if it has more, the item addition process fails 213. Depending on the implementation, an item 11 may exhibit multiple inheritance and therefore may have multiple types 13. Such tags 12 come from any number of Lexicons 31. The Item Store 10 enforces that all tags 12 or types 13 of items 11 in the Item Store 10 to concepts that have a corresponding definition in a Lexicon 31 available at the Lexicon Store 30. Thus, while adding an item 11 if it is fagged with concepts from a Lexicon 31 that is not available, then such a Lexicon 31 must first be added 211 to the Lexicon Store 30 before an Item 11 is added 216 to the Item Store 10. The Item Store 10 may enforce a more stringent policy with regards to update and delete.

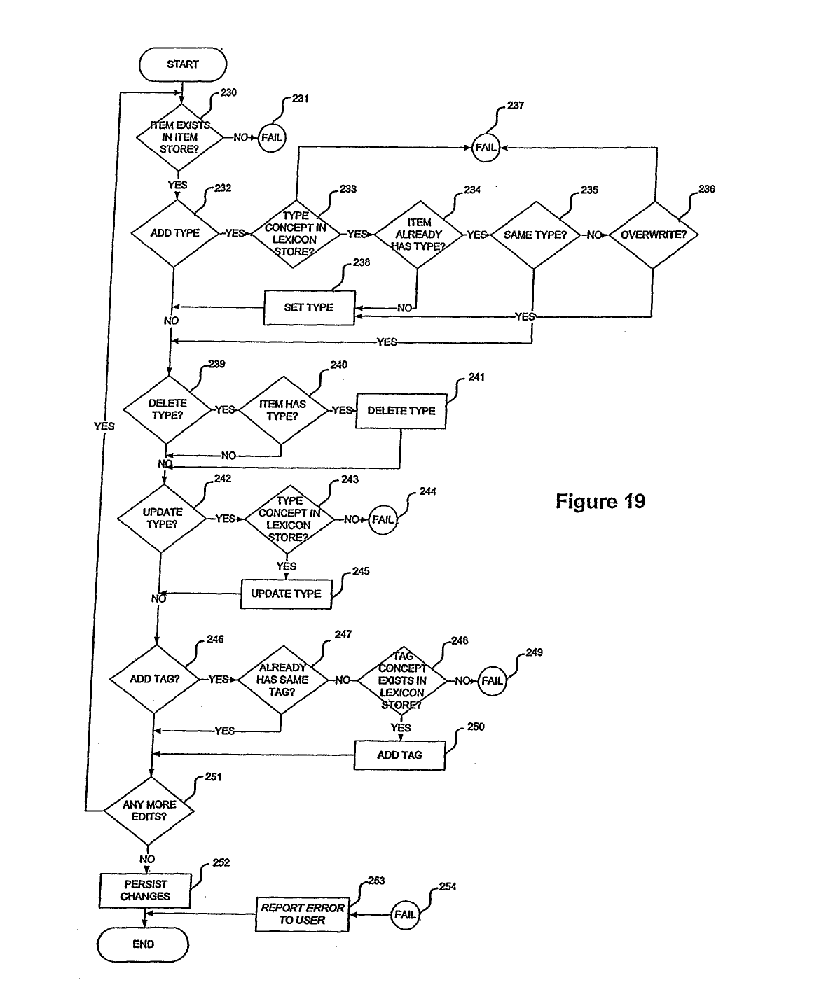

Referring to FIG. 19, the mechanism of the preferred embodiment does not allow update or delete of tags 12. In general, different users tag the item 11 differently but may depend on each other's tags 12 to help find it. Also, if a tag 12 is useful to the group, there is no reason to update/delete it. If it is not useful to the group, then usage based ranking methods allow the item 11 have a low rank corresponding to selects and therefore effectively fades away from the group view. Another implementation may allow some or all users the ability to update or delete tags 12 if the specific requirements favor it.

The mechanism allows users to insert 238, update 245 and delete 241 the type 13. This type 13 is a concept that comes 243 from any Lexicon 31 in the Lexicon Store 30 and such a Lexicon 31 does not need to have any relation with the Lexicons 31 used in tagging. This mechanism ensures that there is only one type 13 for an item 11 and allows anybody including the author, the user or the administrator may change it. Other implementations may have a different policy regarding this. For example, update 245 and delete 241 may be restricted to the user that inserted the type 13 or an administrator. Depending on the context 21 of the use of the Item Store 10, each such policy may have relevance. Therefore, the mechanism described in the preferred embodiment is one such policy.

The requirements for items 11 in the Item Store 10 are that each item 11 has a unique identifier within the Item Store 10 and it has a reference for location the item 11. An item 11 like a web page may use a URL to serve as both. Ordinarily, the item 11 has a human read-able name or description but in the case it does not, a suitable default is used. This allows the Item Store 10 to operate over a wide range of items 11. In a specific implementation, there may be advantage to adopting more stringent requirements of items 11 and that is done as per implementation requirements without changing the basic functionality.

Each Item Store 10 has a unique location within the system 5 that allows the other components like the Directory Viewer 20, the Tagging Interface 25 or the Lexicon Store 30 to locate it. This may be a URL or a UNC. The components are connectable to different Item Stores 10 based on its location. The Item Store 10 may store the location of the corresponding Lexicon Store 30 in order for it to verify concepts in tags and types. An alternate embodiment allows items 11 to have tags 12 that are not contained in the corresponding Lexicon Store 30. Since all the Item Store 10 does is match the item tag 12 or type 13 with the concepts in the context 21, it is not material whether or not such a concept is well defined within a Lexicon 31. However, the advantage of enforcing the check is to allow differing retrieval behavior dependent on Lexicon. For Tag-Mounted Lexicons, the Item Store 10 converts all tags 12 of such a Lexicon 31 into a corresponding Lexicon tag until the Lexicon Tag is received within the context.

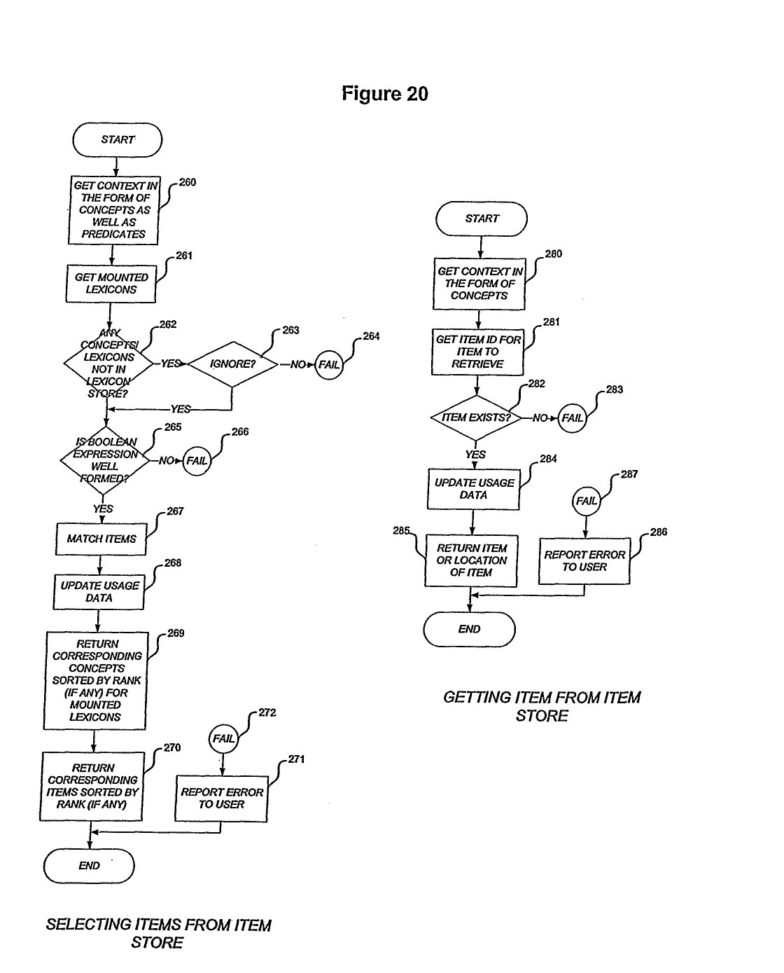

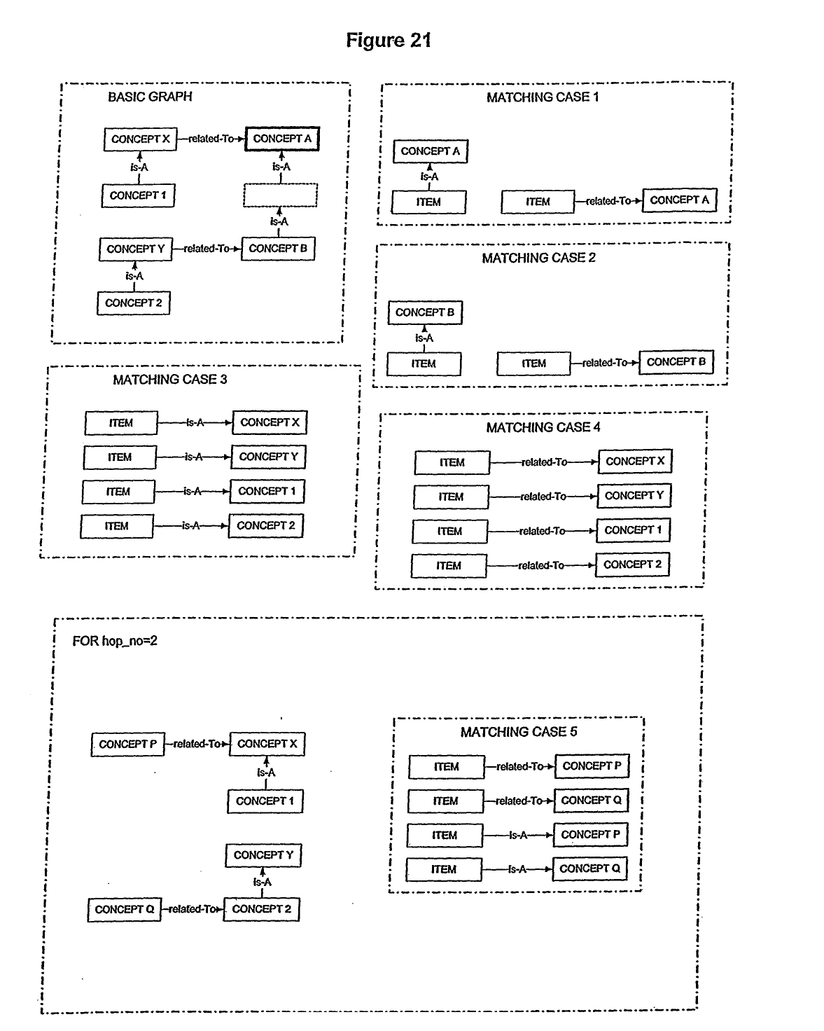

Referring to FIG. 20, the primary function of the Item Store 10 is to allow users to view its contents and locate items 11 of interest. This is achieved through a select mechanism that operates on the basis of a context 21. A context 21 is received 260 (typically from a Directory Viewer 20 or a Tagging Interface 25) in the form of a Boolean expression of predicates. These predicates are in the general form of: f(relationship, concept)

where relationship indicates the relationship type that is one of ‘is-A’ or ‘related-To’. The concept refers to the concept that tags 12 or types 13 an item 11. If the relationship is ‘related-To’, then the function is true for an item 11 that is either tagged or typed with the specified concept. Otherwise, for ‘is-A’ the function is true only for items 11 that are typed with the concept. The context 21 corresponds to a well-formed Boolean expression 265 of such predicates. The Item Store 10 has to find and return 270 matching items 11.

The select operation may be expensive and an implementation for the Item Store 10 may implement a number of optimization strategies like caching. Firstly, each context 21 may be converted to a unique canonical form where this may serve as a key to caching the result data (this may be done at the client like Directory Viewer 20 or Tagging Interface 25 as well). Secondly, the expression may also be expressed in a suitably minimized Disjunctive Normal Form where it is considered to be a logical OR of smaller contexts 21. The context expansion as described previously allowed the front-end to split the context 21 to set of smaller queries and potentially specify a sequence so as to signify semantic distance. This information may be utilized to process a given query faster. This also allows a context 21 to leverage previously processed result sets of smaller contexts 21. Other optimization strategies are possible. Any concept that does not have any items 11 tagged with it allows simplification of the context expression by putting false against its predicates. The context 21 may also be represented as a product of maxterms where the maxterm corresponding to the smallest number of items 11 is leveraged to compute the result. Any such optimization strategy is dependent on the items 11, users and usage in an implementation scenario.

For a context 21, there are potentially a large number of items 11 that match it. From a user perspective it is important that the results are sorted 270 according to relevance. These results include the items 11 in the result set and also the tags 12/types 13 which serve as further drill down categories. There may be many approaches to such ranking and the optimal approach differs based on the items 11 stored in the Item Store 10. Usage based ranking may be effective in a number of cases like smaller Item Stores 10 such as file systems or file shares. The usage based ranking accommodates context to concept ranking 269 as well as context to item ranking 270. Such a ranking system leverages relevance as found by the users of the Item Store 10 through the collection 284 of usage data. For example, the context 21 to concept ranking has as inputs:
# of items tagged with concept (overall)
# of items tagged with concept (in context)
Usage of Tag (overall)
Usage of Tag (in context)
Usage in more limited contexts (such as those from minimizing the DNF)
Recency of Usage of Tag (overall)
Recency of Usage of Tag (in context)

Each of these are assigned a weight in calculating relevance and sorted by that rank. Usage in this case means the usage of the tag 12 for drill-downs in the context 21. Since the context 21 is expanded at the client side to include tags 12 that were not directly input by the user, it is advantageous for the client to include the concepts actually input in the Context Specification section so that usage data for concepts may be collected 284 by the Item Store 10. The mounted Lexicons 31 of the user are sent to the Item Store 10 so that it does not return concepts that come from other Lexicons 31 and therefore are not relevant as they cannot be viewed by the user anyway. If there are items 11 where all tags 12 and the type 13 come from other Lexicons 31, then the Item Store 10 may optionally decide not to return that item 11 as a part of the result set. A large number of concepts may be returned for any context 21 and therefore the Item Store 10 presents a pagination mechanism for the user.

Similar to the case of ranking 269 concepts, ranking items is based on usage. Other offline methods like bookmarks, PageRank™, and last access time, may supplement a usage based ranking method. Pagination of responses is supported so that the client may view a small subset of highly ranked items page at a time.

After an item list is displayed, the user finds an item 11 of interest and attempt to get it or open it. This is processed through the Item Store 10 such that even if the item 11 is not stored there, the location of the item 11 is obtained 285 and the item 11 is retrieved. This is the mechanism used to capture usage information so even if the result set of the select contains the location reference 285 for the item 11, the client applications such as the Directory Viewer 20 or the Tagging Interface 25 informs the Item Store 10 of the use of the item 11.

An Item Store 10 implements authentication, authorization and access control features. Since it is a shared resource, it implements locking that may be done at the item level. Updates are done in a batch fashion to implement commit block functionality. An Item Store 10 is implemented as a stand-alone application or it may be implemented on top of a relational database. It can be implemented on top of a next generation file system such as WinFS. It can be offered as a service in a number of different fashions like Web Services, REST-like APIs, HTTP Get/Put, CORBA, RPC, RMI, Net Remoting or others. The tags 12 and relationships may be represented in RDF/OWL. An Item Store 10 implementation may further supplement with RDF technologies such that it services semi-structured as well as structured data. The context based search method is augmented with RDF and RDB query. Federated Item Store 10s are created by relaying context queries to another Item Store 10 and caching the results for future use in the same context 21.

### Directory Viewer and Tagging Interface Mechanisms

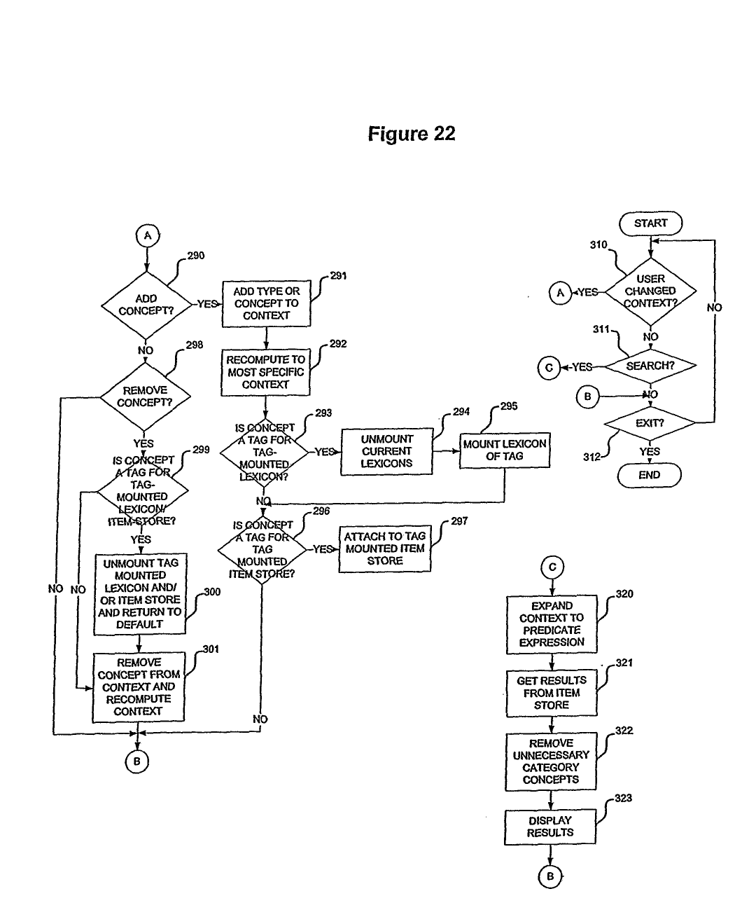

Referring to FIG. 22, the purpose of the Directory Viewer 20 is to find the items 11 in the Item Store 10 that are tagged or typed with concepts relevant to the query. Similarly, the purpose of the Tagging Interface 25 is to place relevant tags 12 against an item 11 in the Item Store 10 so that it is retrievable later. Each uses the context 21 as the mechanism to achieve this. The context 21 entered by the user is expanded 320 based on the relationships between concepts in the mounted Lexicons. Thus relationships may come from a variety of Lexicons 31 and the set of mounted Lexicons are collapsed into a common graph prior to such expansion. The expanded expression may be different depending on the set of mounted Lexicons, therefore each user that has a different mounted set may get a different expanded expression. The resulting context expression is sent to the Item Store 10 for processing 321.

Prior to the expansion of the context 21, all ‘TRelated-To’ relationships are converted to their equivalent ‘related-To’ relationships and all ‘same-As’ relationships are processed so that the concepts on either side of the relationship have the same parent, the same children, the same incoming and outgoing ‘related-To’ relationships. For the purposes of expansion, any one of the two concepts may be used and after all expansion is completed, wherever that concept occurs, it is replaced with a logical OR of the two original concepts. Therefore, the only relationships that need to be collapsed in the predicate expression are ‘is-A’ and ‘related-To’ so that they can be directly matched against items.

The expansion of a context based on the ‘is-A’ relationship is fundamentally the equivalent of placing a logical OR between the concept and its subclasses. In its simplest form, a context 21 is a single concept. Items 11 matching this context 21 are done in a variety of ways depending on the structure of relationships for that context 21 stored in its Lexicon 31 as well as other Lexicons 31 in the Lexicon Store 30. Referring to FIG. 21, a user specifying a context 21 ‘Concept A’ is interested in finding all items 11 of the type ‘Concept A’. They are also interested in finding all items 11 that are tagged with ‘Concept A’ (i.e. they are about ‘Concept A’). However, they may also be interested in items 11 that are a subclass of ‘Concept A’ such as ‘Concept B’. Similar to ‘Concept A’, this implies that items typed or tagged ‘Concept B’ also matches this context. This is true for any subclass of ‘Concept A’ including subclasses of a subclass and so forth down the ‘is-A’ relationship tree for the concept ‘Concept A’. A user may also be interested in items that are typed with a concept that is ‘related-To’ ‘Concept A’. For example, if ‘Concept X’-related-To→‘Concept A’, then items that are typed ‘Concept X’ is effectively tagged with ‘Concept A’ and therefore is considered a match to the context. This is also true of concepts that are related to subclasses of ‘Concept A’. There may be items 11 that are subclass of a concept that is ‘related-To’ ‘Concept A’. Items 11 that are of type such subclass match the context 21 as well. As noted before, items may be about something like a web page or a photograph. The default assumption of the directory is that the items 11 are such items. This means that in the above case, not only are the items typed with ‘Concept X’ candidates for matching but also items that are tagged with ‘Concept X’. This is considered true for items 11 tagged with subclasses of ‘Concept X’ as well.

Formally, this is expressed as: (where f( ) is as defined in the previous section)
1. f(‘related-To’, ‘Concept A’)
2. f(‘related-To’, ‘Concept B’) for all ‘Concept B’ that is a subclass of ‘Concept A’
3. f(‘related-To’, ‘Concept X’) for all ‘Concept X’ that is ‘related-To’ ‘Concept A’.
4. f(‘related-To’, ‘Concept Y’) for all ‘Concept Y’ that is ‘related-To’ any subclass of ‘Concept A’.
5. f(‘related-To’, ‘Concept 1’) for all ‘Concept 1’ that is a subclass of ‘Concept X’.
6. f(‘related-To’, ‘Concept 2’) for all ‘Concept 2’ that is a subclass of ‘Concept Y’.

The context ‘Concept A’ is expressed by the Boolean expression that is a logical OR of all the above predicate functions. Similarly, all concepts entered by the user are expanded to an expression of predicates in the same manner as above. In the case of a context 21 containing multiple concepts, the context 21 may be either an implicit AND of all concepts or a specific user entered Boolean expression of such concepts. Regardless of the input method, the entered context 21 may be considered a general Boolean expression of concepts that may include AND, OR as well as NOT. For each entered concept 21, the above expansion may be carried out and is considered the expansion of the concept with respect to the ‘is-A’ relationship.

The expansion of the context 21 with respect to the ‘related-To’ relationship may be done as follows. For example, the original context is a Boolean expression with AND, OR as well as NOT. This expression is converted into a Disjunctive Normal Form. For each conjunction in the resulting expression, the following is done:
For each concept in the conjunction, expand the concept on the basis of the ‘is-A’ relationship. For each such expanded concept, determine whether the concept is dependent on any other concept within the conjunction. Let us take two concepts—‘Concept G’ and ‘Concept H’. ‘Concept G’ is considered dependent on ‘Concept H’ if ‘Concept G’ or any of its parents have a ‘related-To’ relationship or an ‘is-A’ relationship to ‘Concept H’ or any subclasses of ‘Concept H’. ‘Concept G’ is also considered dependent if it is recursively dependent on ‘Concept H’. This implies that ‘Concept G’ is dependent on a concept that is dependent on a concept and so on till a concept is dependent on ‘Concept H’, where the number of such recursion is limited to the number of concepts in the conjunction. If the concept or any of its expanded concepts are not dependent on any other concepts in the conjunction, then the next concept in the conjunction is expanded and so forth.
In the case where any such expanded concept is dependent on another concept or concepts in the conjunction, then if any of the concepts it is dependent on is present with a NOT operator in the conjunction, the concept is removed from context expansion. If the concept is dependent on one or many concepts in the conjunction, then a separate term is introduced to the overall disjunction that is a conjunction of the dependent concept and other concepts of the original conjunction with the concepts that it is dependent on removed from the conjunction. This is repeated for each expanded concept. The remaining set of concepts represents the expanded form of the original concept in the original conjunction.
The above is then repeated for each concept in the original conjunction one at a time. Once this is completed, then an expanded expression of the conjunction is obtained where each dependent concept is introduced to the overall disjunction. This is then repeated for all conjunctions in the overall disjunction and all such dependent concepts are introduced into the overall disjunction of the context.

An example of this is the case of (‘Denim’ AND ‘Jeans’) from a previous example. First ‘Denim’ is expanded to (‘Denim’ OR (‘Denim Jeans’)). Here ‘Denim Jeans’ is a dependent concept on ‘Jeans’. Therefore, (‘Denim’ AND ‘Jeans’) is expanded to ((‘Denim’ AND ‘Jeans’) OR (‘Denim Jeans’)). Similarly ‘Jeans’ is expanded to (‘Jeans’ OR ‘Denim Jeans’). Since ‘Denim Jeans’ is dependent on ‘Denim’, (‘Denim’ AND ‘Jeans’) is expanded to ((‘Denim’ AND ‘Jeans’) OR (‘Denim Jeans’)). The final expression after the expansion based on ‘related-To’ will be ((‘Denim’ AND ‘Jeans’) OR (‘Denim Jeans’)). Since after taking out all the related concepts in each concept expansion, we are left with just the original concept in each case, the final context after expansion is ((‘Denim’ AND ‘Jeans’) OR (‘Denim Jeans’)). If there were any ‘same-As’ relationships concepts prior to the expansion, then every such concept in the resulting expression is expanded to include the other concepts it was linked with the ‘same-As’ concept by a logical OR.

Therefore, a context 21 that is a Boolean expression of concepts entered by the user is similarly converted to an expanded form that completely captures the graph structure of the Lexicon 31 that the user uses. Such a Boolean expression includes AND, OR and NOT to allow a full expression. The context 21 also allows the user to specify the type 13 of items 11 to be searched. If the matches to items 11 are limited to the type ‘Concept M’, this is expanded to the expression that is a logical OR of the following:
1. f(‘is-A’, ‘Concept M’)
2. f(‘is-A’, ‘Concept N’) for all ‘Concept N’ that is a subclass of ‘Concept M’

This may also be a Boolean expression of concepts entered by the user. This may be expanded a concept at a time. The Boolean expression for the restriction of type is then appended to the context expression with a logical AND.

Once the specified context 21 is fully expanded, the entire graph structure of the Lexicon 31 is collapsed into the Boolean expression of the context 21. Next, a number of operations may be performed at the Directory Viewer 20 so that processing at the Item Store 10 is optimized. It can order the disjunction on the basis of semantic distance so that the Item Store 10 may process the semantically closer sub-query first so as to return results quicker. It simplifies and minimizes the expression to either CNF or DNF or both. It converts it into a canonical form or a truth table. Once these forms are created, the Directory Viewer 20 sends the original context 21, the expanded contexts 21 and the mounted Lexicons 31 to the Item Store 10 for matching items 11.

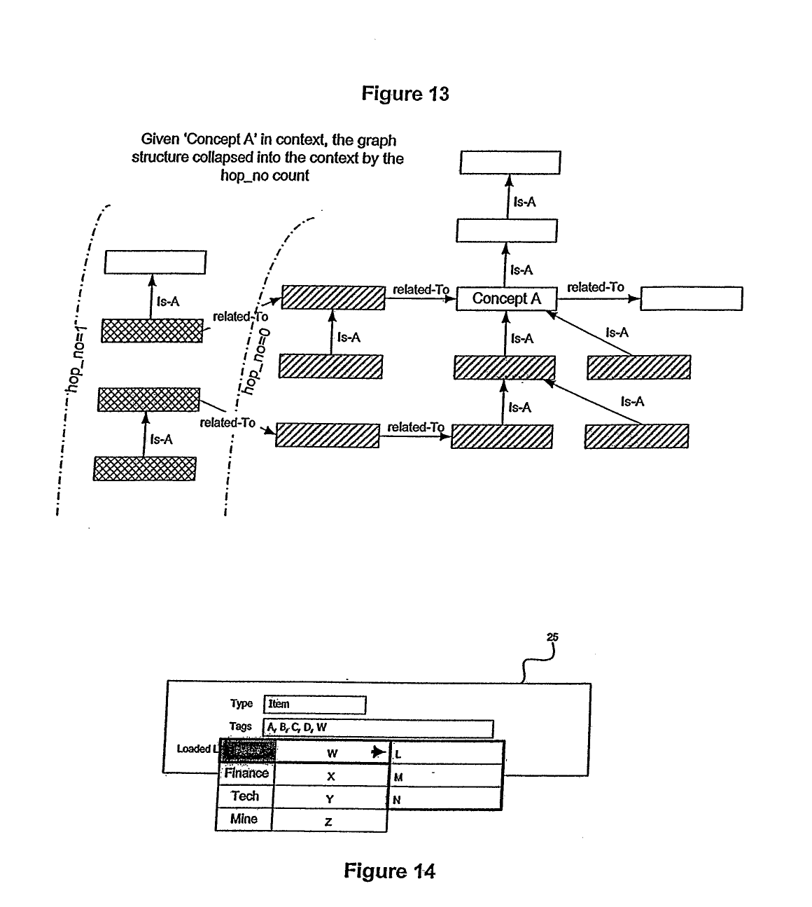

Referring to FIG. 13, traversing further down the opposite direction of a ‘related-To’ relationship or a browse path is illustrated. The nature of the ‘related-To’ relationship allows users to group things in a limited hierarchy and allow them drill down directory structures. A user may specify the number of hops (called hop_no) that the mechanism takes along a browse path thereby allowing the user to control the level of fuzziness in finding items 11. If the hop_no=0, then the items 11 returned all are directly relevant (even though many potentially relevant items 11 are not). If the hop_no=1, then items 11 that are tagged with concepts that are ‘related-To’ the concept being searched are also found (the default behavior used for this embodiment). For higher hop_no settings more items 11 are retrieved at the risk of finding more irrelevant hits. All the transformation corresponding to hop_no is done at the context 21 in the Directory Viewer 20 and therefore operates per query.

The above example corresponds to the expansion for hop_no=1. However, there are situations where this is may be too restrictive a search. Therefore, increasing the hop_no increases the expansion of context 21 to include other related concepts. Specifically, in the case of hop_no=2, the expansion of the above also includes:
1. f(‘related-To’, ‘Concept P’) for all ‘Concept P’ that is ‘related-To’ any ‘Concept X’ or its subclasses such as ‘Concept 1’.
2. f(‘related-To’, ‘Concept Q’) for all ‘Concept Q’ that is ‘related-To’ any ‘Concept Y’ or its subclasses such as ‘Concept 2’.

Once a context 21 is expanded to the full Boolean expression of predicates, it is passed to the Item Store 10 along with information regarding the Lexicons 31 that the user has mounted and optionally the original context specification prior to expansion. In returning the result set, the Item Store 10 removes 221 all tags/types 12, 13 that are concepts from a Lexicon 31 other than the ones mounted. In the case all the tags 12 and type 13 of the item 11 come from unmounted Lexicons 31, it optionally drops the item 11 as well. If a tag or a type is attached to every item 11 of the result set, it is no longer a good discriminator and therefore does not need to be returned with the concepts for the Category Display Section. Once the concepts are received from the Item Store 10, the Directory Viewer 20 does some further pruning before presenting them in the Category Display section. All concepts that are parents (or grandparents, etc.) of a concept in the context 21 are removed. The remaining concepts are now displayed according to the ranking order generated by the Item Store 10. Similarly, the items 11 are presented in the Item Display section sorted by the ranking order provided by the Item Store 10.

The Context Specification section allows the user to specify concepts that form a context 21. This is a set of concepts separated by spaces that represent an implicit AND. This also is expanded to accommodate a full Boolean expression of these concepts (the expansion of the context 21 to predicates accommodates such expressions). When a user enters a concept into the context 21, this concept maybe a subclass or parent of one of the concepts already present, or dependent on one or more concepts in already present or be completely independent of any concept already present. The behavior of the Context Specification section has the following requirements:
If the entered concept (through the Input Method) is a parent of an incumbent concept, it is folded into the incumbent concept (essentially removed from the concept after giving some visual cue that it is not necessary).
If the entered concept (either through the Input Method or clicking a concept in the Category Display section) is a subclass of an incumbent concept, then the incumbent concept is replaced with the entered concept after giving the user a visual cue as to what is happening.
If the entered concept is dependent on one or more concepts in the Context Specification section, then the following behavior is suggested:
   If the concept was entered by clicking a concept in the Category Display Section (browse path behavior) then remove all concepts in the context 21 that are the entered concept is dependent on (after giving a visual cue) and then insert the entered concept into the context. In the case for hop_no greater than one, dependency may be defined recursively upto the hop_no. For example, for hop_no=2, then a concept may be considered dependent if it is dependent on a concept that is dependent on the concept in the context.
   If the concept was entered through the Input Method, then add it to the context 21 with an implicit AND.
If the concept is not related to any of the concepts in the context then add it to the context 21 with an implicit AND.
All the above assumes the default input box where a full Boolean expression of concepts is not present. Such a Boolean expression is done at a specialized window that does not exhibit such browse behavior.

At any time the user has visibility to one hop and is not cluttered with too many tags 12. Furthermore, as the user drills down into narrower categories, they are items 11 only relevant to the narrower category. This is referred to as the browse path behavior.

For each increase in hop_no, the expansion method above is used to capture items 11 further down the browse path or in the reverse direction from the ‘related-To’ relationship. The effect of increasing the hop_no is to introduce more concepts in the context expression and therefore increase the numbers of items 11 that match the context 21. Many items 11 are about things like web pages or files. These are retrieved on the basis of their contents. Therefore, the search is not for an item 11 tagged with a concept but also the tag concepts that are tagged with a particular concept. This is the equivalent of increasing the hop_no=1. This may also be advantageously combined with browse path behavior at the Directory Viewer 20 to allow the user to crawl the ‘related-To’ graph a step at a time. However, it may be necessary to increase the hop_no even further. This may be useful in many situations where the ‘related-To’ relationship is acting as a sort of limited hierarchy therefore there may be many concepts that may be relevant in the general graph that are two hops away. It also increases the number of irrelevant hits. All items 11 that are returned are organized on the basis of their tags 12, so even if a large number of concepts are returned, they are managed by drilling down by relevant categories. With a larger hop_no, the query processing at the Item Store 10 becomes more expensive. Therefore, the preferred embodiment uses a mechanism that allows the hop_no to be set per user and also per context, allowing free customization of behavior. This is set at the time of expansion of the concepts in the context 21 to their predicate expression.

A number of standard features commonly found in browsers are supported, including: a “Back”, a “Forward”, a “Reload” and a “Home” button. Pagination is implemented where the user browses returned items 11 a page at a time. A user may bookmark an item 11. Such a bookmark is saved and automatically obtains its categorization information from the concepts in the context 21. A “See Also” section is provided where concepts are parents of concepts in the context 21 or concepts corresponding to walking the ‘related-To’ graph in the direction of the relationship.

To incorporate Tag-Mounted Lexicons, the context processing includes an unmount and mount operation for Lexicons 31. When a user clicks such a tag in the Category Display Section, then the current Lexicons of the user are temporarily unmounted 294 and the Lexicon corresponding to the tag 12 is mounted. Then the rest of the processing resumes as usual. For Tag-Mounted Item Store 10s, the same operation is done except all the future communication is made with the Tag-Mounted Item Store 10 instead of the normal one. Also, the Directory Viewer 20 may allow the specification of an Item Store 10 through a location identifier such as a URL. This allows the Directory Viewer 20 to mount different Item Stores 10 as per user requirements. The Get Item operation of the Item Store 10 corresponds to a click/double click of an item 11 in the Item Display Section.

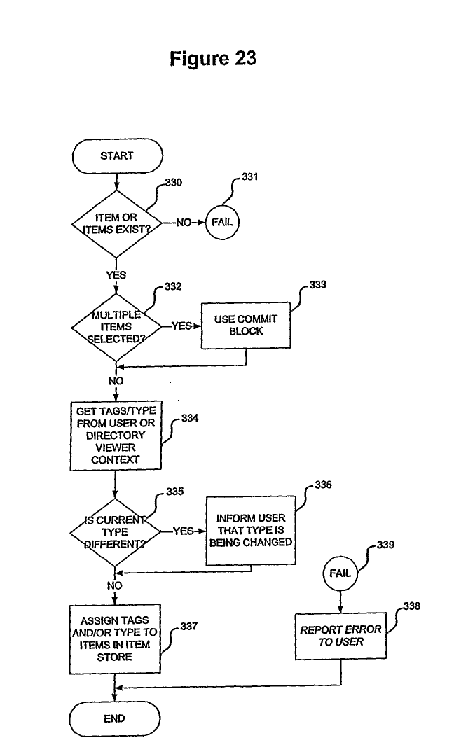

Referring to FIGS. 14 and 23, the Tagging Interface 25 is used to place tags 12 or type 13 of an item 11. This allows the user to associate tags 12 or a type 13 to an item 11. The user enters the corresponding tags 12 and type 13 in the input windows provided in the Tagging Interface 25 and the mechanism requests the Item Store 10 to store that tags/type against the item 11. Each subsequent tag 12 entered narrows the context 21. The user keeps tagging until the item 11 is categorized in sufficient detail to allow it to be discovered. Once the set of tags 12 is entered, the Tagging Interface 25 computes the most specific tags 12 leveraging logic similar to the context calculation for the Directory Viewer 20. The primary intention is to tag the item 11 with the most representative tags 12 (as specific as possible) and let the graph structure allow people to discover the items 11 in a structured way. As many independent or unrelated tags 12 that characterize the item 11 as possible are placed. A relatively large number of items 11 may be effectively categorized by a relatively small number of independent tags 12 at the right level of specificity. The Tagging Interface 25 may continually monitor the entered tags 12 so as to provide the user with feedback on the number of independent tags 12 (by finding dependency similar to the case of drill-down behavior). The Tagging Interface 25 constantly removes the unnecessary concepts from the Tagging Section, thereby allowing the user to have a succinct set of tags 12.

The Directory Viewer 20 is leveraged where a user enters a context 21 that corresponds to the closest to the contents of the item 11. Then a GUI gesture like a drag-and-drop into that Item Display section, tags and types the item 11 with the tags/type in the context 21. Also, a user may select an item 11 in the Directory Viewer 20 and specify further tags 12 in the Tagging Section. The concepts in the Category Display section may give the user hints on what other people have tagged items 11 in that context 21 as well as the ranked order gives the user a cue on what tags 12 people are using more often. All this helps the user in the tagging process. The user may select 332 a number of items 11 simultaneously in the Item Display Section so that they are tagged/typed simultaneously. When multiple items 11 are selected, only tags 12 and types 13 are shown if they are shared by all items 11. Any tag 12 entered with multiple items 11 selected 337 is tagged to all items 11. Similarly, if a type 13 is set then all items 11 selected 337 are set to the same type 13. The Item Store 10 may advantageously use commit blocks 333 in the case of multiple simultaneous edits so that they are realized in a reliable and consistent manner. Depending on the implementation it is possible to have different types of tagging behavior: insert only, or update/delete by author only, or full edit capability for all users. They all use the same mechanism with suitable modifications. The Tagging Interface 25 also implements authentication and authorization for data in the Item Store 10. Lexicon access control behavior is supported. For example, depending on the Lexicon 31, a user may be able to use it in the Input Method for the Directory Viewer 20 but cannot use it to tag/type items 11.

Both the Lexicon Store 30 and the Item Store 10 can be implemented in a distributed manner over the network in a number of well-known methods including client-server, master-cache, master-slave, peer-to-peer, and REST-like architecture.

All the data structures of a Lexicon 31 may be represented by any suitable technology such as RDF/OWL, any triple stores, Relational Databases, etc. in a manner that exposes such semantics. The use of such technology in itself does not change the basic intent of the mechanism. Although a further definition of a concept through schema or other definition is not explicitly described, the mechanism can be extended to cover this. As an example, in an implementation using Semantic Web technologies such as RDF/OWL, the concept serves as a class URI or has an annotation property such as rdfs: see also using which a schema definition of the concept is appended. In doing so, the concept is actually kept independent of a specific class schema. Therefore, in an example where different Item Stores 10 have different schema definitions for the concept ‘Book’, is handled gracefully by a common generic Lexicon 31.

While the description has focused on providing mechanisms to create and handle semantic metadata 12, the same mechanisms may be applied to any metadata that has standardized semantics, either through a standards specification or by the virtue of being a de-facto standard. Mechanisms like separation of items 11 from organization through Boolean expression based context queries, the underspecified relationship types, Directory Viewer 20, Tagging Interface 25, etc. can all be used against such metadata.

It will be appreciated by persons skilled in the art that numerous variations and/or modifications may be made to the invention as shown in the specific embodiments without departing from the scope or spirit of the invention as broadly described. The present embodiments are, therefore, to be considered in all respects illustrative and not restrictive.

We claim:

1. A method for organizing items, the method comprising:
associating at least one semantic metadata with an item to define a directional relationship between a concept and the item; and
assigning a unique machine-readable identifier for the at least one semantic metadata and for the item;
wherein the at least one semantic metadata corresponds to the concept that is a characteristic of the item and is expressible in at least one natural language having a description or at least one keyword corresponding to the concept in the at least one natural language; and the at least one semantic metadata is discoverable by searching against the description or at least one keyword and items associated with the at least one semantic metadata are viewable; and the at least one semantic metadata and the item are referenced by their unique machine-readable identifiers.

2. The method according to claim 1, wherein a user associating the semantic metadata with the item is independent from a user that created the semantic metadata.

3. The method according to claim 1, wherein the unique machine readable identifiers for semantic metadata and items are globally unique.

4. The method according to claim 1, wherein at least one directed relationship exists between two semantic metadata from any one of the group consisting of: related-To, no-Relationship, is-A, TRelated-To and same-As.

5. The method according to claim 1, wherein the at least one semantic metadata is associated with another semantic metadata with an underspecified directed relationship whose semantics is determined by the at least one semantic metadata and another semantic metadata and the direction of the relationship.

6. The method according to claim 1, wherein the at least one semantic metadata is described by a schema; and the schema specifies attributes that is able to be specified with any instance of the corresponding semantic metadata.

7. The method according to claim 6, wherein the attributes are identified with semantic metadata.

8. The method according to claim 1, wherein at least one lexicon has a unique machine-readable identifier containing a plurality of semantic metadata having machine-readable identifiers that are unique within the lexicon.

9. The method according to claim 8, wherein the unique machine-readable identifier for the lexicon is globally unique.

10. The method according to claim 8, wherein each lexicon is one from a group consisting of read-only and read-write.

11. The method according to claim 8, wherein at least one lexicon is shared by a group of users and is modifiable by any user of the group.

12. The method according to claim 1, wherein an item is any one from the group consisting of: an animate entity, an Inanimate entity, a group, an event, a time period, a location, a state, a process, an act, a digital entity, a concept, a file, an email, an instant message, a web page, a web site, a web service, a data structure, a software module, a software object, an application, an operating system, a row in a table in a relational database, XML data and a resource represented in RDF.

13. The method according to claim 1, wherein the machine-readable identifier for an item is any one from the group consisting of: a hash value, URL, URI, URN, UNC, bar code, RFID, fiducial marker, email address, social security number, vehicle registration number, and telephone number.

14. The method according to claim 1, wherein the directed relationship is any one from the group consisting of: related-To, about and is-A.

15. The method according to claim 1, wherein machine-readable identifiers for the Items are stored in at least one Item store, the at least one Item store having a unique identifier.

16. The method according to claim 15, wherein the unique identifier for the item store is globally unique or is a URL.

17. The method according to claim 15, wherein the item store is distributed within a network and is a member of the group of configurations consisting of: master-slave configuration, master-cache configuration, client-server configuration, peer-to-peer, and federated configuration.

18. The method according to claim 15, wherein if the item store is a file system, the files are considered items and are associated with semantic metadata.

19. The method according to claim 15, wherein if the item store is a relational database, at least one entity or entity set in the relational database is mapped to a semantic metadata, and at least one row in a table is considered an item.

20. The method according to claim 15, wherein if the item store is an object-oriented database or object-oriented application, at least one object is considered an item and at least one from a group consisting of a class, a method and a method parameter are mapped to a semantic metadata.

21. The method according to claim 15, wherein if the Item store is a messaging bus, messages are described by subjects that correspond to semantic metadata and/or a Boolean expression of semantic metadata.

22. The method according to claim 8, wherein a user is authenticated and authorized against a lexicon before the user is allowed to associate semantic metadata from that lexicon to items.

23. The method according to claim 1, wherein the semantic metadata is verified according to a brand.

24. The method according to claim 1, wherein the description is in a form from any one of the group consisting of: image, sound, video, Braille, scent, touch.

25. A method for searching items, the method comprising:
inputting a context in the form of a Boolean expression to search for the items, the Boolean expression comprising at least one semantic metadata predicate such that each predicate evaluates whether an item is associated with the at least one semantic metadata;
evaluating the items and their associated semantic metadata; and
retrieving items having associated semantic metadata causing the Boolean expression to evaluate to true;
wherein items are associated with semantic metadata to define a directional relationship between a concept and the item; unique machine-readable identifiers are assigned for are at least one semantic metadata and for the item; and the concept corresponding to the at least one semantic metadata is a characteristic of the item and is expressible in at least one natural language having a description or at least one keyword corresponding to the concept in the at least one natural language; and the at least one semantic metadata is discoverable by searching against the description or at least one keyword and items-associated with the at least one semantic metadata are viewable; and the at least one semantic metadata and the item are referenced by their unique machine-readable identifiers.

26. The method according to claim 25, wherein the semantic metadata identifier is derived from a standardized ontology.

27. The method according to claim 25, wherein the items are retrieved based on a ranked order where ranking is performed on the basis of any method from the group of methods consisting of: usage-based, recent use based, usage based for a context, recent use based for a context, and semantic distance ordering in a context.

28. The method according to claim 25, wherein the item identifier and/or the attributes of the item are retrieved instead of the item.

29. The method according to claim 25, wherein the items are retrieved from at least one item store.

30. The method according to claim 29, wherein if the item store is a federated item store, queries having semantic metadata in the predicates of the context expression from the specified set of semantic metadata for the federated item store are forwarded to the federated item store.

31. The method according to claim 29, wherein if the item store is an object-oriented database or object-oriented application, the API call is modeled as a Boolean expression of context where such concepts are added with a logical AND, and passing of such a context expression to the API is the equivalent of invoking it.

32. The method according to claim 31, wherein the API call is part of a sequence of API calls modeling a process, and control flow statements are modeled through drill down behavior.

33. The method according to claim 29, wherein if the item store is a messaging bus, Item retrieval is performed continuously, and item matching is done on the basis of each message; where each message is described by a subject that corresponds to concepts and/or expressions of concepts; and the subject is evaluated with the Boolean expression of context such that the message is retrieved if the expression evaluates to true.

34. The method according to claim 25, wherein the presentation format of the retrieved items is determined based on the context.

35. The method according to claim 25, further comprising retrieving semantic metadata associated with the items and offering at least one other semantic metadata or keyword as drill-down categories; and where drilling-down updates the context as per the drill-down process and the search is re-executed with the new context.

36. The method according to claim 25, wherein the Boolean expression further comprises at least one predicate such that each predicate evaluates whether an item is associated with a specified semantic metadata through a specified relationship.

37. The method according to claim 36, wherein the specified relationship is from the group of relationships consisting of: related-To, about and is-A.

38. The method according to claim 36, wherein a graph of relationships between concepts is used to expand the predicates in the Boolean expression of the search context, the relationships between concepts being members of a group consisting of related-To, no-Relationship, TRelated-To, is-A and same-As, the method further comprising:
incorporating all relevant information in the graph in the expanded context expression; and
retrieving machine-readable identifiers of items having associated metadata which cause the resulting expanded context expression of predicates evaluate to true.

39. The method according to claim 38, wherein Boolean expression of the context is in a disjunctive normal form such that each conjunction in the disjunction represents a sub-query and the conjunctions are ordered with the notion of semantic distance.

40. The method according to claim 38, wherein the related-To relationship is defined as a limited hierarchy and matches items that correspond to semantic metadata that have a related-To relationship with a semantic metadata present in the search context.

41. The method according to claim 25, wherein at least one predicate in the search context corresponds to a semantic metadata representing an instance of a system from the group consisting of: relational database, object-oriented database, messaging bus, application system, operating system and file system.

42. The method according to claim 41, wherein a lexicon is mounted for a user inputting the search context if the search context has the at least one predicate; and the semantic metadata in the mounted lexicon is any one from the group consisting of: only semantic metadata and semantic metadata described with a schema.

43. The method according to claim 25, wherein the search context has a predicate corresponding to a tag of a tag-mounted lexicon; and the lexicon is mounted for a user inputting the search context.

44. The method according to claim 25, wherein the search context has a predicate corresponding to a tag for a tag-mounted directory; and the directory is used for searches.

45. The method according to claim 41, wherein a function call is made to the system by passing the Boolean expression.

46. The method according to claim 25, wherein the search context is entered by a user through a predetermined input method, the predetermined input method comprising:
selecting semantic metadata from a set of semantic metadata matching an input keyword; and
entering attribute values for the semantic metadata before the semantic metadata and its attribute values are added to the search context.

47. The method according to claim 46, wherein the semantic metadata in the predetermined input method is selected from the mounted lexicons for the user.

48. The method according to claim 47, wherein the semantic metadata corresponding to a keyword is matched from all mounted lexicons; and is sorted by the predetermined input method according to usage based on any one from the group consisting of: each lexicon and user.

49. An organisation system for organizing Items, the system comprising:
a data structure associating at least one semantic metadata with an item to define a directional relationship between a concept and the item; and
a user interface to express the at least one semantic metadata in at least one natural language using a description or at least one keyword corresponding to the concept in the at least one natural language such that the at least one semantic metadata is discoverable by searching against the description or at least one keyword and items associated with the at least one semantic metadata are viewable;
wherein the at least one semantic metadata corresponds to the concept that is a characteristic of the item; and the at least one semantic metadata and the item are referenced by unique machine-readable identifiers.

50. The system according to claim 49, wherein the data structure is an item store.

51. The system according to claim 49, further comprising a Lexicon to store the at least one semantic metadata.

52. The system according to claim 51, further comprising a lexicon store to manage the lexicon.

53. A semantic metadata for enhancing the discoverability of items, wherein the semantic metadata is associated with an item to define a directional relationship between a concept and the item; and a unique machine-readable identifier is assigned for the semantic metadata and for the item; and the at least one semantic metadata corresponds to the concept that is a characteristic of the item and is expressible in at least one natural language having a description or at least one keyword corresponding to the concept in the at least one natural language; and the at least one semantic metadata is discoverable by searching against the description or at least one keyword and items associated with the at least one semantic metadata are viewable; and the at least one semantic metadata and the item are referenced by their unique machine-readable identifiers.

54. The semantic metadata according to claim 53, wherein the semantic metadata is in the form of a tag.

55. The semantic metadata according to claim 53, wherein for a plurality of semantic metadata, there is at least one semantic metadata that is associated with another semantic metadata with an underspecified directed relationship whose semantics is determined by the at least one and another semantic metadata and the direction of the relationship.

56. The semantic metadata according to claim 55, wherein the underspecified directed relationship implies that the concept represented by the semantic metadata at a target of the relationship is a characteristic of the semantic metadata at a source of the relationship.
